(19) United States
(12) Patent Application Publication
(10) Pub. No.: US 2025/0197658 A1
(43) Pub. Date: Jun. 19, 2025

(54) ANTIOXIDANT STABILIZERS FOR DIRECT FABRICATION OF ORTHODONTIC APPLIANCES

(71) Applicant: Align Technology, Inc., San Jose, CA (US)

(72) Inventors: Ming Ren, Belmont, CA (US); Daniel Yilin Jiang, Fremont, CA (US); Jason Safko, Redwood City, CA (US); Lance Robert Pickens, Campbell, CA (US)

(21) Appl. No.: 18/980,475

(22) Filed: Dec. 13, 2024

Related U.S. Application Data
(60) Provisional application No. 63/609,646, filed on Dec. 13, 2023.

(51) Int. Cl. C09D 7/63; A61C 7/08; B33Y 70/00; C08F 290/14; C08K 5/1545; C09D 4/00; C09D 151/08

(52) U.S. Cl. CPC C09D 7/63; B33Y 70/00; C08F 290/142; C08F 290/147; C09D 4/00; C09D 151/08; A61C 7/08; C08K 5/1545

(57) ABSTRACT

This disclosure provides stable polymerizable resin compositions comprising one or more antioxidant stabilizers to prevent undesired polymerization and/or oxidation of polymerizable components as well as undesired depletion of photoinitiators in the polymerizable resin composition. Such polymerizable resin compositions can be used to produce polymeric materials with properties suitable for use in various mechanical appliances, such as orthodontic appliances.

### CROSS-REFERENCE TO RELATED APPLICATION

This application claims the priority of U.S. Provisional Patent Application No. 63/609,646, filed Dec. 13, 2023, which is hereby incorporated by reference in its entirety.

### BACKGROUND OF THE INVENTION

Orthodontic procedures typically involve repositioning a patient's teeth to a desired arrangement in order to correct malocclusions and/or improve aesthetics. To achieve these objectives, orthodontic appliances such as aligners, retainers, expanders, and the like can be applied to the patient's teeth by an orthodontic practitioner and/or a patient. The appliance is configured to exert force on one or more teeth in order to effect desired tooth movements. The application of force can be periodically adjusted (e.g., by altering the appliance or using different types of appliances) in order to incrementally reposition the teeth to a desired arrangement.

Additive manufacturing, also referred to as three-dimensional (3D) printing, has been widely used to fabricate orthodontic appliances out of photopolymerizable materials. Many additive manufacturing techniques involve successively adding layers of photopolymerizable materials and curing these layers by controlled light exposure. The photopolymerizable materials often include reactive components that are cured with light. Acrylate-based resins, which undergo free-radical polymerization, are the most commonly used photosensitive resins for additive manufacturing technologies due to their high photopolymerization curing speed.

### SUMMARY OF THE INVENTION

Provided herein are stable polymerizable resin compositions comprising one or more antioxidant stabilizers. The antioxidant stabilizers are employed to prevent undesired polymerization of polymerizable components, oxidation of reactive diluents, and depletion of photoinitiators in the polymerizable resin compositions at various stages of additive manufacturing, handling, storage, and transportation. Such resin compositions have applications for use, including in additive manufacturing of appliances (e.g., orthodontic appliances). Also provided herein are orthodontic appliances manufactured using the disclosed stable polymerizable resin compositions, materials made from these stable polymerizable resin compositions, and methods of using orthodontic appliances made from these stable polymerizable resin compositions.

In one aspect, a polymerizable resin composition is provided. The polymerizable resin composition includes an antioxidant stabilizer selected from the group consisting of vitamin E, octadecyl 3-(3,5-di-tert-butyl-4-hydroxyphenyl)propionate, pentaerythritol tetrakis(3-(3,5-di-tert-butyl-4-hydroxyphenyl)propionate, pentaerythritol tetrakis(3,5-di-tert-butyl-4-hydroxyhydrocinnamate), 1,3,5-tris(3,5-di-tert-butyl-4-hydroxybenzyl)-isocyanurate, 1,3,5-tris(4-tert-butyl-3-hydroxy-2,6-dimethylbenzyl)-isocyanurate, bis(3,5-di-tert-butyl-4-hydroxyhydrocinnamoyl)-methane, 2,2′-methylenebis(4-methyl-6-tert-butylphenol), bis(2,4-di-tert-butylphenol) pentaerythritol diphosphite, tris(nonylphenyl)phosphite, tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite), ethylene bis(oxyethylene)bis[β-(3-tert-butyl-4-hydroxy-5-methylphenyl)propionate], and tetrakis[methylene-3-(3,5-di-tert-butyl-4-hydroxyphenyl)propionate]methane; a reactive diluent, wherein the reactive diluent is a polymerizable compound having a molecular weight of 0.1 to 1.0 kDa; and a telechelic compound comprising an oligomeric or a polymeric chain of interconnected monomeric units having a first terminal end and a second terminal end; at least one first reactive functional group covalently bonded to the first terminal end; and at least one second reactive functional group covalently bonded to the second terminal end. In some embodiments, the antioxidant stabilizer comprises vitamin E. In some embodiments, the vitamin E comprises alpha-tocopherol. In some embodiments, the vitamin E comprises mixed tocopherols selected from alpha-tocopherol, beta-tocopherol, delta-tocopherol and gamma-tocopherol. In some embodiments, a total content of the mixed tocopherols in the vitamin E is about 95 wt %. In some embodiments, the antioxidant stabilizer is tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite), octadecyl 3-(3,5-di-tert-butyl-4-hydroxyphenyl)propionate, or a mixture of tris(2,4-di-tert-butylphenyl)phosphite and pentacrythritol tetrakis(3,5-di-tert-butyl-4-hydroxyhydrocinnamate). In some embodiments, the oligomeric or polymeric chain of interconnected monomeric units is selected from the group consisting of (poly)carbonate-(poly)urethane, (poly)ester-(poly)urethane, (poly)ether-(poly) urethane, (poly)thioether-(poly)urethane, hydrogenated (poly)butadiene, (poly)ester and (poly)urethane. In some embodiments, the oligomeric or polymeric chain of interconnected monomeric units comprises a polyether moiety, a polyester moiety, a polyurethane moiety or a combination thereof. In some embodiments, the at least one first reactive functional group and the at least one second reactive group are independently selected from the group consisting of an acrylate, a methacrylate, a vinyl acrylate, a vinyl methacrylate, an allyl ether, a silene, an alkyne, an alkene, a vinyl ether, a maleimide, a fumarate, a maleate, an itaconate, an epoxide and a styrenyl.

In some embodiments, the at least one first reactive functional group and the at least one second reactive function group independently have one of the following structures:

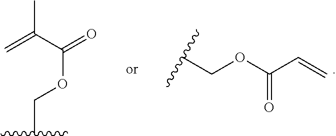

In some embodiments, the at least one first reactive functional group and the at least one second reactive function group have the following structure:

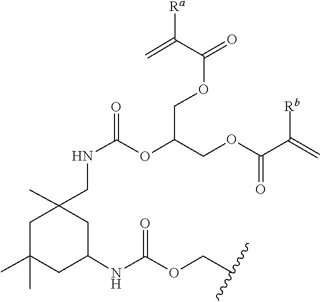

wherein R^{a} and R^{b} are independently H, halogen, or substituted or unsubstituted C₁-C₃ alkyl.

In some embodiments, the telechelic compound has one of the following structures:

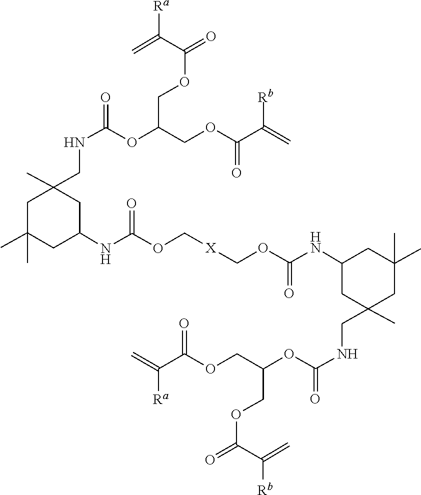

wherein:
X is an oligomeric or polymeric chain of interconnected monomeric units selected from the group consisting of (poly)carbonate-(poly)urethane, (poly)ester-(poly)urethane, (poly)ether-(poly)urethane, (poly)thioether-(poly)urethane, hydrogenated (poly)butadiene, (poly)ester or (poly)urethane; and
R^{a} and R^{b} are independently H, halogen, or substituted or unsubstituted C₁-C₃ alkyl.

In some embodiments, R^{a} and R^{b} are independently H or methyl.

In some embodiments, the telechelic compound has one of the following structures:

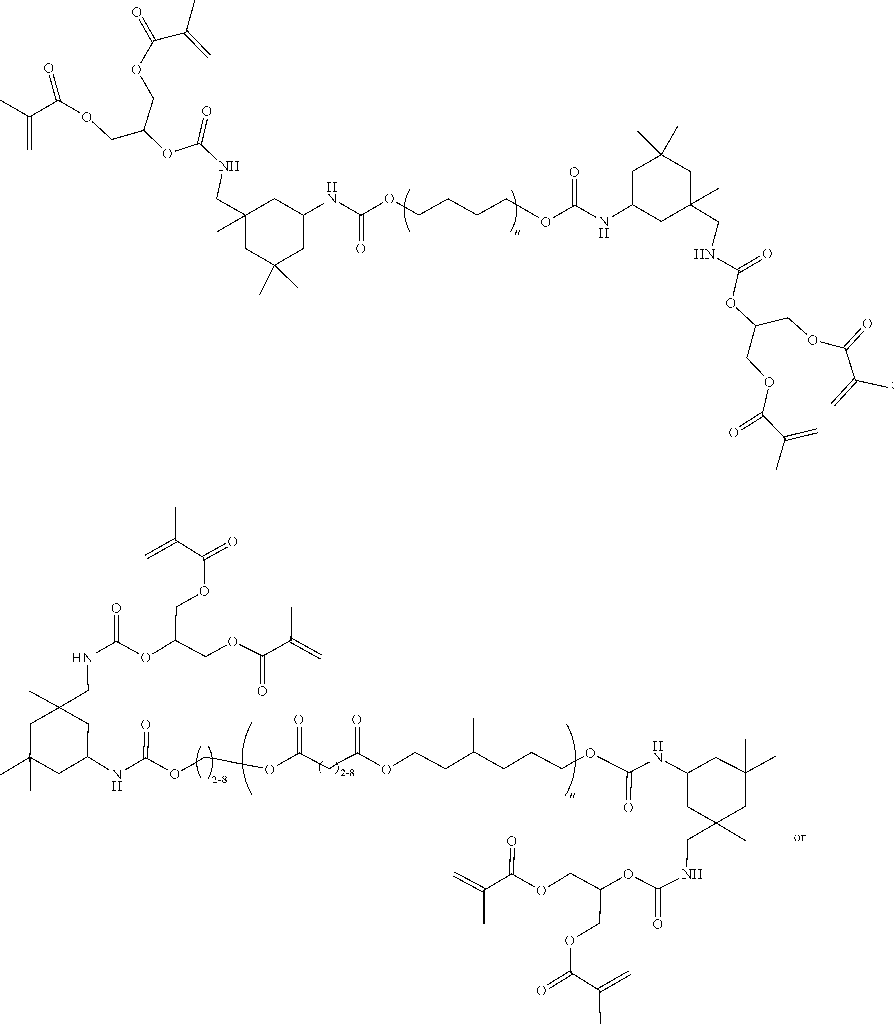

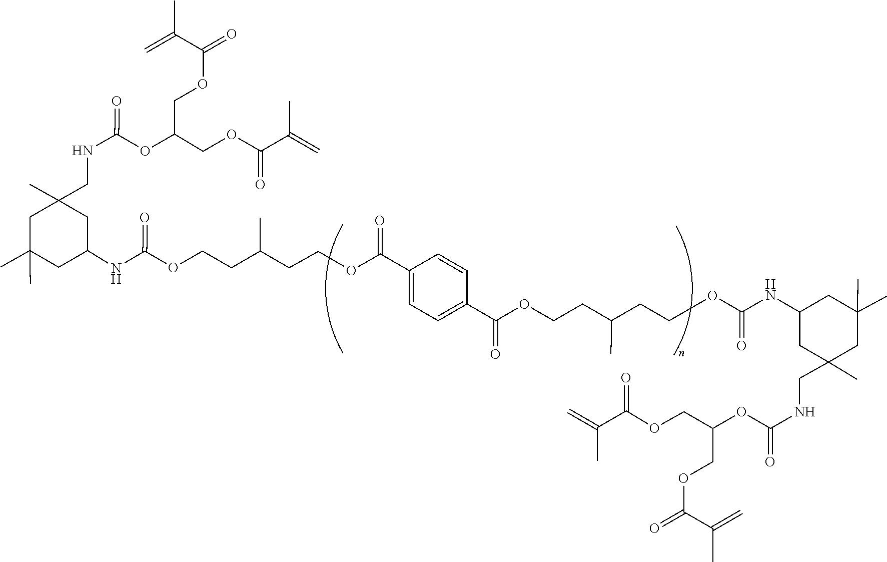

wherein n is an integer from 1 to 100.

In some embodiments, the telechelic compound is a toughness modifier having a number average molecular weight greater than 5 kDa.

In some embodiments, the toughness modifier has one of the following structures (II), (III), (IV) and (V):

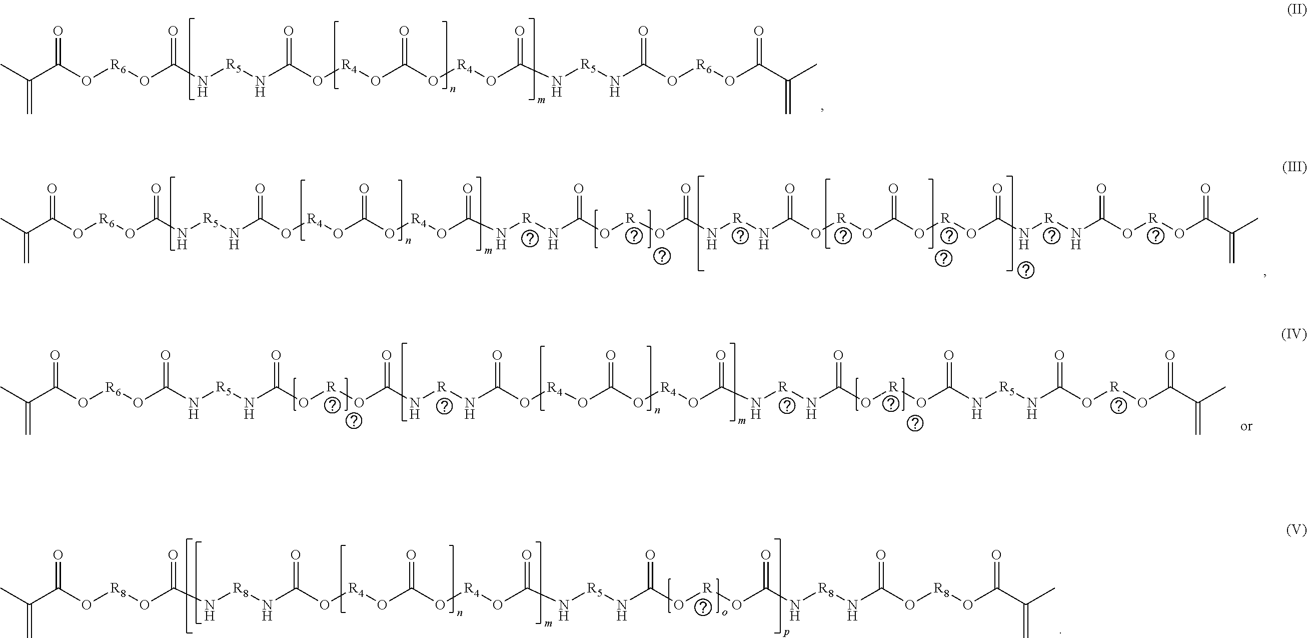

wherein each R₄ and each R₅ independently represent a divalent, linear, branched or cyclic C₅-C₁₅ alkyl radical; each R₆ independently represents a divalent, linear or branched C₂-C₄ alkyl radical; each R₇ independently represents a divalent, linear, branched C₂-C₆ alkyl radical, or is absent; each n is independently an integer from 1 to 10; each m is independently an integer from 1 to 20; each o is independently an integer from 5 to 50 or is absent; and p is an integer from 1 to 40 or is absent.

In some embodiments, the polymerizable resin composition further comprises a glass transition temperature modifier having a higher glass transition temperature than the toughness modifier and a number average molecular weight of 0.4 to 5 kDa.

In some embodiments, the glass transition temperature modifier comprises a compound having the following structure (I),

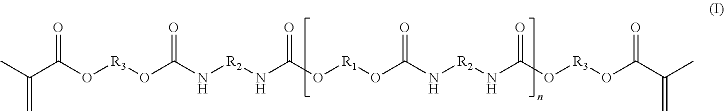

wherein each R₁ and each R₂ independently represent a divalent, linear, branched or cyclic C₅-C₁₅ alkyl radical, with the proviso that at least one of R₁ and R₂ is or comprises a C₅-C₆ cycloalkyl structure; each R₃ independently represents a divalent, linear or branched C₂-C₄ alkyl radical; and n is an integer from 1 to 5.

In some embodiments, the reactive diluent comprises triethylene glycol dimethacrylate (TEGDMA), decanediol-1,10-dimethacrylate (D3MA), 1,12-dodecanediol dimethacrylate (D4MA), 3,3,5-trimethylcyclohexyl 2-(methacryloxy)benzoate (HSMA), benzyl salicylate methacrylate (BSMA), bisphenol A-glycidyl methacrylate (BisGMA) and urethane dimethacrylate (UDMA), 2-hydroxyethyl methacrylate (HEMA), 2-hydroxybutyl methacrylate (HBMA), isobornyl methacrylate (IBMA), 2-ethylhexyl methacrylate (EHMA), 2-cyanoethyl methacrylate (CEMA), benzyl methacrylate (BMA), 2-phenoxyethyl methacrylate (PEMA), butyl methacrylate (BMA), lauryl methacrylate (LMA), syringyl methacrylate (SMA) or combinations thereof. In some embodiments, the polymerizable resin composition comprises no greater than 2000 ppm, based on the total weight of the composition, of the antioxidant stabilizer. In some embodiments, the polymerizable resin composition comprises 500 to 1000 ppm, based on the total weight of the composition, of the antioxidant stabilizer. In some embodiments, the polymerizable resin composition comprises 200 to 500 ppm, based on the total weight of the composition, of the antioxidant stabilizer. In some embodiments, the polymerizable resin composition comprises 200 to 300 ppm, based on the total weight of the composition, of the vitamin E. In some embodiments, the polymerizable resin composition comprises 1 to 75 wt %, based on the total weight of the composition, of the telechelic compound. In some embodiments, the polymerizable resin composition comprises 25 to 65 wt %, based on the total weight of the composition, of the telechelic compound. In some embodiments, the polymerizable resin composition comprises 30 to 60 wt %, based on the total weight of the composition, of the telechelic compound. In some embodiments, the polymerizable resin composition comprises 1 to 75 wt %, based on the total weight of the composition, of the reactive diluent. In some embodiments, the polymerizable resin composition comprises 5 to 50 wt %, based on the total weight of the composition, of the reactive diluent. In some embodiments, the polymerizable resin composition comprises 20 to 50 wt %, based on the total weight of the composition, of the reactive diluent. In some embodiments, the polymerizable resin composition further comprises an initiator. In some embodiments, the initiator comprises a photoinitiator. In some embodiments, the photoinitiator comprises phenylbis(2,4,6-trimethylbenzoyl) phosphine oxide (BAPO), diphenyl-(2,4,6-trimethylbenzoyl) phosphine oxide (TPO), ethyl-(2,4,6-trimethylbenzoyl)phenylphosphinate (TPO-L), a polymeric TPO-L, alpha-hydroxyketone, benzil dimethyl ketal (BDK), or a combination thereof. In some embodiments, the initiator comprises a thermal initiator. In some embodiments, the thermal initiator comprises azobisisobutyronitrile, 2,2′-azodi(2-methylbutyronitrile) or a combination thereof. In some embodiments, the polymerizable resin composition comprises 0 to 20 wt %, based on the total weight of the composition of, the initiator. In some embodiments, the polymerizable resin composition comprises 0.01 to 10 wt %, based on the total weight of the composition, of the initiator. In some embodiments, the polymerizable composition further comprises a crosslinking modifier, a polymerization catalyst, a light blocker, a plasticizer, a surface energy modifier, a pigment, a dye, a filler, a biologically significant chemical, a solvent, and combinations thereof. In some embodiments, the polymerizable resin composition is capable of being 3D printed at a printing temperature greater than 25° C. In some embodiments, the printing temperature is at least 30° C., 40° C., 50° C., 60° C., 80° C., or 100° C. In some embodiments, the polymerizable resin composition has a viscosity from 30 cP to 50,000 cP at a printing temperature. In some embodiments, the polymerizable resin composition is a liquid at a temperature from about 40° C. to about 100° C. In some embodiments, the polymerizable resin composition is a liquid at a temperature of above about 40° C. with a viscosity less than about 20 Pa·s. In some embodiments, the polymerizable resin composition is a liquid at a temperature of above about 40° C. with a viscosity less than about 1 Pa·s. In some embodiments, at least a portion of the polymerizable resin composition melts at a temperature between about 60° C. and about 0° C.

In another aspect, a polymeric material formed from such polymerizable resin composition is provided. In some embodiments, the polymeric material is characterized by one or more of a stress relaxation of greater than or equal to 5% of the initial load and a glass transition temperature of greater than or equal to 90° C. In some embodiments, the polymeric material is further characterized by one or more of: a tensile modulus greater than or equal to 100 MPa; a tensile strength at yield greater than or equal to 5 MPa; an elongation at yield greater than or equal to 4%; an elongation at break greater than or equal to 5%; a storage modulus greater than or equal to 300 MPa; and a stress relaxation greater than or equal to 0.01 MPa. In some embodiments, the polymeric material is characterized by a stress relaxation of 5% to 45% of the initial load. In some embodiments, the polymeric material is characterized by a stress relaxation of 20% to 45% of the initial load. In some embodiments, the polymeric material is characterized by a glass transition temperature of 90° C. to 150° C. In some embodiments, the polymeric material is characterized by a tensile modulus from 100 MPa to 2000 MPa. In some embodiments, the polymeric material is characterized by a tensile modulus from 800 MPa to 2000 MPa. In some embodiments, the polymeric material is characterized by a tensile strength at yield of 5 MPa to 85 MPa. In some embodiments, the polymeric material is characterized by a tensile strength at yield of 20 MPa to 55 MPa. In some embodiments, the polymeric material is characterized by a tensile strength at yield of 25 MPa to 55 MPa. In some embodiments, the polymeric material is characterized by an elongation at yield of 4% to 10%. In some embodiments, the polymeric material is characterized by an elongation at yield of 5% to 10%. In some embodiments, the polymeric material is characterized by an elongation at break of 5% to 250%. In some embodiments, the polymeric material is characterized by an elongation at break of 20% to 250%. In some embodiments, the polymeric material is characterized by a storage modulus of 300 MPa to 3000 MPa. In some embodiments, the polymeric material is characterized by a storage modulus of 750 MPa to 3000 MPa. In some embodiments, the polymeric material is characterized by a stress relaxation of 0.01 MPa to 15 MPa. In some embodiments, the polymeric material is characterized by a stress relaxation of 2 MPa to 15 MPa. In some embodiments, the polymeric material is characterized by: a stress relaxation of greater than or equal to 20% of the initial load; a glass transition temperature of greater than or equal to 90° C.; a tensile modulus from 800 MPa to 2000 MPa; and an elongation at break greater than or equal to 20%. In some embodiments, the polymeric material is biocompatible, bioinert or a combination thereof.

In still another aspect, an orthodontic appliance comprising the polymeric material is provided. In some embodiments, the orthodontic appliance is an aligner, an expander or a retainer. In some embodiments, the orthodontic appliance comprises a plurality of tooth receiving cavities configured to reposition teeth from a first configuration toward a second configuration. In some embodiments, the orthodontic appliance is one of a plurality of orthodontic aligners configured to reposition the teeth from an initial configuration toward a target configuration. In some embodiments, the orthodontic appliance is one of a plurality of aligners configured to reposition the teeth from an initial configuration toward a target configuration according to a treatment plan.

In still another aspect, a method of forming an orthodontic appliance is provided. The method includes providing the polymerizable resin composition; curing the polymerizable resin composition to form a polymeric material; and fabricating the orthodontic appliance with the polymeric material. In some embodiments, curing the polymerizable resin composition comprises exposing the polymerizable resin composition to a light source. In some embodiments, the light source is an ultraviolet light source. In some embodiments, the method further comprises heating the polymerizable resin composition to a processing temperature. In some embodiments, the processing temperature is from about 50° C. to about 120° C. In some embodiments, the processing temperature is from about 90° C. to about 110° C., from about 100° C. to about 120° C., from about 105° C. to about 115° C., or from about 108° C. to about 110° C. In some embodiments, the method further comprises heating the polymeric material at an elevated temperature. In some embodiments, the elevated temperature is from 40° C. to 150° C. In some embodiments, heating the polymeric material to the elevated temperature occurs after curing the polymerizable resin composition. In some embodiments, forming the orthodontic appliance comprises additive manufacturing. In some embodiments, forming the orthodontic appliance comprises printing the polymerizable resin composition with a 3D printer. In some embodiments, printing the polymerizable resin composition is performed using a high temperature lithography. In some embodiments, the orthodontic appliance is an aligner, an expander or a retainer.

In still another aspect, a method of preparing a medical device by an additive manufacturing process is provided. The method includes providing the polymerizable resin composition; heating the polymerizable resin composition to a processing temperature; exposing the polymerizable resin composition to radiation; polymerizing the polymerizable resin composition layer-by-layer based on a predefined design, thereby polymerizing the polymer composition to form a polymeric material; and fabricating the medical device with the polymeric material. In some embodiments, the processing temperature is from about 50° C. to about 120° C. In some embodiments, the additive manufacturing process is a 3D printing process. In some embodiments, the medical device is an orthodontic appliance.

In still another aspect, a method of repositioning a patient's teeth is provided. The method includes generating a treatment plan for a patient, the plan comprising a plurality of intermediate tooth arrangements for moving teeth along a treatment path from an initial arrangement toward a final arrangement; producing an orthodontic appliance; and moving on-track, with the orthodontic appliance, at least one of the patient's teeth toward an intermediate arrangement or a final tooth arrangement. In some embodiments, the method further comprises tracking progression of the patient's teeth along the treatment path after administration of the orthodontic appliance, the tracking comprising comparing a current arrangement of the patient's teeth to a planned arrangement of the teeth. In some embodiments, greater than 60% of the patient's teeth are on track with the treatment plan after 2 weeks of treatment. In some embodiments, the orthodontic appliance has a retained repositioning force to the at least one of the patient's teeth after 2 days that is at least 10%, at least 20%, at least 30%, at least 40%, at least 50%, at least 60%, or at least 70% of repositioning force initially provided to the at least one of the patient's teeth. In some embodiments, the method further comprises achieving on-track the movement of the at least one of the patient's teeth to the intermediate arrangement or the final tooth arrangement. In some embodiments, prior to moving on-track, with the orthodontic appliance, the at least one of the patient's teeth toward the intermediate arrangement or the final tooth arrangement, the orthodontic appliance comprises a first flexural stress; and after achieving on-track the movement of the at least one of the patient's teeth to the intermediate arrangement or the final tooth arrangement, the orthodontic appliance comprises a second flexural stress.

In still another aspect, a composition including a reactive diluent and an antioxidant stabilizer for stabilizing the reactive diluent is provided. The antioxidant stabilizer is selected from the group consisting of vitamin E, octadecyl 3-(3,5-di-tert-butyl-4-hydroxyphenyl)propionate, pentaerythritol tetrakis(3-(3,5-di-tert-butyl-4-hydroxyphenyl)propionate, pentaerythritol tetrakis(3,5-di-tert-butyl-4-hydroxyhydrocinnamate), 1,3,5-tris(3,5-di-tert-butyl-4-hydroxybenzyl)-isocyanurate, 1,3,5-tris(4-tert-butyl-3-hydroxy-2,6-dimethylbenzyl)-isocyanurate, bis(3,5-di-tert-butyl-4-hydroxyhydrocinnamoyl)-methane, 2,2′-methylenebis(4-methyl-6-tert-butylphenol), bis(2,4-di-tert-butylphenol) pentaerythritol diphosphite, tris(nonylphenyl)phosphite, tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite), ethylene bis(oxyethylene)bis[β-(3-tert-butyl-4-hydroxy-5-methylphenyl)propionate], and tetrakis[methylene-3-(3,5-di-tert-butyl-4-hydroxyphenyl)propionate]methane. In some embodiments, the reactive diluent comprises 3,3,5-trimethylcyclohexyl 2-(methacryloxy)benzoate (HSMA), benzyl salicylate methacrylate (BSMA), bisphenol A-glycidyl methacrylate (BisGMA), 2-hydroxyethyl methacrylate (HEMA), 2-hydroxybutyl methacrylate (HBMA), isobornyl methacrylate (IBMA), 2-ethylhexyl methacrylate (EHMA), 2-cyanoethyl methacrylate (CEMA), benzyl methacrylate (BMA), 2-phenoxyethyl methacrylate (PEMA), butyl methacrylate (BMA), lauryl methacrylate (LMA), syringyl methacrylate (SMA) or combinations thereof. In some embodiments, the reactive diluent shows no color change at 60° C. over four weeks.

In yet another aspect, a composition including a photoinitiator and an antioxidant stabilizer for stabilizing the photoinitiator is provided. The antioxidant stabilizer is selected from the group consisting of vitamin E, octadecyl 3-(3,5-di-tert-butyl-4-hydroxyphenyl)propionate, pentacrythritol tetrakis(3-(3,5-di-tert-butyl-4-hydroxyphenyl)propionate, pentaerythritol tetrakis(3,5-di-tert-butyl-4-hydroxyhydrocinnamate), 1,3,5-tris(3,5-di-tert-butyl-4-hydroxybenzyl)-isocyanurate, 1,3,5-tris(4-tert-butyl-3-hydroxy-2,6-dimethylbenzyl)-isocyanurate, bis(3,5-di-tert-butyl-4-hydroxyhydrocinnamoyl)-methane, 2,2′-methylenebis(4-methyl-6-tert-butylphenol), bis(2,4-di-tert-butylphenol) pentaerythritol diphosphite, tris(nonylphenyl)phosphite, tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite), ethylene bis(oxyethylene)bis[β-(3-tert-butyl-4-hydroxy-5-methylphenyl)propionate], and tetrakis[methylene-3-(3,5-di-tert-butyl-4-hydroxyphenyl)propionate]methane. In some embodiments, the photoinitiator comprises phenylbis(2,4,6-trimethylbenzoyl) phosphine oxide (BAPO), diphenyl-(2,4,6-trimethylbenzoyl) phosphine oxide (TPO), ethyl-(2,4,6-trimethylbenzoyl)phenylphosphinate (TPO-L), a polymeric TPO-L, alpha-hydroxyketone, benzil dimethyl ketal (BDK), or a combination thereof.

In some embodiments, the antioxidant stabilizer comprises vitamin E. In some embodiments, the vitamin E comprises alpha-tocopherol. In some embodiments, the vitamin E comprises mixed tocopherols selected from alpha-tocopherol, beta-tocopherol, delta-tocopherol and gamma-tocopherol. In some embodiments, a total content of the mixed tocopherols in the vitamin E is about 95 wt %. In some embodiments, the antioxidant stabilizer is tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite), octadecyl 3-(3,5-di-tert-butyl-4-hydroxyphenyl)propionate, or a mixture of tris(2,4-di-tert-butylphenyl)phosphite and pentaerythritol tetrakis(3,5-di-tert-butyl-4-hydroxyhydrocinnamate). In some embodiments, the composition comprises the antioxidant stabilizer in an amount no greater than 2000 ppm. In some embodiments, the composition comprises the antioxidant stabilizer in an amount of 100 ppm, 200 ppm, 500 ppm, 1000 ppm or 2000 ppm. In some embodiments, the composition is used for forming an orthodontic appliance by additive manufacturing. In some embodiments, the orthodontic appliance is an aligner, an expander or a retainer.

### BRIEF DESCRIPTION OF THE DRAWINGS

FIG. 1A illustrates a tooth repositioning appliance, in accordance with some embodiments of the present disclosure.

FIG. 1B illustrates a tooth repositioning system, in accordance with some embodiments of the present disclosure.

FIG. 1C illustrates a method of orthodontic treatment using a plurality of appliances, in accordance with some embodiments of the present disclosure.

FIG. 2 is a partially schematic illustration of a system for additive manufacturing, in accordance with some embodiments of the present disclosure.

FIG. 3 illustrates a method for designing an orthodontic appliance, in accordance with some embodiments of the present disclosure.

FIG. 4 illustrates a method for digitally planning an orthodontic treatment, in accordance with some embodiments of the present disclosure.

FIG. 5 shows generating and administering treatment, in accordance with some embodiments of the present disclosure.

FIG. 6 shows a schematic configuration of a high temperature additive manufacturing device used for curing polymerizable compositions of the present disclosure by using a 3D printing process, in accordance with some embodiments of the present disclosure.

FIG. 7 depicts viscosity changes of polymerizable resin compositions according to the present disclosure and control composition over time.

FIG. 8 depicts viscosity values of samples comprising antioxidant stabilizers of the present disclosure and control sample comprising BHT upon formulation and after accelerated aging at various temperatures.

### DETAILED DESCRIPTION OF THE INVENTION

Polymerizable resin for additive manufacturing is typically composed of a polymerizable component (e.g., a polymer precursor) and a photoinitiator. The photoinitiator decomposes under UV radiation, generating radicals that react with the polymer precursor to form a polymeric material. During an additive manufacturing process, the polymerizable resin can be prepared and loaded into programmable digitally-controlled light-based curing systems, such as stereolithography (SLA) or digital light processor (DLP)-based additive manufacturing systems (“vat photopolymerization”), where 3D objects (e.g., orthodontic appliances) can be formed in a progressive layer-by-layer, dropwise, or continuous photocuring manner.

Ethylenically unsaturated polymeric precursors, such as acrylates, vinyl ethers, and vinyl esters, employed in polymerizable resins, are susceptible to undesired polymerization and/or oxidation when exposed to elevated temperatures during various stages of additive manufacturing, handling, storage, and transportation. For instance, the thermal polymerization of these polymer precursors during transportation and storage may lead to an undesired increase in viscosity or gel formation, consequently reducing the processability of the polymerizable resins. Furthermore, thermal polymerization and/or oxidation of these polymer precursors may cause the clear resins to turn yellow over time. This yellowing effect has a negative impact on the esthetic quality of the 3D objects later produced.

To achieve the desired thermomechanical properties, including elongation, time stress-relaxation, modulus, durability, and toughness, necessary for aligners and other orthodontic appliances, high molecular weight prepolymers, such as prepolymers having a number average molecular weight greater than 5 kDa, are often used. In order to process such resins effectively, hot lithography-based photopolymerization is performed. The process involves pre-heating both the polymerizable resins and the printing platform to elevated printing temperatures, typically ranging from 60° C. to 120° C. Viscosities of the polymerizable resins at these temperatures need to be sufficiently low, despite the presence of the high molecular weight prepolymers. However, undesired polymerization at the pre-heating stage may reduce processibility of the polymerizable resins.

During the printing process used to build (or print) 3D objects, polymerizable resin is deposited one thin layer at a time. The layers are each cured via exposure to UV light, solidifying them into solid material matching a programmed computer-assisted design (CAD) file. Such a process repeats itself layer by layer until an entire part has been constructed. In the current technology, once a layer is deposited, a leveler removes excess, non-solidified resin material to improve printing accuracy and ensure layer uniformity. In 3D printing, after a single material layer is printed and leveled but before it is cured, the excess leveled material is recirculated for reuse in printing subsequent layers. However, the undesired polymerization may make the leveled material un-reusable. Since the resin materials are very expensive, the undesired polymerization during the 3D printing process may increase the cost of printing. In addition, it is desirable that the photoinitiator in the recovered resin composition remains active.

To prevent the undesired polymerization and oxidation of resin components, stabilizers (e.g., polymerization inhibitors) are added to the polymerizable resins. These stabilizers help suppress unwanted polymerization and/or oxidation reactions of polymeric precursors, and prevent the decomposition of the photoinitiators in the recovered resin, thereby prolonging the shelf life of polymerizable resins, increasing processibility, and reducing the manufacturing costs. Butylated hydroxytoluene (BHT) has been extensively used as a stabilizer in 3D printing as well as in foods, food packaging, cosmetics, and pharmaceuticals. However, growing concerns about its toxicity and suspected endocrine-disrupting effects have led to BHT being banned in certain countries. New non-toxic stabilizers are thus needed to prevent the undesired polymerization and/or oxidation of the polymer precursors as well as the depletion of the photoinitiators without compromising the curing rate of the polymerizable resin and the mechanical properties of the resulting polymeric materials.

Antioxidants, such as vitamin E, offer a safe alternative to BHT as stabilizers in 3D printing. The advantages of using antioxidants are that they are not only highly efficient radical scavengers but also non-toxic. For example, most people can take up to 1000 mg/day of vitamin E. Accordingly, the present disclosure provides non-toxic photopolymerizable (i.e., photocurable) resins containing one or more antioxidants, including vitamin E, octadecyl 3-(3,5-di-tert-butyl-4-hydroxyphenyl)propionate, pentaerythritol tetrakis(3-(3,5-di-tert-butyl-4-hydroxyphenyl)propionate, pentaerythritol tetrakis(3,5-di-tert-butyl-4-hydroxyhydrocinnamate), 1,3,5-tris(3,5-di-tert-butyl-4-hydroxybenzyl)-isocyanurate, 1,3,5-tris(4-tert-butyl-3-hydroxy-2,6-dimethylbenzyl)-isocyanurate, bis(3,5-di-tert-butyl-4-hydroxyhydrocinnamoyl)-methane, 2,2′-methylenebis(4-methyl-6-tert-butylphenol), bis(2,4-di-tert-butylphenol) pentaerythritol diphosphite, tris(nonylphenyl)phosphite, tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite), ethylene bis(oxyethylene)bis[β-(3-tert-butyl-4-hydroxy-5-methylphenyl)propionate], and tetrakis[methylene-3-(3,5-di-tert-butyl-4-hydroxyphenyl)propionate]methane. These antioxidants act as stabilizers to prevent undesired polymerization of the polymer precursors during various stages of 3D printing, as well as throughout handling, storage, and transportation. Using antioxidants as the stabilizers in polymerizable resins not only helps to increase shelf life and color stability and to case the restrictions on shipping conditions of the resins, but also helps to improve the processability and the reusability of the polymerizable resins. As a result, the manufacturing costs can be reduced.

### Definitions

All terms, chemical names, expressions and designations have their usual meanings which are well-known to those skilled in the art. As used herein, the terms “to comprise” and “comprising” are to be understood as non-limiting, i.e., other components than those explicitly named may be included.

Number ranges are to be understood as inclusive, i.e., including the indicated lower and upper limits. Furthermore, the term “about”, as used herein, and unless clearly indicated otherwise, generally refers to and encompasses plus or minus 10% of the indicated numerical value(s). For example, “about 10%” may indicate a range of 9% to 11%, and “about 1” may include the range 0.9-1.1.

As used herein, the term “monomer” refers to a molecule having a reactive functional group capable of undergoing a radical initiated polymerization reaction (e.g., alkenes or functionally substituted alkenes). Such polymerization reaction can be a photo-induced polymerization, e.g., via radical generation. In some embodiments, a monomer component is ethene, chloroethene, fluoroethene, chlorotrifluoroethene, tetrafluoroethene, propene, 2-methylpropene, styrene, propenenitrile, methyl methacrylate, phenyl ethylene, butyl acrylate, 1,6-hexandiol diacrylate, isobornyl methacrylate, homosalic methacrylate, ortho-phenylphenyl methacrylate, etc.

As used herein, the term “polymer” generally refers to a molecule composed of repeating structural units connected by covalent chemical bonds and characterized by a substantial number of repeating units (e.g., equal to or greater than 20 repeating units and often equal to or greater than 100 repeating units and often equal to or greater than 200 repeating units) and a molecular weight greater than or equal to 5,000 Daltons (Da) or 5 kDa, such as greater than or equal to 10 kDa, 15 kDa, 20 kDa, 30 kDa, 40 kDa, 50 kDa, or 100 kDa. Polymers are commonly the polymerization product of one or more monomer precursors. The term polymer includes homopolymers, i.e., polymers consisting essentially of a single repeating monomer species. The term polymer also includes copolymers which are formed when two or more different types (or species) of monomers are linked in the same polymer. Copolymers may comprise two or more different monomer species, and include random, block, alternating, segmented, grafted, tapered and other copolymers. The term “cross-linked polymers” generally refers to polymers having one or multiple links between at least two polymer chains, which can result from multivalent monomers forming cross-linking sites upon polymerization. In various embodiments, a polymer herein is a telechelic polymer capable of undergoing further polymerization reactions, e.g., with other polymerizable components present in a polymerizable resin composition.

As used herein, the term “oligomer” generally refers to a molecule composed of repeating structural units connected by covalent chemical bonds and characterized by a number of repeating units less than that of a polymer (e.g., equal to or less than 20 or less than 10 repeating units) and a lower molecular weight than polymers, e.g., less than 5,000 Da or less than 2,000 Da, and in various cases from about 0.4 kDa to about 5 kDa. In some cases, oligomers may be the polymerization product of one or more monomer precursors. In various embodiments, an oligomer herein is a telechelic oligomer capable of undergoing further polymerization reactions, e.g., with other polymerizable components present in a polymerizable resin composition.

As used herein, the terms “telechelic polymer” and “telechelic oligomer” generally refer to a polymer or oligomer the molecules of which are capable of entering, through polymerizable reactive functional groups, into further polymerization.

As used herein, the term “reactive diluent” generally refers to a substance which reduces the viscosity of another substance, such as a monomer or polymerizable resin. A reactive diluent may become part of another substance, such as a polymer obtained by a polymerization process. In some examples, a reactive diluent is a polymerizable monomer which, when mixed with a polymerizable resin, reduces the viscosity of the resultant formulation and is incorporated into the polymer that results from polymerization of the formulation.

Oligomer and polymer mixtures can be characterized and differentiated from other mixtures of oligomers and polymers by measurements of molecular weight and molecular weight distributions.

The molecular weight (M) is a number-average molecular weight (Mₙ), which is the average number of repeating units n times the molecular weight or molar mass (Mᵢ) of the repeating unit. The number-average molecular weight (Mₙ) is the arithmetic mean, representing the total weight of the molecules present divided by the total number of molecules.

Photoinitiators described in the present disclosure can include those that can be activated with light and initiate polymerization of the polymerizable components of a resin or formulation. A “photoinitiator”, as used herein, may generally refer to a compound that can produce radical species and/or promote radical reactions upon exposure to radiation (e.g., UV or visible light).

The term “biocompatible,” as used herein, refers to a material that does not elicit an immunological rejection or detrimental effect, referred herein as an adverse immune response, when it is disposed within an in-vivo biological environment. For example, in embodiments a biological marker indicative of an immune response changes less than 10%, or less than 20%, or less than 25%, or less than 40%, or less than 50% from a baseline value when a human or animal is exposed to or in contact with the biocompatible material. Alternatively, immune response may be determined histologically, wherein localized immune response is assessed by visually assessing markers, including immune cells or markers that are involved in the immune response pathway, in and adjacent to the material. In an aspect, a biocompatible material or device does not observably change immune response as determined histologically. In some embodiments, the disclosure provides biocompatible devices configured for long-term use, such as on the order of weeks to months, without invoking an adverse immune response. Biological effects may be initially evaluated by measurement of cytotoxicity, sensitization, irritation and intracutaneous reactivity, acute systemic toxicity, pyrogenicity, subacute/subchronic toxicity and/or implantation. Biological tests for supplemental evaluation include testing for chronic toxicity.

“Bioinert” refers to a material that does not elicit an immune response from a human or animal when it is disposed within an in-vivo biological environment. For example, a biological marker indicative of an immune response remains substantially constant (plus or minus 5% of a baseline value) when a human or animal is exposed to or in contact with the bioinert material. In some embodiments, the disclosure provides bioinert devices.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individually or in any combination. Additionally, unless otherwise specified, all isotopic variants of compounds disclosed herein are intended to be encompassed by the disclosure. Specific names of compounds are intended to be exemplary, as it is known that one of ordinary skill in the art can name the same compounds differently.

It is noted that as used herein and in the appended claims, the singular forms “a”, “an”, and “the” include plural reference unless the context clearly dictates otherwise. Thus, for example, reference to “a monomer” includes a plurality of such monomers and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim.

As used herein, the term “group” may refer to a reactive functional group of a chemical compound. Groups of the present compounds refer to an atom or a collection of atoms that are a part of the compound. Groups of the present disclosure may be attached to other atoms of the compound via one or more covalent bonds. Groups may also be characterized with respect to their valence state. The present disclosure includes groups characterized as monovalent, divalent, trivalent, etc. valence states.

As used herein, the term “substituted” refers to a compound (e.g., an alkyl chain) wherein a hydrogen is replaced by another reactive functional group or atom, as described herein.

As used herein,

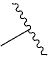

in a chemical structure, e.g.,

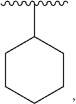 [SMILES: *C1CCCCC1]

can be used to indicate that the given moiety, the cyclohexyl moiety in this example, is attached to a molecule via the bond that is “capped” with the wavy line.

“Aliphatic” or “aliphatic group” as used herein means a straight-chain or branched C₁-C₃₀ hydrocarbon chain that is completely saturated or that contains one or more units of unsaturation, or a monocyclic C₃-C₂₀ hydrocarbon or bicyclic C₈-C₂₀ hydrocarbon that is completely saturated or that contains one or more units of unsaturation, but which is not aromatic (also referred to herein as “cycloalkyl”), that has a single point of attachment to the rest of the molecule where in any individual ring in said bicyclic ring system has 3-7 members. For example, suitable aliphatic groups include, but are not limited to, linear or branched alkyl, alkenyl, alkynyl groups and hybrids thereof such as (cycloalkyl)alkyl, (cycloalkenyl)alkyl or (cycloalkyl)alkonyl.

Alkyl groups include straight-chain, branched and cyclic alkyl groups, unless otherwise defined for a compound or genus of compounds. Alkyl groups include those having from 1 to 30 carbon atoms, unless otherwise defined. Thus, alkyl groups can include small alkyl groups having 1 to 3 carbon atoms, medium length alkyl groups having from 4-10 carbon atoms, as well as long alkyl groups having more than 10 carbon atoms, particularly those having 10-30 carbon atoms. The term cycloalkyl specifically refers to an alkyl group having a ring structure such as a ring structure comprising 3-30 carbon atoms, optionally 3-20 carbon atoms and optionally 3-10 carbon atoms, including an alkyl group having one or more rings. Cycloalkyl groups include those having a 3-, 4-, 5-, 6-, 7-, 8-, 9- or 10-member carbon ring(s) and particularly those having a 3-, 4-, 5-, 6-, 7- or 8-member ring(s). The carbon rings in cycloalkyl groups can also carry alkyl groups. Cycloalkyl groups can include bicyclic and tricyclic alkyl groups. Alkyl groups are optionally substituted, as described herein. Substituted alkyl groups can include among others those which are substituted with aryl groups, which in turn can be optionally substituted. Specific alkyl groups include methyl, ethyl, n-propyl, iso-propyl, cyclopropyl, n-butyl, s-butyl, t-butyl, cyclobutyl, n-pentyl, branched-pentyl, cyclopentyl, n-hexyl, branched hexyl, and cyclohexyl groups, all of which are optionally substituted. Unless otherwise defined herein, substituted alkyl groups include fully halogenated or semihalogenated alkyl groups, such as alkyl groups having one or more hydrogens replaced with one or more fluorine atoms, chlorine atoms, bromine atoms and/or iodine atoms. Thus, substituted alkyl groups can include fully fluorinated or semifluorinated alkyl groups, such as alkyl groups having one or more hydrogens replaced with one or more fluorine atoms. An alkoxy group is an alkyl group that has been modified by linkage to oxygen and can be represented by the formula R—O and can also be referred to as an alkyl ether group. Examples of alkoxy groups include, but are not limited to, methoxy, ethoxy, propoxy, butoxy and heptoxy. Alkoxy groups include substituted alkoxy groups wherein the alkyl portion of the groups is substituted as provided herein in connection with the description of alkyl groups. As used herein MeO-refers to CH₃O—. Moreover, a thioalkoxy group, as used herein is an alkyl group that has been modified by linkage to a sulfur atom (instead of an oxygen) and can be represented by the formula R—S.

Alkenyl groups include straight-chain, branched and cyclic alkenyl groups. Alkenyl groups include those having 1, 2 or more double bonds and those in which two or more of the double bonds are conjugated double bonds. Unless otherwise defined herein, alkenyl groups include those having from 2 to 20 carbon atoms. Alkenyl groups include small alkenyl groups having 2 to 3 carbon atoms. Alkenyl groups include medium length alkenyl groups having from 4-10 carbon atoms. Alkenyl groups include long alkenyl groups having more than 10 carbon atoms, particularly those having 10-20 carbon atoms. Cycloalkenyl groups include those in which a double bond is in the ring or in an alkenyl group attached to a ring. The term cycloalkenyl specifically refers to an alkenyl group having a ring structure, including an alkenyl group having a 3-, 4-, 5-, 6-, 7-, 8-, 9- or 10-member carbon ring(s) and particularly those having a 3-, 4-, 5-, 6-, 7- or 8-member ring(s). The carbon rings in cycloalkenyl groups can also carry alkyl groups. Cycloalkenyl groups can include bicyclic and tricyclic alkenyl groups. Alkenyl groups are optionally substituted. Unless otherwise defined herein, substituted alkenyl groups include among others those that are substituted with alkyl or aryl groups, which groups in turn can be optionally substituted. Specific alkenyl groups include ethenyl, prop-1-enyl, prop-2-enyl, cycloprop-1-enyl, but-1-enyl, but-2-enyl, cyclobut-1-enyl, cyclobut-2-enyl, pent-1-enyl, pent-2-enyl, branched pentenyl, cyclopent-1-enyl, hex-1-enyl, branched hexenyl, cyclohexenyl, all of which are optionally substituted. Substituted alkenyl groups can include fully halogenated or semihalogenated alkenyl groups, such as alkenyl groups having one or more hydrogens replaced with one or more fluorine atoms, chlorine atoms, bromine atoms and/or iodine atoms. Substituted alkenyl groups include fully fluorinated or semifluorinated alkenyl groups, such as alkenyl groups having one or more hydrogen atoms replaced with one or more fluorine atoms.

Aryl groups include groups having one or more 5-, 6-, 7- or 8-membered aromatic rings, including heterocyclic aromatic rings. The term heteroaryl specifically refers to aryl groups having at least one 5-, 6-, 7- or 8-member heterocyclic aromatic ring. Aryl groups can contain one or more fused aromatic rings, including one or more fused heteroaromatic rings, and/or a combination of one or more aromatic rings and one or more nonaromatic rings that may be fused or linked via covalent bonds. Heterocyclic aromatic rings can include one or more N, O, or S atoms in the ring. Heterocyclic aromatic rings can include those with one, two or three N atoms, those with one or two O atoms, and those with one or two S atoms, or combinations of one or two or three N, O or S atoms. Aryl groups are optionally substituted. Substituted aryl groups include among others those that are substituted with alkyl or alkenyl groups, which groups in turn can be optionally substituted. Specific aryl groups include phenyl, biphenyl groups, pyrrolidinyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, and naphthyl groups, all of which are optionally substituted. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogens replaced with one or more fluorine atoms. Aryl groups include, but are not limited to, aromatic group-containing or heterocyclic aromatic group-containing groups corresponding to any one of the following: benzene, naphthalene, naphthoquinone, diphenylmethane, fluorene, anthracene, anthraquinone, phenanthrene, tetracene, tetracenedione, pyridine, quinoline, isoquinoline, indoles, isoindole, pyrrole, imidazole, oxazole, thiazole, pyrazole, pyrazine, pyrimidine, purine, benzimidazole, furans, benzofuran, dibenzofuran, carbazole, acridine, acridone, phenanthridine, thiophene, benzothiophene, dibenzothiophene, xanthene, xanthone, flavone, coumarin, azulene or anthracycline. As used herein, a group corresponding to the groups listed above expressly includes an aromatic or heterocyclic aromatic group, including monovalent, divalent and polyvalent groups, of the aromatic and heterocyclic aromatic groups listed herein provided in a covalently bonded configuration in the compounds of the disclosure at any suitable point of attachment. In some embodiments, aryl groups contain between 5 and 30 carbon atoms. In some embodiments, aryl groups contain one aromatic or heteroaromatic six-member ring and one or more additional five- or six-member aromatic or heteroaromatic ring. In embodiments, aryl groups contain between five and eighteen carbon atoms in the rings. Aryl groups optionally have one or more aromatic rings or heterocyclic aromatic rings having one or more electron donating groups, electron withdrawing groups and/or targeting ligands provided as substituents.

Arylalkyl groups are alkyl groups substituted with one or more aryl groups wherein the alkyl groups optionally carry additional substituents and the aryl groups are optionally substituted. Specific arylalkyl groups are phenyl-substituted alkyl groups, e.g., phenylmethyl groups. Alkylaryl groups are alternatively described as aryl groups substituted with one or more alkyl groups wherein the alkyl groups optionally carry additional substituents and the aryl groups are optionally substituted. Specific alkylaryl groups are alkyl-substituted phenyl groups such as methylphenyl. Substituted arylalkyl groups include fully halogenated or semihalogenated arylalkyl groups, such as arylalkyl groups having one or more alkyl and/or aryl groups having one or more hydrogens replaced with one or more fluorine atoms, chlorine atoms, bromine atoms and/or iodine atoms.

As used herein, the terms “alkylene” and “alkylene group” are used synonymously and refer to a divalent group “—CH₂—” derived from an alkyl group as defined herein. The disclosure includes compounds having one or more alkylene groups. Alkylene groups in some compounds function as attaching and/or spacer groups. Compounds of the disclosure may have substituted and/or unsubstituted C₁-C₂₀ alkylene, C₁-C₁₀ alkylene and C₁-C₆ alkylene groups.

As used herein, the terms “cycloalkylene” and “cycloalkylene group” are used synonymously and refer to a divalent group derived from a cycloalkyl group as defined herein. The disclosure includes compounds having one or more cycloalkylene groups. Cycloalkyl groups in some compounds function as attaching and/or spacer groups. Compounds of the disclosure may have substituted and/or unsubstituted C₃-C₂₀ cycloalkylene, C₃-C₁₀ cycloalkylene and C₃-C₆ cycloalkylene groups.

As used herein, the terms “arylene” and “arylene group” are used synonymously and refer to a divalent group derived from an aryl group as defined herein. The disclosure includes compounds having one or more arylene groups. In some embodiments, an arylene is a divalent group derived from an aryl group by removal of hydrogen atoms from two intra-ring carbon atoms of an aromatic ring of the aryl group. Arylene groups in some compounds function as attaching and/or spacer groups. Arylene groups in some compounds function as chromophore, fluorophore, aromatic antenna, dye and/or imaging groups. Compounds of the disclosure include substituted and/or unsubstituted C₅-C₃₀ arylene, C₅-C₂₀ arylene, C₅-C₁₀ arylene and C₅-C₆ arylene groups.

As used herein, the terms “heteroarylene” and “heteroarylene group” are used synonymously and refer to a divalent group derived from a heteroaryl group as defined herein. The disclosure includes compounds having one or more heteroarylene groups. In some embodiments, a heteroarylene is a divalent group derived from a heteroaryl group by removal of hydrogen atoms from two intra-ring carbon atoms or intra-ring nitrogen atoms of a heteroaromatic or aromatic ring of the heteroaryl group. Heteroarylene groups in some compounds function as attaching and/or spacer groups. Heteroarylene groups in some compounds function as chromophore, aromatic antenna, fluorophore, dye and/or imaging groups. Compounds of the disclosure include substituted and/or unsubstituted C₄-C₃₀ heteroarylene, C₄-C₂₀ heteroarylene, C₄-C₁₀ heteroarylene and C₄-C₆ heteroarylene groups.

As used herein, the terms “alkenylene” and “alkenylene group” are used synonymously and refer to a divalent group derived from an alkenyl group as defined herein. The invention includes compounds having one or more alkenylene groups. Alkenylene groups in some compounds function as attaching and/or spacer groups. Compounds of the disclosure include substituted and/or unsubstituted C₂-C₂₀ alkenylene, C₂-C₁₀ alkenylene and C₂-C₅ alkenylene groups.

As used herein, the terms “cycloalkenylene” and “cycloalkenylene group” are used synonymously and refer to a divalent group derived from a cycloalkenyl group as defined herein. The disclosure includes compounds having one or more cycloalkenylene groups. Cycloalkenylene groups in some compounds function as attaching and/or spacer groups. Compounds of the disclosure include substituted and/or unsubstituted C₃-C₂₀ cycloalkenylene, C₃-C₁₀ cycloalkenylene and C₃-C₅ cycloalkenylene groups.

As used herein, the terms “alkynylene” and “alkynylene group” are used synonymously and refer to a divalent group derived from an alkynyl group as defined herein. The disclosure includes compounds having one or more alkynylene groups. Alkynylene groups in some compounds function as attaching and/or spacer groups. Compounds of the disclosure include substituted and/or unsubstituted C₂-C₂₀ alkynylene, C₂-C₁₀ alkynylene and C₂-C₅ alkynylene groups.

As used herein, the terms “halo” and “halogen” can be used interchangeably and refer to a halogen group such as a fluoro (—F), chloro (—Cl), bromo (—Br) or iodo (—I).

The term “heterocyclic” refers to ring structures containing at least one other kind of atom, in addition to carbon, in the ring. Examples of such heteroatoms include nitrogen, oxygen and sulfur. Heterocyclic rings include heterocyclic alicyclic rings and heterocyclic aromatic rings. Examples of heterocyclic rings include, but are not limited to, pyrrolidinyl, piperidyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, triazolyl and tetrazolyl groups. Atoms of heterocyclic rings can be bonded to a wide range of other atoms and reactive functional groups, for example, provided as substituents.

The term “carbocyclic” refers to ring structures containing only carbon atoms in the ring. Carbon atoms of carbocyclic rings can be bonded to a wide range of other atoms and reactive functional groups, for example, provided as substituents.

The term “alicyclic ring” refers to a ring, or plurality of fused rings, that is not an aromatic ring. Alicyclic rings include both carbocyclic and heterocyclic rings.

The term “aromatic ring” refers to a ring, or a plurality of fused rings, that includes at least one aromatic ring group. The term aromatic ring includes aromatic rings comprising carbon, hydrogen and heteroatoms. Aromatic ring includes carbocyclic and heterocyclic aromatic rings. Aromatic rings are components of aryl groups.

The term “fused ring” or “fused ring structure” refers to a plurality of alicyclic and/or aromatic rings provided in a fused ring configuration, such as fused rings that share at least two intra ring carbon atoms and/or heteroatoms.

As used herein, the term “alkoxyalkyl” refers to a substituent of the formula alkyl-O-alkyl.

As used herein, the term “polyhydroxyalkyl” refers to a substituent having from 2 to 12 carbon atoms and from 2 to 5 hydroxyl groups, such as the 2,3-dihydroxypropyl, 2,3,4-trihydroxybutyl or 2,3,4,5-tetrahydroxypentyl residue.

As used herein, the term “polyalkoxyalkyl” refers to a substituent of the formula alkyl-(alkoxy) n-alkoxy wherein n is an integer from 1 to 10, e.g., 1 to 4, and in some embodiments 1 to 3.

The term “heteroalkyl”, as used herein, generally refers to an alkyl, alkenyl or alkynyl group as defined herein, wherein at least one carbon atom of the alkyl group is replaced with a heteroatom. In some instances, heteroalkyl groups may contain from 1 to 18 non-hydrogen atoms (carbon and heteroatoms) in the chain, or from 1 to 12 non-hydrogen atoms, or from 1 to 6 non-hydrogen atoms, or from 1 to 4 non-hydrogen atoms. Heteroalkyl groups may be straight or branched, and saturated or unsaturated. Unsaturated heteroalkyl groups have one or more double bonds and/or one or more triple bonds. Heteroalkyl groups may be unsubstituted or substituted. Exemplary heteroalkyl groups include, but are not limited to, alkoxyalkyl (e.g., methoxymethyl), and aminoalkyl (e.g., alkylaminoalkyl and dialkylaminoalkyl). Heteroalkyl groups may be optionally substituted with one or more substituents.

The term “carbonyl”, as used herein, for example in the context of C₁₋₆ carbonyl substituents, generally refers to a carbon chain of given length (e.g., C₁₋₆), wherein each of the carbon atom of a given carbon chain can form the carbonyl bond, as long as it chemically feasible in terms of the valence state of that carbon atom. Thus, in some instance, the “C₁₋₆ carbonyl” substituent refers to a carbon chain of between 1 and 6 carbon atoms, and either the terminal carbon contains the carbonyl functionality, or an inner carbon contains the carbonyl functionality, in which case the substituent could be described as a ketone. The term “carboxy”, as used herein, for example in the context of C₁₋₆ carboxyl substituents, generally refers to a carbon chain of given length (e.g., C₁₋₆), wherein a terminal carbon contains the carboxy functionality, unless otherwise defined herein.

As to any of the groups described herein that contain one or more substituents, it is understood that such groups do not contain any substitution or substitution patterns which are sterically impractical and/or synthetically non-feasible. In addition, the compounds of this disclosure include all stereochemical isomers arising from the substitution of these compounds.

Unless otherwise defined herein, optional substituents for any alkyl, alkenyl and aryl group include substitution with one or more of the following substituents, among others:
halogen, including fluorine, chlorine, bromine or iodine;
pseudohalides, including —CN, —OCN (cyanate), —NCO (isocyanate), —SCN (thiocyanate) and —NCS (isothiocyanate);
—COOR, where R is a hydrogen or an alkyl group or an aryl group and more specifically where R is a methyl, ethyl, propyl, butyl, or phenyl group all of which groups are optionally substituted;
—COR, where R is a hydrogen or an alkyl group or an aryl group and more specifically where R is a methyl, ethyl, propyl, butyl, or phenyl group all of which groups are optionally substituted;
—CON(R)₂, where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—OCON(R)₂, where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—N(R)₂, where each R, independently of each other R, is a hydrogen, or an alkyl group, or an acyl group or an aryl group and more specifically where R is a methyl, ethyl, propyl, butyl, phenyl or acetyl group, all of which are optionally substituted; and where R and R can form a ring that can contain one or more double bonds and can contain one or more additional carbon atoms;
—SR, where R is hydrogen or an alkyl group or an aryl group and more specifically where R is hydrogen, methyl, ethyl, propyl, butyl, or a phenyl group, which are optionally substituted;
—SO₂R, or —SOR, where R is an alkyl group or an aryl group and more specifically where R is a methyl, ethyl, propyl, butyl, or phenyl group, all of which are optionally substituted;
—OCOOR, where R is an alkyl group or an aryl group;
—SO₂N(R)₂, where each R, independently of each other R, is a hydrogen, or an alkyl group, or an aryl group all of which are optionally substituted and wherein R and R can form a ring that can contain one or more double bonds and can contain one or more additional carbon atoms; and
—OR, where R is H, an alkyl group, an aryl group, or an acyl group all of which are optionally substituted. In a particular example R can be an acyl yielding —OCOR″, wherein R″ is a hydrogen or an alkyl group or an aryl group and more specifically where R″ is methyl, ethyl, propyl, butyl, or phenyl groups all of which groups are optionally substituted

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di-, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups; and methoxyphenyl groups, particularly 4-methoxyphenyl groups.

As to any of the above groups that contain one or more substituents, it is understood that such groups do not contain any substitution or substitution patterns which are sterically impractical and/or synthetically non-feasible. In addition, as further described herein, the compounds of this disclosure can include all stereochemical isomers (and racemic mixtures) arising from the substitution of these compounds.

### Polymerizable Resin Compositions

In some embodiments, the present disclosure provides stable polymerizable resin compositions comprising a plurality of polymerizable components and an antioxidant stabilizer as a safe alternative of BHT. The antioxidant stabilizer improves processing, storage and transportation stability of the polymerizable resin compositions by suppressing polymerization and/or oxidation reactions of the resin components, drafts of resin viscosity and gel time. In some embodiments, the polymerizable resin composition herein is a photopolymerizable composition, a thermo-polymerizable composition, or a combination thereof. In some embodiments, a polymerizable resin composition includes an antioxidant stabilizer, one or more species of telechelic compound (e.g., toughness modifiers and glass transition temperature modifiers), and one or more species of polymerizable monomers (e.g. reactive diluents). The polymerizable resin compositions provided herein can comprise lower amounts of antioxidant stabilizers to effectively inhibit polymerization and/or oxidation reactions of the polymerizable components of the polymerizable resin compositions compared to conventional resin compositions using a BHT as the stabilizer. As a result, the storage shelf life of the polymerizable resin compositions can be improved and with a lesser amount of stabilizers, the shipping and warehouse storage costs can be reduced. Antioxidant stabilizers also help to improve processability and reusability of the polymerizable resin compositions during 3D printing process. As a result, the manufacturing costs can also be reduced.

### 1) Antioxidant Stabilizers

A polymerizable resin composition of the present disclosure can comprise an antioxidant stabilizer to prevent undesired polymerization of the polymerizable components in the composition. The antioxidant stabilizer can improve the storage stability of the composition so that undesired polymer is not formed in the overheated space of the storage container during transportation and/or storage. Additionally, the antioxidant stabilizer can improve processability and reusability of the polymerizable resin composition during 3D printing process so as to reduce manufacturing costs. Furthermore, by stabilizing polymerizable components in the polymerizable resin composition, the yellowing effect of the reactive diluent due to the undesired oxidation of the reactive diluent can be reduced.

In some embodiments, the antioxidant stabilizer may include one or more of vitamin E, octadecyl 3-(3,5-di-tert-butyl-4-hydroxyphenyl)propionate, pentaerythritol tetrakis(3-(3,5-di-tert-butyl-4-hydroxyphenyl)propionate, pentaerythritol tetrakis(3,5-di-tert-butyl-4-hydroxyhydrocinnamate), 1,3,5-tris(3,5-di-tert-butyl-4-hydroxybenzyl)-isocyanurate, 1,3,5-tris(4-tert-butyl-3-hydroxy-2,6-dimethylbenzyl)-isocyanurate, bis(3,5-di-tert-butyl-4-hydroxyhydrocinnamoyl)-methane, 2,2′-methylenebis(4-methyl-6-tert-butylphenol), bis(2,4-di-tert-butylphenol) pentaerythritol diphosphite, tris(nonylphenyl)phosphite, tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite), ethylene bis(oxyethylene)bis[β-(3-tert-butyl-4-hydroxy-5-methylphenyl)propionate], and tetrakis[methylene-3-(3,5-di-tert-butyl-4-hydroxyphenyl)propionate]methane.

In some embodiments, the antioxidant stabilizer comprises vitamin E. In some embodiments, vitamin E includes alpha-tocopherol. In some embodiments, vitamin E comprises alpha-tocopherol having a purity greater than 96%. The alpha-tocopherol can be used alone or in combination with the other forms of vitamin E, including beta-tocopherol, delta-tocopherol, and gamma-tocopherol. In some embodiments, vitamin E includes mixed tocopherols selected from alpha-tocopherol, beta-tocopherol, delta-tocopherol, and gamma-tocopherol. In some embodiments, the total amount of the mixed tocopherols in vitamin E is about 30 wt %, 40 wt %, 50 wt %, 60 wt %, 70 wt %, 80 wt %, 90 wt %, or 95 wt %.

In some embodiments, the antioxidant stabilizer is tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite), octadecyl 3-(3,5-di-tert-butyl-4-hydroxyphenyl)propionate, or combinations thereof. In some embodiments, the antioxidation stabilizer is a mixture of tris(2,4-di-tert-butylphenyl)phosphite and pentaerythritol tetrakis(3,5-di-tert-butyl-4-hydroxyhydrocinnamate).

In some embodiments, the polymerizable resin composition may comprise 1 to 2000 parts per million (ppm), for example, from 1 to 10 ppm, 10 to 50 ppm, 50 to 100 ppm, 100 to 150 ppm, 150 to 200 ppm, 200 to 300 ppm, 300 to 400 ppm, 400 to 500 ppm, 500 to 600 ppm, 600 to 700 ppm, 700 to 800 ppm, 800 to 900 ppm, 900 to 1000 ppm, 1000 to 1500 ppm, or 1500 to 2000 ppm. In some embodiments, the polymerizable resin composition comprises from 100 to 1000 ppm, 100 to 900 ppm, 100 to 800 ppm, 100 to 700 ppm, 100 to 600 ppm, 100 to 500 ppm, 200 to 900 ppm, 200 to 800 ppm, 200 to 700 ppm, 200 to 600 ppm, or 200 to 500 ppm, based on the total weight of the composition, of the antioxidant stabilizer. In some embodiments, the polymerizable resin composition comprises less than 1500 ppm, less than 1000 ppm, less than 900 ppm, less than 800 ppm, less than 700 ppm, less than 600 ppm, less than 500 ppm, less than 400 ppm, less than 300 ppm, or less than 200 ppm, based on the total weight of the composition, of the antioxidant stabilizer. In some embodiments, the polymerizable resin composition comprises 100 ppm, 200 ppm, 300 ppm, 400 ppm, 500 ppm, 800 ppm, 1000 ppm, 1500 ppm, or 2000 ppm, based on the total weight of the composition, of the antioxidant stabilizer. In some embodiments, the polymerizable resin composition comprises 200 ppm or 300 ppm of vitamin E. In some embodiments, the polymerizable resin composition comprises 500 ppm of tris(2,4-di-tert-butylphenyl)phosphite and 500 ppm of pentacrythritol tetrakis(3,5-di-tert-butyl-4-hydroxyhydrocinnamate). In some embodiments, the polymerizable resin composition comprises 1000 ppm of tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite). In some embodiments, the polymerizable resin composition comprises 2000 ppm of octadecyl 3-(3,5-di-tert-butyl-4-hydroxyphenyl) propionate.

### 2) Reactive Diluents

A polymerizable resin composition of the present disclosure can comprise one or more species of polymerizable monomers. Such polymerizable monomers can be used as reactive diluents to reduce a viscosity of the polymerizable resin composition. For example, a reactive diluent can reduce the viscosity of the polymerizable resin composition by at least about 5% compared to a resin composition that does not comprise the reactive diluent. In some instances, a reactive diluent can reduce the viscosity of a polymerizable resin composition by at least about 5%, 10%, 20%, 30%, 40%, or 50%.

In various embodiments, a reactive diluent can comprise an acrylate or methacrylate moiety for incorporation into an oligomeric or polymeric backbone, coupled to a linear or cyclic (e.g., mono-, bi-, or tricyclic) side-chain moiety. Generally, any aliphatic, cycloaliphatic or aromatic molecule with a mono-functional polymerizable reactive functional group can be used (also includes liquid crystalline monomers). In some embodiments, the polymerizable reactive functional group is an acrylate or methacrylate group. Specific reactive diluents suitable for use in the subject compositions include, but are not limited to, 3,3,5-trimethylcyclohexyl 2-(methacryloxy)benzoate (HSMA), benzyl salicylate methacrylate (BSMA), bisphenol A-glycidyl methacrylate (BisGMA), 2-hydroxyethyl methacrylate (HEMA), 2-hydroxybutyl methacrylate (HBMA), isobornyl methacrylate (IBMA), 2-ethylhexyl methacrylate (EHMA), 2-cyanoethyl methacrylate (CEMA), benzyl methacrylate (BMA), 2-phenoxyethyl methacrylate (PEMA), butyl methacrylate (BMA), lauryl methacrylate (LMA), syringyl methacrylate (SMA), the corresponding acrylates, and combinations thereof. The antioxidant stabilizer helps to prevent undesired oxidation of the reactive diluent.

In some embodiments, the reactive diluent of the present disclosure can have a low vapor pressure at an elevated temperature and a high boiling point. Such low vapor pressure can be particularly advantageous for use of such monomer in polymerizable (e.g., photopolymerizable) resin compositions and additive manufacturing where elevated temperatures (e.g., 60° C., 80° C., 90° C., or higher) may be used. In various instances, the reactive diluent can have a vapor pressure of at most about 12 Pa at 60° C. In various instances, the reactive diluent can have a vapor pressure of at most about 2 Pa to 10 Pa at 60° C. In various instances, the reactive diluent can have a vapor pressure of at most about 2 Pa to 5 Pa at 60° C. Thus, in some embodiments, the reactive diluent of the present disclosure can have a low mass loss at an elevated temperature. As used herein, a mass loss of a compound at a certain temperature (e.g., 90° C.) for a certain time period (e.g., 2 hours) can be used as a measure for volatility of such compounds. Herein, “substantially no volatility” can refer to a mass loss less than 1 wt % at the respective temperature, e.g., at 90° C. for 2 hours. In various instances, the reactive diluent of the present disclosure can have a mass loss less than 1 wt % at the respective temperature at 90° C. after heating at that temperature for 2 hours. In some embodiments, the reactive diluent can have a mass loss of less than about 0.5% after heating at 90° C. for 2 h. In some embodiments, the reactive diluent can have a mass loss of about 0.1% to about 0.45% after heating at 90° C. for 2 h. In some embodiments, the reactive diluent can have a mass loss of about 0.05% to about 0.25% after heating at 90° C. for 2 h.

In some embodiments, the reactive diluent of the present disclosure can have a molecular weight of at least about 150 Da, 200 Da, 250 Da, 300 Da, 350 Da, 400 Da, or at least about 450 Da. In some instances, the reactive diluent has a molecular weight of less than about 750 Da.

In some embodiments, the reactive diluent of the present disclosure can have a melting point of at least about 20° C., 30° C., 40° C., 50° C., or higher. The melting point of the reactive diluent is lower than the processing temperatures employed in current high temperature lithography-based photopolymerization processes, which are typically in the range of 50 to 120° C., such as 90 to 120° C. Therefore, the reactive diluents can have a melting point less than 120° C., less than 90° C., less than 70° C., or even less than 50° C. or less than 30° C., which provides for low viscosities of the melts and, consequently, for more pronounced viscosity-lowering effects when they are used as reactive diluents for resin compositions to be cured by means of high temperature lithography-based polymerization. In some cases, they are liquid at room temperature, which, in addition to the above advantages, facilitates their handling.

In some embodiments, the polymerizable resin composition comprises 1 to 75 wt %, 1 to 70 wt %, 1 to 60 wt %, 1 to 50 wt %, 1 to 40 wt %, 1 to 30 wt %, 1 to 25 wt %, 1 to 20 wt %, 10 to 70 wt %, 10 to 70 wt %, 10 to 60 wt %, 10 to 50 wt %, 10 to 40 wt %, 10 to 30 wt %, 10 to 25 wt %, 20 to 70 wt %, 20 to 60 wt %, 20 to 50 wt %, 20 to 40 wt %, 20 to 35 wt %, or 20 to 30 wt %, based on the total weight of the composition, of the reactive diluent. In certain embodiments, the polymerizable resin composition may comprise 5 to 50 wt % or 20 to 50 wt %, based on the total weight of the composition, of the reactive diluent. In certain embodiments, the polymerizable resin composition may comprise 20 to 50 wt %, based on the total weight of the composition, of the reactive diluent.

### 3) Toughness Modifiers

A polymerizable resin composition can comprise one or more species of telechelic compounds. Such telechelic compound can be a telechelic oligomer or a telechelic polymer. In some embodiments, the telechelic compound comprises an oligomeric or polymeric chain of interconnected monomeric units having at least one terminal reactive functional group coupled at each end. The oligomeric or polymeric chain of interconnected monomeric units can have a molecular weight of about 0.5 kDa, 1 kDa, 2 kDa, 3 kDa, 5 kDa, 10 kDa, 15 kDa, 20 kDa, 25 kDa, 30 kDa, 35 kDa, 40 kDa, 45 kDa, or 50 kDa. The oligomeric or polymeric chain of interconnected monomeric units can comprise or consist of at least about 2, 5, 10, 25, 50, 75, or 100 monomeric subunits.

In some embodiments, the oligomeric or polymeric chain of interconnected monomeric units can comprise a polyether chain, a polyester chain, a polyurethan chain, or combinations thereof. In some embodiments, the oligomeric or polymeric chain of interconnected monomeric units is selected from (poly)carbonate-(poly)urethane, (poly)ester-(poly)urethane, (poly)ether-(poly)urethane, (poly)thioether-(poly)urethane, hydrogenated (poly)butadiene, (poly)ester or (poly)urethane, and the terminal reactive functional group is selected from an acrylate, a methacrylate, a vinyl acrylate, a vinyl methacrylate, an allyl ether, a silene, an alkyne, an alkene, a vinyl ether, a maleimide, a fumarate, a maleate, an itaconate, an epoxide, and a styrenyl. The antioxidant stabilizer helps to prevent undesired polymerization of the telechelic compound.

In some embodiments, the oligomeric or polymer chain of interconnected monomeric units comprises a poly-terephthalate chain, a poly-tetrahydrofuran (polyTHF, also referred to herein as poly-(tetramethylene ether)glycol (PTMEG)) chain, or a combination thereof.

In some embodiments, the first terminal end, the second terminal end, or both, comprises a reactive functional group having one of the following structures:

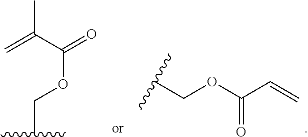

In some embodiments, the first terminal end, the second terminal end, or both, has a reactive functional group having the following structure:

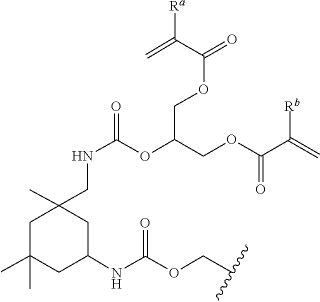

wherein R^{a} and R^{b} are independently H, halogen, or substituted or unsubstituted C₁-C₃ alkyl.

In some embodiments, the telechelic compound has the following structure:

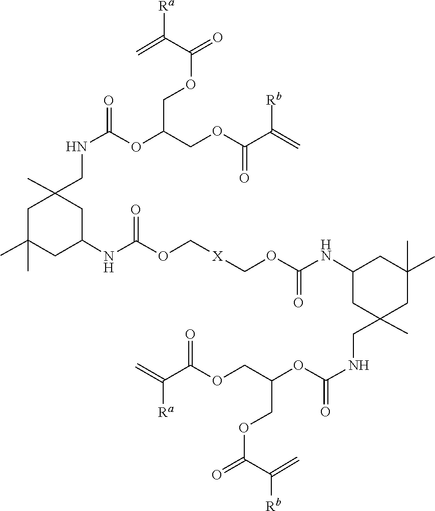

wherein:
X is an oligomeric or polymeric chain of (poly)carbonate-(poly)urethane, (poly)ester-(poly)urethane, (poly)ether-(poly)urethane, (poly)thioether-(poly)urethane, hydrogenated (poly)butadiene, (poly)ester or (poly)urethane; and
R^{a} and R^{b} are independently H, halogen, or substituted or unsubstituted C₁-C₃ alkyl.

In some embodiments, R^{a} and R^{b} are H. In other embodiments, R^{a} and R^{b} are methyl. In yet other embodiments, R^{a} is H and R^{b} is methyl.

In some embodiments, the telechelic compound has one of the following structures:

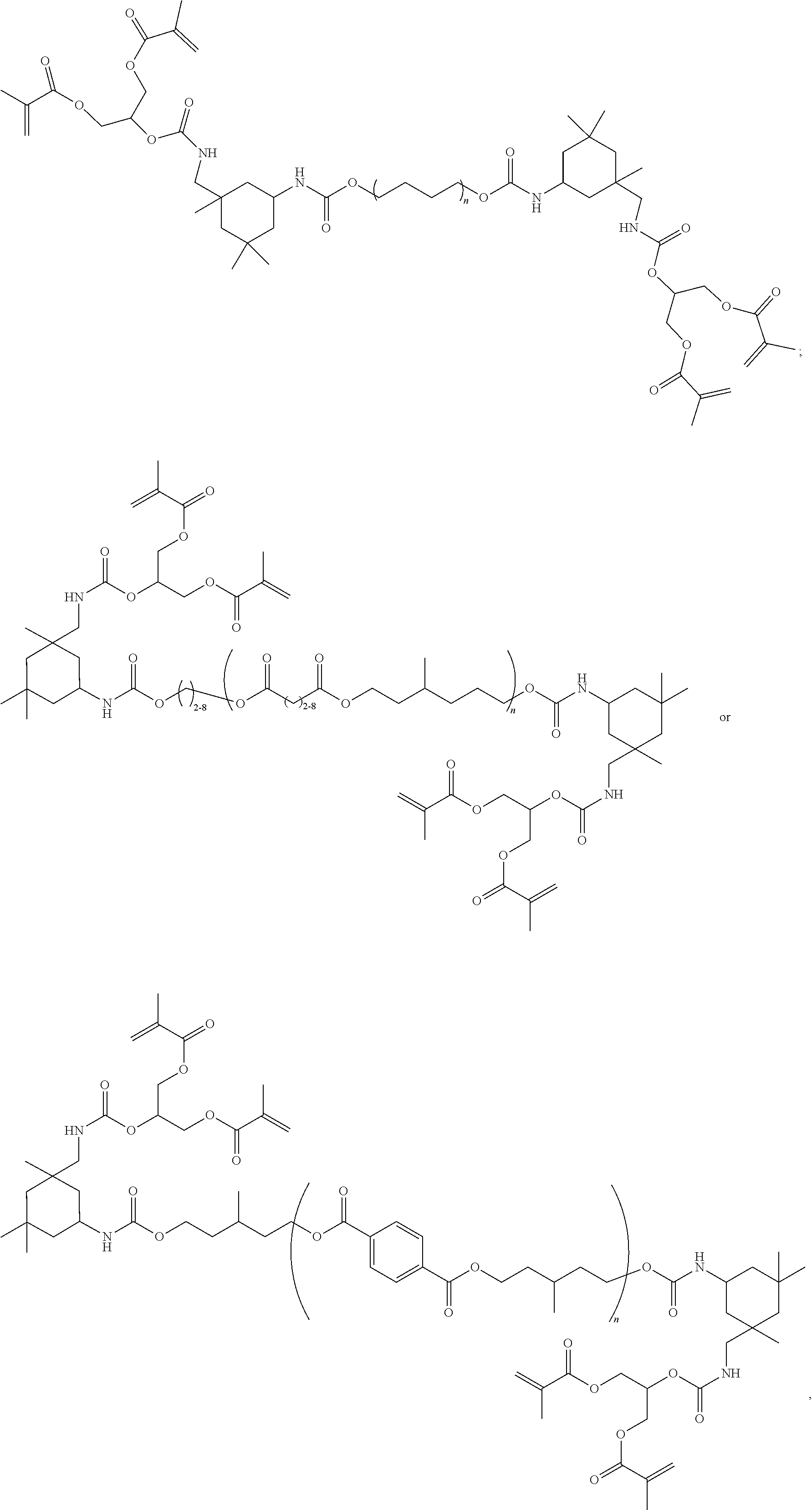

wherein n is an integer from 1 to 100, from 1 to 75, from 10 to 50, from 25 to 50.

In some embodiments, the telechelic compound is a telechelic polymer having a number average molecular weight greater than 5 kDa. Such telechelic polymer can be used as a toughness modifier for a polymeric material to be generated using a polymerizable resin composition herein. The toughness modifier provides for high elongation at break and toughness via strengthening effects.

The toughness modifier of the subject compositions may have a low glass transition temperature (T_{g}), such as a T_{g} less than 0° C., which can add to tough behavior if used above its glass transition temperature. In some examples, the T_{g} of the toughness modifier may be less than 25° C., such as less than 15° C., less than 10° C., less than 5° C., less than 0° C., less than −5° C., or less than-10° C. The T_{g} of a polymer or composition described herein may be assessed using dynamic mechanical analysis (DMA) and is provided herein as the tan 8 peak.

The toughness modifier can have a number average molecular weight greater than 5 kDa, 6 kDa, 7 kDa, 8 kDa, 9 kDa, 10 kDa, 11 kDa, 12 kDa, 13 kDa, 14 kDa, 15 kDa, 16 kDa, 17 kDa, 18 kDa, 19 kDa, 20 kDa, 21 kDa, 22 kDa, 23 kDa, 24 kDa, or greater than 25 kDa. In some embodiments, the toughness modifier has a number average molecular weight ranging from 7-15 kDa. In certain embodiments, the toughness modifier has a number average molecular weight ranging from 8-10 kDa, 8-15 kDa, 9-10 kDa, 9-15 kDa, 10-20 kDa, 11-15 kDa, 12-15 kDa, 15-20 kDa, 13-15 kDa, or 17-20 kDa.

The polymerizable resin composition can comprise 1 to 75 wt %, 1 to 70 wt %, 1 to 60 wt %, 1 to 50 wt %, 1 to 40 wt %, 1 to 30 wt %, 1 to 25 wt %, 10 to 75 wt %, 10 to 70 wt %, 10 to 60 wt %, 10 to 50 wt %, 10 to 40 wt %, 10 to 30 wt %, 10 to 25 wt %, 20 to 75 wt %, 20 to 70 wt %, 20 to 60 wt %, 20 to 50 wt %, 20 to 40 wt %, 20 to 35 wt %, 20 to 30 wt %, 25 to 75 wt %, 25 to 70 wt %, 25 to 60 wt %, 25 to 50 wt %, 25 to 45 wt %, 25 to 40 wt %, or 25 to 35 wt %, based on the total weight of the composition, of the toughness modifier. In certain embodiments, the polymerizable resin composition may comprise 25 to 35 wt %, based on the total weight of the composition, of the toughness modifier. In certain embodiments, the polymerizable resin composition may comprise 20 to 40 wt %, based on the total weight of the composition, of the toughness modifier.

In some embodiments, the toughness modifier is polyether modified (poly)carbonate-(poly)urethane dimethacrylate. In some embodiments, the toughness modifier comprises a structure according to formula (II), (III), (IV), or (V),

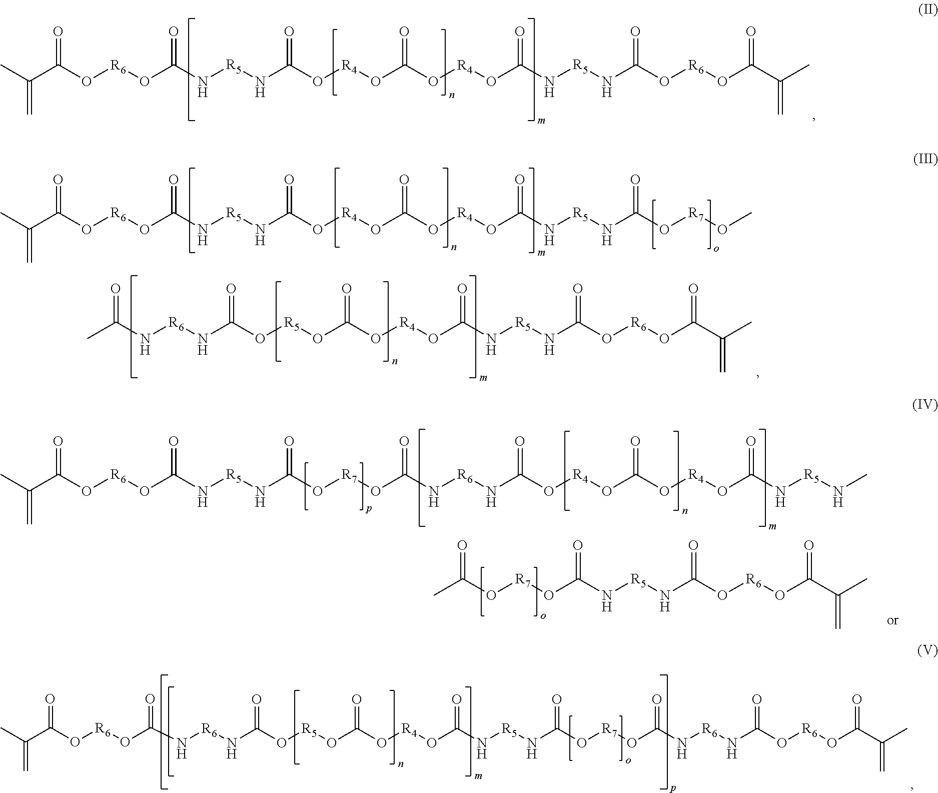

wherein:
each R₄ and each R₅ independently represent a divalent, linear, branched or cyclic C₅-C₁₅ alkyl radical;
each R₆ independently represents a divalent, linear or branched C₂-C₄ alkyl radical;
each R₇ independently represents a divalent, linear or branched C₂-C₆ alkyl radical;
each n is independently an integer from 1 to 10;
each m is independently an integer from 1 to 20;
each o is independently an integer from 5 to 50; and
p is an integer from 1 to 40,
with the proviso that R₄, R₅, R₆, R₇, n, m, o and p are selected so as to result in a number average molecular weight of the (poly)carbonate-(poly)urethane dimethacrylate greater than 5 kD.

In some embodiments, R₄ is a divalent radical originating from a diol selected from the group consisting of 2,2-dimethyl-1,3-propanediol (DMP), 1,6-hexanediol, 1,4-cyclohexanedimethanol (CHDM), and mixtures thereof. In certain embodiments, R₄ is the alcoholic moiety of a polycarbonate.

In some embodiments, R₅ is a divalent radical originating from a diisocyanate selected from the group consisting of isophorone diisocyanate (IPDI), hexamethylene diisocyanate (HDI), trimethylhexamethylene diisocyanate (2,2,4- and 2,4,4-mixture, TMDI), dicyclohexylmethane 4,4′-diisocyanate (HMDI), 1,3-bis(isocyanatomethyl)cyclohexane, and mixtures thereof.

In some embodiments, R₆ is a divalent radical originating from a diol independently selected from the group consisting of 1,2-ethanediol, 1,3-propanediol, 1,2-propanediol, 1,4-butanediol, and mixtures thereof. In certain embodiments, R₆ is a divalent radical originating from 1,2-ethanediol.

In some embodiments, R₇ is a divalent radical originating from a diol selected from the group consisting of C₂-C₆ alkanediols and mixtures thereof. In certain embodiments, R₇ is a divalent radical originating from 1,4-butanediol.

Specific toughness modifiers suitable for use in the subject compositions are described herein below, including compounds of formula (II), (III), (IV) or (V). In some embodiments, the toughness modifier is selected from UA5216 (Miwon), TNM1, TNM2, TNM3, TNM4, TNM5, and TNM6. The TNM1, TNM2, TNM3, TNM4, TNM5, and TNM6 have the following structures, respectively.

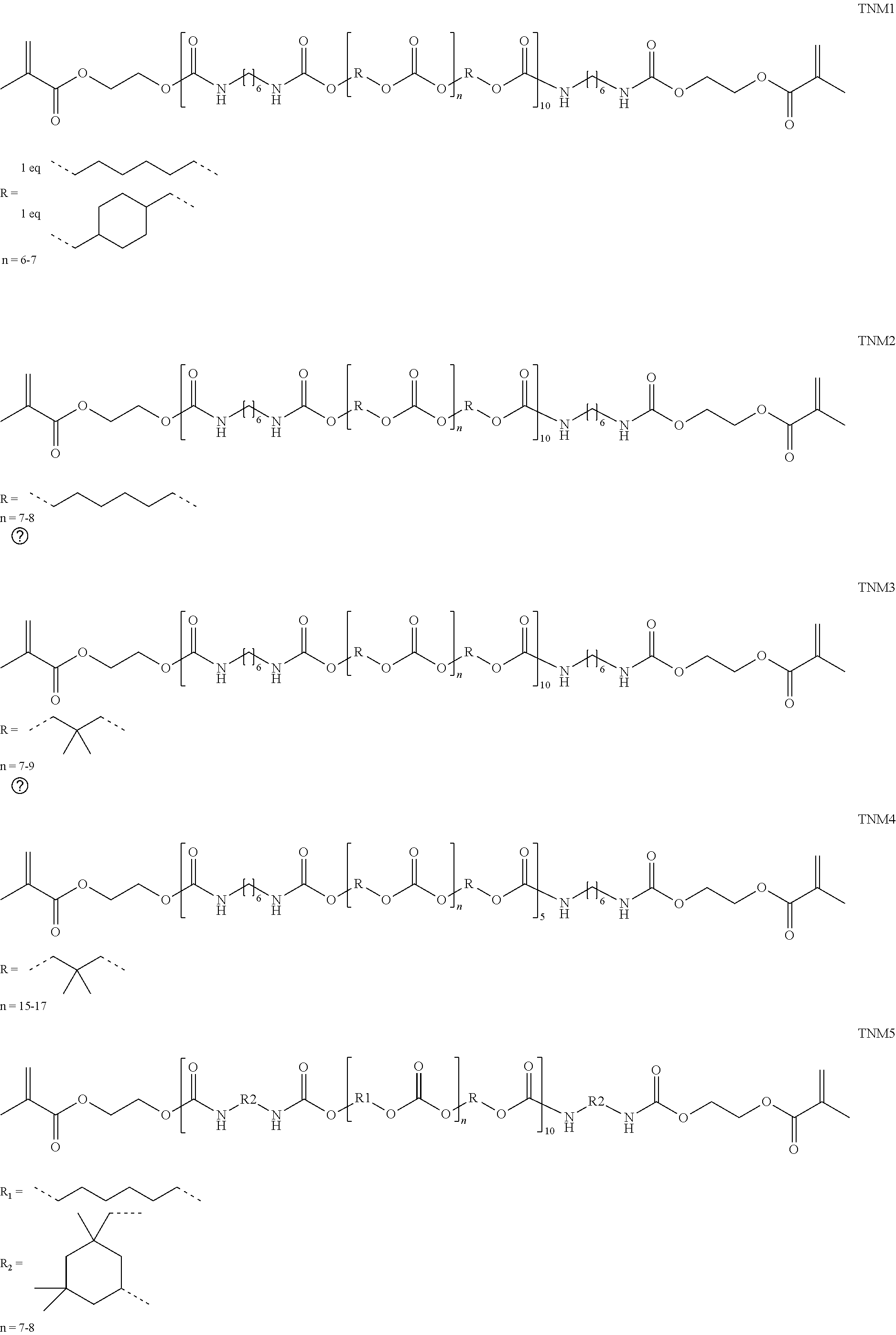

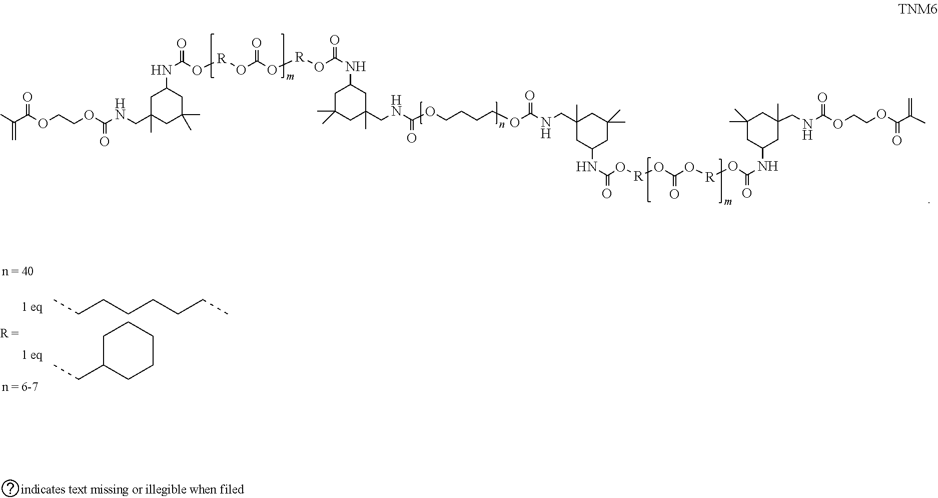

### 4) Glass Transition Temperature Modifiers

In some embodiments, the polymerizable resin composition of the present disclosure may further comprise a glass transition temperature (T_{g}) modifier (also referred to herein as a T_{g} modifier). The T_{g} modifier can have a high glass transition temperature, which leads to a high heat deflection temperature, which can be necessary to use a material at elevated temperatures. The toughness modifier, the reactive diluent, and the T_{g} modifier are typically miscible and compatible in the methods described herein. When used in the subject compositions, the T_{g} modifier may provide for high T_{g} and strength values, sometimes at the expense of elongation at break. The toughness modifier may provide for high elongation at break and toughness via strengthening effects, and the reactive diluent may improve the processability of the formulations, particularly of those comprising high amounts of toughness modifiers, while maintaining high values for strength and T_{g}. The T_{g} modifier typically has a higher T_{g} than the toughness modifier.

In certain embodiments, the polymerizable resin composition comprises 0 to 80 wt %, 0 to 75 wt %, 0 to 70 wt %, 0 to 65 wt %, 0 to 60 wt %, 0 to 55 wt %, 0 to 50 wt %, 1 to 50 wt %, 2 to 50 wt %, 3 to 50 wt %, 4 to 50 wt %, 5 to 50 wt %, 10 to 50 wt %, 15 to 50 wt %, 20 to 50 wt %, 25 to 50 wt %, 30 to 50 wt %, 35 to 50 wt %, 0 to 40 wt %, 1 to 40 wt %, 2 to 40 wt %, 3 to 40 wt %, 4 to 40 wt %, 5 to 40 wt %, 10 to 40 wt %, 15 to 40 wt %, or 20 to 40 wt % of a T_{g} modifier. In certain embodiments, the polymerizable resin composition comprises 0-50 wt % of a glass transition modifier.

The T_{g} modifier can be a telechelic oligomer having a number average molecular weight ranging from 0.4 to 5 kDa. In certain embodiments, the number average molecular weight of the T_{g} modifier is from 0.4 to 5 kDa, 0.5 to 5 kDa, from 0.6 to 5 kDa, from 0.7 to 5 kDa, from 0.8 to 5 kDa, from 0.9 to 5 kDa, from 1.0 to 5 kDa, from 0.4 to 4 kDa, from 0.5 to 4 kDa, from 0.6 to 4 kDa, from 0.7 to 4 kDa, from 0.8 to 4 kDa, from 0.9 to 4 kDa, from 1 to 4 kDa, from 0.4 to 3 kDa, from 0.5 to 3 kDa, from 0.6 to 3 kDa, from 0.7 to 3 kDa, from 0.8 to 3 kDa, from 0.9 to 3 kDa, or from 1 to 3 kDa.

In certain embodiments, the T_{g} modifier may comprise a urethane group. In certain embodiments, the T_{g} modifier comprises at least one methacrylate group. Specific T_{g} modifiers suitable for use in the subject compositions are described herein below, including compounds of formula (I). In some embodiments, the T_{g} modifier is a polyester dimethacrylate oligomer or a polyurethane dimethacrylate oligomer. In some embodiments, the T_{g} is polyether modified polyurethane dimethacrylate. In certain embodiments, the T_{g} modifier is selected from H1188 (bis((2-((methacryloyloxy)methyl) octahydro-1H-4,7-methanoinden-5-yl)methyl)cyclohexane-1,4-dicarboxylate), TGM1, TGM2, TGM3, TGM4, and a compound of formula (I). In certain embodiments, the T_{g} modifier is a derivative of H1188 (DMI), TGM1, TGM2, TGM3, TGM4, or a derivative of the compound of formula (I). In certain embodiment, the T_{g} modifier is a blend of modifiers comprising H1188 (DMI), TGM1, TGM2, TGM3, TGM4, or a compound of formula (I).

In some embodiments, the T_{g} modifier is H1188:

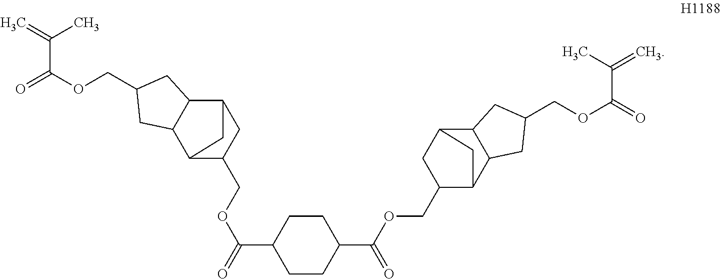

In some embodiments, the T_{g} modifier is TGM1:

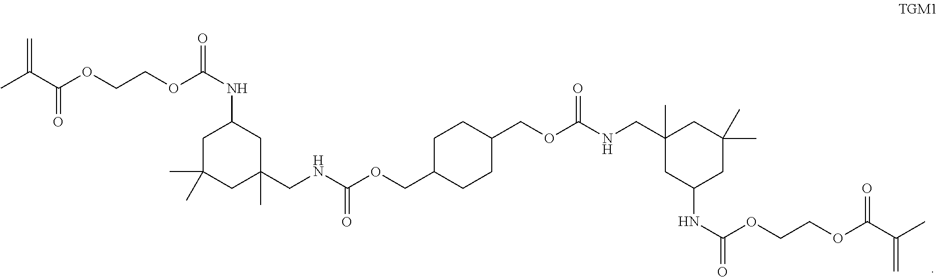 [SMILES: C=C(C)C(=O)OCCOC(=O)NC1CC(C)(C)CC(C)(CNC(=O)OCC2CCC(COC(=O)NCC3(C)CC(NC(=O)OCCOC(=O)C(=C)C)CC(C)(C)C3)CC2)C1]

In some embodiments, the T_{g} modifier is TGM2:

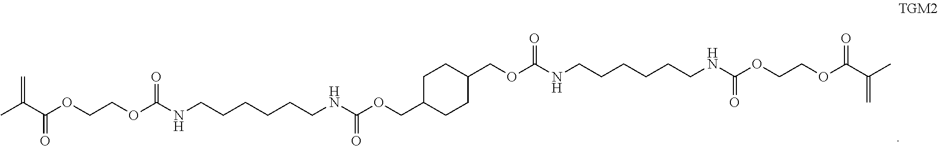 [SMILES: C=C(C)C(=O)OCCOC(=O)NCCCCCCNC(=O)OCC1CCC(COC(=O)NCCCCCCNC(=O)OCCOC(=O)C(=C)C)CC1]

In some embodiments, the T_{g} modifier is TGM3:

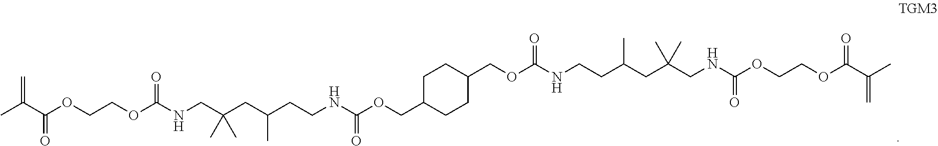 [SMILES: C=C(C)C(=O)OCCOC(=O)NCC(C)(C)CC(C)CCNC(=O)OCC1CCC(COC(=O)NCCC(C)CC(C)(C)CNC(=O)OCCOC(=O)C(=C)C)CC1]

In some embodiments, the T_{g} modifier is TGM4:

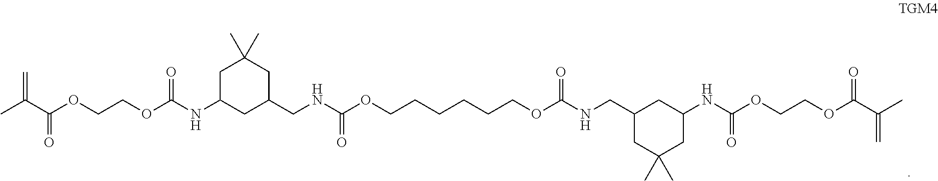 [SMILES: C=C(C)C(=O)OCCOC(=O)NC1CC(CNC(=O)OCCCCCCOC(=O)NCC2CC(NC(=O)OCCOC(=O)C(=C)C)CC(C)(C)C2)CC(C)(C)C1]

In some embodiments, the T_{g} modifier is a compound of Formula (I):

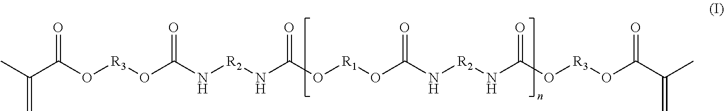

wherein:
each R₁ and each R₂ independently represent a divalent, linear, branched or cyclic C₅-C₁₅ alkyl radical, with the proviso that at least one of R¹ and R₂ is or comprises a C₅-C₆ cycloalkyl structure;
each R₃ independently represents a divalent, linear or branched C₂-C₄ alkyl radical; and
n is an integer from 1 to 5;
with the proviso that R₁, R₂, R₃ and n are selected so as to result in a number average molecular weight of the oligomeric dimethacrylate from 0.4 to 5 kDa.

In some embodiments, the T_{g} modifier comprises a plurality of aliphatic rings. In certain embodiments, the T_{g} modifier comprises a plurality of aliphatic rings. In some aspects, the aliphatic rings arc hydrocarbon rings. In some aspects, the aliphatic rings are saturated. In some aspects, the plurality of aliphatic rings comprises cyclobutane, cyclopentane, cyclohexane, cycloheptane, cyclooctane, cyclononane, cyclodecane, or any combination thereof. In some aspects, the plurality of aliphatic rings includes bridged ring structures. In some aspects, the plurality of aliphatic rings includes fused ring structures. In certain embodiments, the middle portion of the T_{g} modifier comprises a cyclohexane-1,4-dicarboxylic acid, a cyclohexanedimethanol, a cyclohexane-1,4-diylbis(methylene)dicarbamate, or a combination thereof. In certain embodiments, the center of the T_{g} modifier structure comprises a cyclohexane-1,4-diylbis(methylene)dicarbamate (e.g., TGM1, TGM2, and TGM3).

In some embodiments, the T_{g} modifier comprises a methacrylate. In some embodiments, the T_{g} modifier comprises at least two methacrylates. In certain embodiments, the T_{g} modifier has terminal portions comprising methacrylates. In some embodiments, the T_{g} modifier has a structure that terminates at each end with a methacrylate. In some embodiments, the T_{g} modifier is a bis(2-methacrylate) (e.g., TGM1, TGM2, TGM3, TGM4, and H1188).

In some embodiments, the T_{g} modifier comprises a blend of components, selected from TGM1, TGM2, TGM3, TGM4, H1188, a compound of formula (I), D3MA (1,10-decanediol dimethacrylate), D4MA (1,12-dodecanediol dimethacrylate), LPU624, a derivative thereof, or a combination thereof. In some embodiments, the Tg modifier comprises Bomar XR-741 MS. The antioxidant stabilizer helps to prevent undesired polymerization of the T_{g} modifier.

### 5) Initiators

In various embodiments, the polymerizable resin composition disclosed herein is a photopolymerizable composition. In some embodiments, the polymerizable resin composition comprises an initiator that is a photoinitiator. Such photoinitiator, when activated with light of an appropriate wavelength (e.g., UV/VIS) can initiate a polymerization reaction (e.g., during photo-curing) between the monomers, toughness modifiers, and other potentially polymerizable components that may be present in the photopolymerizable matrix, to form a polymeric material as further described herein. Generally, photoinitiators described in the present disclosure can include those that can be activated with light and initiate polymerization of the polymerizable components of the formulation. A “photoinitiator”, as used herein, may generally refer to a compound that can produce radical species and/or promote radical reactions upon exposure to radiation (e.g., UV or visible light). The antioxidant stabilizer helps to prevent decomposition of the photoinitiator in the unreacted portion of the resin composition during additive manufacturing.

In some embodiments, the photoinitiator is a radical photoinitiator and/or a cationic initiator. In some embodiments, the photoinitiator is a Type I photoinitiator which undergoes a unimolecular bond cleavage to generate free radicals. In an additional embodiment, the photoinitiator is a Type II photoinitiator which undergoes a bimolecular reaction to generate free radicals. Common Type I photoinitiators include, but are not limited to benzoin ethers, benzil ketals, α-dialkoxy-acetophenones, α-hydroxy-alkyl phenones, and acyl-phosphine oxides. Common Type II photoinitiators include benzophenones/amines and thioxanthones/amines. Cationic initiators include aryldiazonium, diaryliodonium, and triarylsulfonium salts. In some embodiments, the photoinitiator comprises phenylbis(2,4,6-trimethylbenzoyl) phosphine oxide (BAPO), diphenyl-(2,4,6-trimethylbenzoyl) phosphine oxide (TPO), ethyl-(2,4,6-trimethylbenzoyl)phenylphosphinate (TPO-L), a polymeric TPO-L (Omnipol TP), alpha-hydroxyketone (Chivacure 300), benzil dimethyl ketal (BDK), or a combination thereof.

In some embodiments, the photoinitiator initiates photopolymerization using light energy. In certain embodiments, the photoinitiator initiates photopolymerization with exposure to light energy from 800 nm to 250 nm, from 800 nm to 350 nm, from 800 nm to 450 nm, from 800 nm to 550 nm, from 800 nm to 650 nm, from 600 nm to 250 nm, from 600 nm to 350 nm, from 600 nm to 450 nm, or from 400 nm to 250 nm. In some embodiments, the photoinitiator initiates photopolymerization following absorption of two photons, which can use longer wavelengths of light to initiate the photopolymerization.

In some embodiments, the polymerizable resin composition comprises more than one initiator (e.g., 2, 3, 4, 5, or more than 5 initiators). In some embodiments, the polymerizable resin composition comprises an initiator that is a thermal initiator. In certain embodiments, the thermal initiator comprises an organic peroxide. In some embodiments, the thermal initiator comprises an azo compound, an inorganic peroxide, an organic peroxide, or any combination thereof. In some embodiments, the thermal initiator is selected from the group consisting of tert-amyl peroxybenzoate, 4,4-azobis(4-cyanovaleric acid), 1,1′-azobis(cyclohexanecarbonitrile), 2,2′-azobisisobutyronitrile (AIBN), benzoyl peroxide, 2,2-bis(tert-butylperoxy) butane, 1,1-bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-3,3,5-trimethylcyclohexane, tert-butyl hydroxyperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2,4-pentanedione peroxide, peracetic acid, potassium persulfate, a derivative thereof, and a combination thereof. In preferred embodiments, the thermal initiator comprises azobisisobutyronitrile, 2,2′-azodi(2-methylbutyronitrile), or a combination thereof.

In some embodiments, the polymerizable resin composition comprises 0.01-10 wt %, 0.02-5 wt %, 0.05-4 wt %, 0.1-3 wt %, 0.1-2 wt %, or 0.1-1 wt %, based on the total weight of the composition, of the initiator. In certain embodiments, the polymerizable resin composition comprises 0.1-2 wt % of the initiator. In some embodiments, the polymerizable resin composition comprises 0.01-10 wt %, 0.02-5 wt %, 0.05-4 wt %, 0.1-3 wt %, 0.1-2 wt %, or 0.1-1 wt % of the photoinitiator. In certain embodiments, the polymerizable resin composition comprises 0.1-2 wt % of the photoinitiator. In some embodiments, the polymerizable resin composition comprises from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt % of the thermal initiator. In certain embodiments, the polymerizable resin composition comprises from 0 to 0.5 wt % of the thermal initiator.

### 6) Additional Components

In some embodiments, the polymerizable resin composition may further comprise additional components such as a crosslinking modifier, a polymerization catalyst, a light blocker, a plasticizer, a solvent, a surface energy modifier (e.g., a mold releasing agent), a pigment, a dye, a filler, a biologically significant chemical, or any combination thereof.

In some embodiments, the polymerizable resin composition further comprises a crosslinking modifier. The crosslinking modifier may have a sufficient number of polymerizable groups to affect crosslinking. The crosslinking modifier may comprise at least two, at least three, at least four, at least five, or at least six polymerizable groups. The polymerizable groups can be acrylate, methacrylate, or epoxy groups. In some embodiments, the polymerizable resin composition comprises from 0 to 25 wt %, from 0 to 20 wt %, from 0 to 15 wt %, from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt %, based on the total weight of the composition, of the crosslinking modifier.

In some embodiments, the polymerizable resin composition further comprises a polymerization catalyst. In some embodiments, the polymerization catalyst comprises a tin catalyst, a platinum catalyst, a rhodium catalyst, a titanium catalyst, a silicon catalyst, a palladium catalyst, a metal triflate catalyst, a boron catalyst, a bismuth catalyst, or any combination thereof. Non-limiting examples of a tin catalyst include di-n-butylbutoxychlorotin, di-n-butyldiacetoxytin, di-n-butyldilauryltin, dimethyldincodecanoatetin, dioctyldilauryltin, tetramethyltin, and dioctylbis(2-ethylhexylmaleate) tin. Non-limiting examples of a platinum catalyst include platinum-divinyltetramethyl-disiloxane complex, platinum-cyclovinylmethyl-siloxane complex, platinum-octanal complex, and platinum carbonyl cyclovinylmethylsiloxane complex. A non-limiting example of a rhodium catalyst includes tris(dibutylsulfide) rhodium trichloride. Non-limiting examples of a titanium catalyst include titanium isopropoxide, titanium 2-ethyl-hexoxide, titanium chloride triisopropoxide, titanium ethoxide, and titanium diisopropoxide bis(ethylacetoacetate). Non-limiting examples of a silicon catalyst include tetramethylammonium siloxanolate and tetramethylsilylmethyl-trifluoromethanesulfonate. A non-limiting example of a palladium catalyst includes tetrakis(triphenylphosphine) palladium(0). Non-limiting examples of a metal triflate catalyst include scandium trifluoromethanesulfonate, lanthanum trifluoromethanesulfonate, and ytterbium trifluoromethanesulfonate. A non-limiting example of a boron catalyst includes tris(pentafluorophenyl) boron. Non-limiting examples of a bismuth catalyst include bismuth-zinc neodecanoate, bismuth 2-ethylhexanoate, a metal carboxylate of bismuth and zinc, and a metal carboxylate of bismuth and zirconium. In some embodiments, the polymerizable resin composition comprises from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt %, based on the total weight of the composition, of the polymerization catalyst.

In some embodiments, the polymerizable resin composition further comprises a light blocker. The light blocker can absorb irradiation and prevent or decrease the rate of polymerization or degradation, and its addition to the polymerizable composition can increase the resolution of printable materials. In certain embodiments, the light blocker comprises a hydroquinone, 1,4-dihydroxybenzene, a compound belonging to the HALS (hindered-amine light stabilizer) family, a benzophenone, a benzotriazole, any derivative thereof, or any combination thereof. In some embodiments, the light blocker comprises 2,2′-dihydroxy-4-methoxybenzophenone. In certain embodiments, the light blocker is selected from the group consisting of Michler's ketone, 4-Allyloxy-2-hydroxybenzophenone 99%, 2-(2H-benzotriazol-2-yl)-4,6-bis(1-methyl-1-phenylethyl)phenol powder, 2-(2H-benzotriazol-2-yl)-4,6-di-tert-pentylphenol, 2-(2H-benzotriazol-2-yl)-6-dodecyl-4-methylphenol, 2-[3-(2H-benzotriazol-2-yl)-4-hydroxyphenyl]ethyl methacrylate, 2-(2H-benzotriazol-2-yl)-4-methyl-6-(2-propenyl)phenol, 2-(2H-benzotriazol-2-yl)-4-(1,1,3,3-tetramethylbutyl)phenol, 2-(4-benzoyl-3-hydroxyphenoxy)ethyl acrylate, 3,9-bis(2,4-dicumylphenoxy)-2,4,8,10-tetraoxa-3,9-diphosphaspiro[5.5]undecane, bis(octadecyl) hydroxylamine powder, 3,9-bis(octadecyloxy)-2,4,8,10-tetraoxa-3,9-diphosphaspiro[5,5]undecane, bis(1-octyloxy-2,2,6,6-tetramethyl-4-piperidyl) sebacate, bis(2,2,6,6-tetramethyl-4-piperidyl) sebacate, 2-tert-butyl-6-(5-chloro-2H-benzotriazol-2-yl)-4-methylphenol, 2-tert-Butyl-4-ethylphenol, 5-chloro-2-hydroxybenzophenone, 5-chloro-2-hydroxy-4-methylbenzophenone, 2,4-di-tert-butyl-6-(5-chloro-2H-benzotriazol-2-yl)phenol, 2,6-di-tert-butyl-4-(dimethylaminomethyl)phenol, 3′,5′-dichloro-2′-hydroxyacetophenone, didodecyl 3,3′-thiodipropionate, 2,4-dihydroxybenzophenone, 2,2′-dihydroxy-4-methoxybenzophenone, 2′,4′-dihydroxy-3′-propylacetophenone, 2,3-dimethylhydroquinone, 2-(4,6-diphenyl-1,3,5-triazin-2-yl)-5-[(hexyl)oxy]-phenol, 5-ethyl-1-aza-3,7-dioxabicyclo[3.3.0]octane, ethyl 2-cyano-3,3-diphenylacrylate, 2-ethylhexyl 2-cyano-3,3-diphenylacrylate, 2-ethylhexyl trans-4-methoxycinnamate, 2-ethylhexyl salicylate, 2-hydroxy-4-(octyloxy)benzophenone, methyl anthranilate, 2-methoxyhydroquinone, methyl-p-benzoquinone, 2,2′-methylenebis[6-(2H-benzotriazol-2-yl)-4-(1,1,3,3-tetramethylbutyl)phenol], 2,2′-methylenebis(6-tert-butyl-4-ethylphenol), 2,2′-methylenebis(6-tert-butyl-4-methylphenol), 5,5′-methylenebis(2-hydroxy-4-methoxybenzophenone), methylhydroquinone, 4-nitrophenol sodium salt hydrate, 2-phenyl-5-benzimidazolesulfonic acid, poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino], sodium d-isoascorbate monohydrate, tetrachloro-1,4-benzoquinone, triisodecyl phosphite, 1,3,5-trimethyl-2,4,6-tris(3,5-di-tert-butyl-4-hydroxybenzyl)benzene, tris(4-tert-butyl-3-hydroxy-2,6-dimethylbenzyl) isocyanurate, 1,3,5-tris(2-hydroxyethyl) isocyanurate, and tris(nonylphenyl)phosphite. In some embodiments, the light blocker comprises 2-(2′-hydroxy-phenyl benzotriazole), 2,2′-dihydroxy-4-methoxybenzophenone, 9,10-dicthoxyanthracene, a hydroxyphenyltriazine, an oxanilide, a benzophenone, or a combination thereof.

In some embodiments, the light blocker has a maximum wavelength absorbance between 200 and 300 nm, between 300 and 400 nm, between 400 and 500 nm, between 500 and 600 nm, between 600 and 700 nm, between 700 and 800 nm, between 800 and 900 nm, between 150 and 200 nm, between 200 and 250 nm, between 250 and 300 nm, between 300 and 350 nm, between 350 and 400 nm, between 400 and 450 nm, between 450 and 500 nm, between 500 and 550 nm, between 550 and 600 nm, between 600 and 650 nm, between 650 and 700 nm, or between 700 and 750 nm. In some embodiments, the light blocker has a maximum wavelength absorbance between 300 to 500 nm, such as 300 to 400 nm or 350 to 480 nm. In some embodiments, the light blocker is a UV blocker absorbing light in the UV region.

In some embodiments, the polymerizable resin composition comprises from 0 to 20 wt %, from 0 to 15 wt %, from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt %, based on the total weight of the composition, of the light blocker. In preferred embodiments, the polymerizable resin composition comprises from 0.01 to 10 wt % of the light blocker.

In some embodiments, the polymerizable resin composition further comprises a filler. In some embodiments, the filler comprises calcium carbonate (i.e., chalk), kaolin, metakolinite, a kaolinite derivative, magnesium hydroxide (i.e., talc), calcium silicate (i.e., wollastonite), a glass filler (e.g., glass beads, short glass fibers, or long glass fibers), a nanofiller (e.g., nanoplates, nanofibers, or nanoparticles), a silica filler (e.g., a mica, silica gel, fumed silica, or precipitated silica), carbon black, dolomite, barium sulfate, ATH Al(OH)₃, MDH Mg(OH)₂, diatomaceous earth, magnetite, halloysite, zinc oxide, titanium dioxide, cellulose, lignin, a carbon filler (e.g., chopped carbon fiber or carbon fiber), a derivative thereof, or a combination thereof.

In some embodiments, the polymerizable resin composition further comprises a pigment, a dye, or a combination thereof. A pigment is typically a suspended solid that may be insoluble in the resin. A dye is typically dissolved in the polymerizable resin composition. In some embodiments, the pigment comprises an inorganic pigment. In some embodiments, the inorganic pigment comprises an iron oxide, barium sulfide, zinc oxide, antimony trioxide, a yellow iron oxide, a red iron oxide, ferric ammonium ferrocyanide, chrome yellow, carbon black, Pigment Violet 15, or aluminum flake. In some embodiments, the pigment comprises an organic pigment. In some embodiments, the organic pigment comprises an azo pigment, an anthraquinone pigment, a copper phthalocyanine (CPC) pigment (e.g., phthalo blue or phthalo green), or a combination thereof. In some embodiments, the dye comprises an azo dye (e.g., a diarylide or Sudan stain), an anthraquinone (e.g., Oil Blue A or Disperse Red 11), or a combination thereof.

In some embodiments, the polymerizable resin composition further comprises a surface energy modifier. In some embodiments, the surface energy modifier can aid the process of releasing a polymer from a mold. In some embodiments, the surface energy modifier can act as an antifoaming agent. In some embodiments, the surface energy modifier comprises a defoaming agent, a deaeration agent, a hydrophobization agent, a leveling agent, a wetting agent, or an agent to adjust the flow properties of the polymerizable resin composition. In some embodiments, the surface energy modifier comprises an alkoxylated surfactant, a silicone surfactant, a sulfosuccinate, a fluorinated polyacrylate, a fluoropolymer, a silicone, a star-shaped polymer, an organomodified silicone, or any combination thereof.

In some embodiments, the polymerizable resin composition further comprises a plasticizer. A plasticizer can be a nonvolatile material that can reduce interactions between polymer chains, which can decrease glass transition temperature, melt viscosity, and elastic modulus. In some embodiments, the plasticizer comprises a dicarboxylic ester plasticizer, a tricarboxylic ester plasticizer, a trimellitate, an adipate, a sebacate, a maleate, or a bio-based plasticizer. In some embodiments, the plasticizer comprises a dicarboxylic ester or a tricarboxylic ester comprising a dibasic ester, a phthalate, bis(2-ethylhexyl) phthalate (DEHP), bis(2-propylheptyl) phthalate (DPHP), diisononyl phthalate (DINP), di-n-butyl phthalate (DBP), butyl benzyl phthalate (BBzP), diisodecyl phthalate (DIDP), dioctyl phthalate (DOP), diisooctyl phthalate (DIOP), diethyl phthalate (DEP), diisobutyl phthalate (DIBP), di-n-hexyl phthalate, a derivative thereof, or a combination thereof. In some embodiments, the plasticizer comprises a trimellitate comprising trimethyl trimellitate (TMTM), tri-(2-ethylhexyl)trimellitate (TEHTM), tri-(n-octyl,n-decyl)trimellitate (ATM), tri-(heptyl,nonyl)trimellitate (LTM), n-octyl trimellitate (OTM), trioctyl trimellitate, a derivative thereof, or a combination thereof. In some embodiments, the plasticizer comprises an adipate comprising bis(2-ethylhexyl) adipate (DEHA), dimethyl adipate (DMAD), monomethyl adipate (MMAD), dioctyl adipate (DOA), Bis[2-(2-butoxyethoxy)ethyl]adipate, dibutyl adipate, diisobutyl adipate, diisodecyl adipate, a derivative thereof, or a combination thereof. In some embodiments, the plasticizer comprises a sebacate comprising dibutyl sebacate (DBS), Bis(2-ethylhexyl) sebacate, diethyl sebacate, dimethyl sebacate, a derivative thereof, or a combination thereof. In some embodiments, the plasticizer comprises a maleate comprising Bis(2-ethylhexyl) maleate, dibutyl maleate, diisobutyl maleate, a derivative thereof, or a combination thereof. In some embodiments, the plasticizer comprises a bio-based plasticizer comprising an acetylated monoglyceride, an alkyl citrate, a methyl ricinoleate, or a green plasticizer. In some embodiments, the alkyl citrate is selected from the group consisting of triethyl citrate, acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trimethyl citrate, a derivative thereof, or a combination thereof. In some embodiments, the green plasticizer is selected from the group consisting of epoxidized soybean oil, epoxidized vegetable oil, epoxidized esters of soybean oil, a derivative thereof, or a combination thereof. In some embodiments, the plasticizer comprises an azelate, a benzoate (e.g., sucrose benzoate), a terephthalate (e.g., dioctyl terephthalate), 1,2-cyclohexane dicarboxylic acid diisononyl ester, alkyl sulphonic acid phenyl ester, a sulfonamide (e.g., N-ethyl toluene sulfonamide, N-(2-hydroxypropyl) benzene sulfonamide, N-(n-butyl)benzene sulfonamaide), an organophosphate (e.g., tricresyl phosphate or tributyl phosphate), a glycol (e.g., triethylene glycol dihexanoate or tetraethylene glycol diheptanoate), a polyether, a polymeric plasticizer, polybutene, a derivative thereof, or a combination thereof.

In some embodiments, the polymerizable resin composition further comprises a solvent. In some embodiments, the solvent comprises a nonpolar solvent. In certain embodiments, the nonpolar solvent comprises pentane, cyclopentane, hexane, cyclohexane, benzene, toluene, 1,4-dioxane, chloroform, diethyl ether, dichloromethane, a derivative thereof, or a combination thereof. In some embodiments, the solvent comprises a polar aprotic solvent. In certain embodiments, the polar aprotic solvent comprises tetrahydrofuran, ethyl acetate, acetone, dimethylformamide, acetonitrile, DMSO, propylene carbonate, a derivative thereof, or a combination thereof. In some embodiments, the solvent comprises a polar protic solvent. In certain embodiments, the polar protic solvent comprises formic acid, n-butanol, isopropyl alcohol, n-propanol, t-butanol, ethanol, methanol, acetic acid, water, a derivative thereof, or a combination thereof. In preferred embodiments, the polymerizable resin composition comprises less than 90 wt %, based on the total weight of the composition, of the solvent.

In some embodiments, the polymerizable resin composition further comprises a biologically significant chemical. In some embodiments, the biologically significant chemical comprises a hormone, an enzyme, an active pharmaceutical ingredient, an antibody, a protein, a drug, or any combination thereof. In some embodiments, the biologically significant chemical comprises a pharmaceutical composition, a chemical, a gene, a polypeptide, an enzyme, a biomarker, a dye, a compliance indicator, an antibiotic, an analgesic, a medical grade drug, a chemical agent, a bioactive agent, an antibacterial, an antibiotic, an anti-inflammatory agent, an immune-suppressive agent, an immune-stimulatory agent, a dentinal desensitizer, an odor masking agent, an immune reagent, an anesthetic, a nutritional agent, an antioxidant, a lipopolysaccharide complexing agent or a peroxide.

In some embodiments, the added component (e.g., a crosslinking modifier, a polymerization catalyst, a light blocker, a plasticizer, a solvent, a surface energy modifier, a pigment, a dye, a filler, or a biologically significant chemical) is functionalized so that it can be incorporated into the polymer network so that it cannot readily be extracted from the final cured material. In certain embodiments, the polymerization catalyst, light blocker, plasticizer, surface energy modifier, pigment, dye, and/or filler, are functionalized to facilitate their incorporation into the cured polymeric material. A polymer network, as used herein, can refer to a polymer composition comprising a plurality of polymer chains wherein a large portion (e.g., ≥80%) and optionally all the polymer chains are interconnected, for example via covalent crosslinking, to form a single polymer composition. In an embodiment, there is provided a radiopaque polymer in the form of a crosslinked network in which at least some of the crosslinks of the network structure are formed by covalent bonds.

### Polymerizable Resin Composition Properties

Polymerizable resin compositions of the present disclosure can be characterized by one or more properties. In some embodiments, a polymerizable resin composition can have a viscosity from about 30 cP to about 50,000 cP at a printing temperature. In some embodiments, the polymerizable resin composition has a viscosity less than or equal to 30,000 cP, less than or equal to 25,000 cP, less than or equal to 20,000 cP, less than or equal to 19,000 cP, less than or equal to 18,000 cP, less than or equal to 17,000 cP, less than or equal to 16,000 cP, less than or equal to 15,000 cP, less than or equal to 14,000 cP, less than or equal to 13,000 cP, less than or equal to 12,000 cP, less than or equal to 11,000 cP, less than or equal to 10,000 cP, less than or equal to 9,000 cP, less than or equal to 8,000 cP, less than or equal to 7,000 cP, less than or equal to 6,000 cP, or less than or equal to 5,000 cP at 25° C. In some embodiments, the polymerizable resin composition has a viscosity less than 15,000 cP at 25° C. In some embodiments, the polymerizable resin composition has a viscosity less than or equal to 100,000 cP, less than or equal to 90,000 cP, less than or equal to 80,000 cP, less than or equal to 70,000 cP, less than or equal to 60,000 cP, less than or equal to 50,000 cP, less than or equal to 40,000 cP, less than or equal to 35,000 cP, less than or equal to 30,000 cP, less than or equal to 25,000 cP, less than or equal to 20,000 cP, less than or equal to 15,000 cP, less than or equal to 10,000 cP, less than or equal to 5,000 cP, less than or equal to 4,000 cP, less than or equal to 3,000 cP, less than or equal to 2,000 cP, less than or equal to 1,000 cP, less than or equal to 750 cP, less than or equal to 500 cP, less than or equal to 250 cP, less than or equal to 100 cP, less than or equal to 90 cP, less than or equal to 80 cP, less than or equal to 70 cP, less than or equal to 60 cP, less than or equal to 50 cP, less than or equal to 40 cP, less than or equal to 30 cP, less than or equal to 20 cP, or less than or equal to 10 cP at a printing temperature. In some embodiments, the polymerizable resin composition has a viscosity from 50,000 cP to 30 cP, from 40,000 cP to 30 cP, from 30,000 cP to 30 cP, from 20,000 cP to 30 cP, from 10,000 cP to 30 cP, or from 5,000 cP to 30 cP at a printing temperature. In some embodiments, the printing temperature is from 0° C. to 25° C., from 25° C. to 40° C., from 40° C. to 100° C., or from 20° C. to 150° C.

The polymerizable resin composition of the present disclosure can be capable of being 3D printed at a temperature greater than 25° C. In some cases, the printing temperature is at least about 30° C., 40° C., 50° C., 60° C., 80° C., or 100° C. As described herein, a reactive diluent of this disclosure can have a low vapor pressure and/or mass loss at the printing temperature, thereby providing improved printing conditions compared to conventional compositions used in additive manufacturing.

In some embodiments, the polymerizable resin composition herein has a melting temperature greater than room temperature. In some embodiments, the polymerizable resin composition has a melting temperature greater than 20° C., greater than 25° C., greater than 30° C., greater than 35° C., greater than 40° C., greater than 45° C. greater than 50° C., greater than 55° C., greater than 60° C., greater than 65° C., greater than 70° C., greater than 75° C., or greater than 80° C. In some embodiments, the polymerizable resin composition has a melting temperature from 20° C. to 250° C., from 30° C. to 180° C., from 40° C. to 160° C., or from 50° C. to 140° C. In some embodiments, the polymerizable resin composition has a melting temperature greater than 60° C. In other embodiments, the polymerizable resin composition has a melting temperature from 80° C. to 110° C. In some instances, a polymerizable resin composition can have a melting temperature of about 80° C. before polymerization, and after polymerization, the resulting polymeric material can have a melting temperature of about 100° C.

In certain instances, it may be advantageous that the polymerizable resin composition is in a liquid phase at an elevated temperature. As an example, a conventional polymerizable resin composition can comprise polymerizable components that may be viscous at a process temperature, and thus can be difficult to use in the fabrication of objects (e.g., using 3D printing). As a solution for that technical problem, the present disclosure provides polymerizable resin compositions comprising photopolymerizable components such as monomers and telechelic compounds described herein that can melt at an elevated temperature, e.g., at a temperature of fabrication (e.g., during 3D printing), and can have a decreased viscosity at the elevated temperature, which can make such polymerizable compositions more applicable and usable for uses such as 3D printing. Hence, in some embodiments, provided herein are polymerizable resin compositions that are a liquid at an elevated temperature. In some embodiments, the elevated temperature is at or above the melting temperature (Tm) of the polymerizable resin compositions. In certain embodiments, the elevated temperature is a temperature in the range from about 40° C. to about 100° C., from about 60° C. to about 100° C., from about 80° C. to about 100° C., from about 40° C. to about 150° C., or from about 150° C. to about 350° C. In some embodiments, the elevated temperature is a temperature above about 40° C., above about 60° C., above about 80° C., or above about 100° C. In some embodiments, the polymerizable resin composition herein is a liquid at an elevated temperature with a viscosity less than about 50 Pa·s, less than 2 about 0 Pas, less than about 10 Pas, less than about 5 Pa·s, or less than about 1 Pa·s. In some embodiments, the polymerizable resin composition herein is a liquid at an elevated temperature of above about 40° C. with a viscosity less than about 20 Pa·s. In yet other embodiments, a polymerizable resin composition herein is a liquid at an elevated temperature of above about 40° C. with a viscosity less than about 1 Pa·s.

In some embodiments, at least a portion of the polymerizable resin composition herein has a melting temperature below about 100° C., below about 90° C., below about 80° C., below about 70° C., or below about 60° C. In some embodiments, at least a portion of a polymerizable resin composition herein melts at an elevated temperature between about 100° C. and about 20° C., between about 90° C. and about 20° C., between about 80° C. and about 20° C., between about 70° C. and about 20° C., between about 60° C. and about 20° C., between about 60° C. and about 10° C., or between about 60° C. and about 0° C.

The polymerizable resin composition of the present disclosure can comprise less than about 20 wt % or less than about 10 wt % hydrogen bonding units. In some embodiments, a polymerizable resin composition herein comprises less than about 15 wt %, less than about 10 wt %, less than about 9 wt %, less than about 8 wt %, less than about 7 wt %, less than about 6 wt %, less than about 5 wt %, less than about 4 wt %, less than about 3 wt %, less than about 2 wt %, or less than about 1 wt % hydrogen bonding units.

In various embodiments, the polymerizable resin composition herein as well as its photopolymerizable components can be biocompatible, bioinert, or a combination thereof. In various instances, the photopolymerizable components of a composition herein can have biocompatible and/or bioinert metabolic (e.g., hydrolysis) products.

### Polymeric Materials

In some embodiments, the present disclosure provides polymeric materials formed from the polymerizable resin compositions disclosed herein. In preferred embodiments, the polymeric material is formed from the polymerizable resin compositions disclosed herein with additive manufacturing. In some embodiments, the polymeric material is prepared by a process comprising: providing a polymerizable resin composition as described herein; and forming the polymeric material from the polymerizable resin composition with additive manufacturing. In some preferred embodiments, the polymeric material is prepared by a process comprising: providing a polymerizable resin composition comprising: a telechelic compound, a reactive diluent, an antioxidant stabilizer, and an initiator, wherein the polymerizable resin composition has a viscosity less than or equal to 15,000 cP at 25° C.; and forming the polymeric material from the polymerizable resin composition with additive manufacturing. In certain preferred embodiments, the polymeric material is prepared by a process comprising: providing a polymerizable resin composition comprising: a telechelic compound; a reactive diluent; an antioxidant stabilizer; and a photoinitiator, wherein the polymerizable resin composition has a viscosity less than or equal to 15,000 cP at 25° C.; and forming the polymeric material from the polymerizable resin composition with additive manufacturing.

In some embodiments, the present disclosure provides a polymeric material having less than 20 wt % hydrogen bonding units, wherein the polymeric material is characterized by one or more of: a tensile modulus greater than or equal to 200 MPa after 24 hours in a wet environment at 37° C.; a flexural stress of greater than or equal to 1.5 MPa remaining after 24 hours in a wet environment at 37° C.; a hardness from 60 Shore A to 85 Shore D after 24 hours in a wet environment at 37° C.; an elongation at break greater than or equal to 15% before 24 hours in a wet environment at 37° C.; and an elongation at break greater than or equal to 15% after 24 hours in a wet environment at 37° C. In preferred embodiments, the polymeric material is formed from the polymerizable resin compositions disclosed herein. Young's modulus is calculated with an algorithm that breaks the relevant portion of a stress strain curve into 6 regions with 0% overlap and applies a least square fitting to determine the slope. The pair of consecutive regions that have the highest slope sum are determined. From this pair, the modulus is assigned to region with the highest slope.

Property values of the polymeric material can be determined, for example, by using the following methods:
stress relaxation properties can be assessed using an RSA-G2 instrument from TA Instruments, with a 3-point bending, according to ASTM D790; stress relaxation can be measured at 30° C. and submerged in water, and reported as either the remaining load after 24 hours, and/or as the percent (%) of initial load;
storage modulus can be measured at 37° C. and is reported in MPa;
T_{g} of the cured polymeric material can be assessed using dynamic mechanical analysis (DMA) and is provided herein as the tan 8 peak when run at 1 hz with a temperature ramp of 2° C. a minute;
tensile modulus, tensile strength, elongation at yield and elongation at break can be assessed according to ISO 527-2 5B;
tensile strength at yield, elongation at break, tensile strength, and Young's modulus can be assessed according to ASTM D1708 or ASTM D638; and
flexural stress remaining after 24 hours in wet environment at 37° C. (“flexural stress remaining”) can be assessed according to ASTM E328.

In some embodiments, the polymeric material is characterized by a tensile stress-strain curve that displays a yield point after which the test specimen continues to elongate, but there is no increase in load. Such yield point behavior typically occurs “near” the glass transition temperature, where the material is between the glassy and rubbery regimes and may be characterized as having viscoelastic behavior. In embodiments, viscoelastic behavior is observed in the temperature range 20° C. to 40° C. The yield stress is determined at the yield point. In some embodiments, the yield point follows an elastic region in which the slope of the stress-strain curve is constant or nearly constant. In embodiments, the modulus is determined from the initial slope of the stress-strain curve or as the secant modulus at 1% strain (e.g. when there is no linear portion of the stress-strain curve). The elongation at yield is determined from the strain at the yield point. When the yield point occurs at a maximum in the stress, the ultimate tensile strength is less than the yield strength. For a tensile test specimen, the strain is defined by ln(l/l₀), which may be approximated by (l−l₀)/l₀ at small strains (e.g. less than approximately 10%) and the elongation is l/l₀, where l is the gauge length after some deformation has occurred and l₀ is the initial gauge length. The mechanical properties can depend on the temperature at which they are measured. The test temperature may be below the expected use temperature for a dental appliance such as 35° C. to 40° C. In some embodiments, the test temperature is 23±2° C.

Properties of the polymeric material can be determined after a soak time in a wet environment. Determination of values after a soak time in a wet environment can be conducted on a 1-mm thick sample. For example, material properties of a polymeric material disclosed herein can be determined by obtaining a 1-mm thick sample of said polymeric material, and soaking in a wet environment for 24 hours at 37° C. (i.e., the material after 24 hours in a wet environment at 37° C.).

In some embodiments, the polymeric material has an elongation at break greater than 5%, greater than 10%, greater than 15%, greater than 20%, greater than 25%, greater than 30%, greater than 35%, greater than 40%, greater than 45%, or greater than 50% after 24 hours in a wet environment at 37° C. In some embodiments, the polymeric material has an elongation at break greater than 5%, greater than 10%, greater than 15%, greater than 20%, greater than 25%, greater than 30%, greater than 35%, greater than 40%, greater than 45%, or greater than 50% before 24 hours in a wet environment at 37° C. In preferred embodiments, the polymeric material has an elongation at break greater than 15% before and after 24 hours in a wet environment at 37° C.

In some embodiments, the polymeric material has a tensile strength at yield from 1 MPa to 100 MPa, from 5 MPa to 85 MPa, from 10 MPa to 75 MPa, from 15 MPa to 65 MPa, from 20 MPa to 55 MPa, or from 25 MPa to 45 MPa after 24 hours in a wet environment at 37° C. In preferred embodiments, the polymeric material has a tensile strength at yield from 10 MPa to 55 MPa after 24 hours in a wet environment at 37° C. In some embodiments, the polymeric material is characterized by a tensile strength at yield greater than or equal to 0.1 MPa, greater than or equal to 0.5 MPa, greater than or equal to 1 MPa, greater than or equal to 2 MPa, greater than or equal to 3 MPa, greater than or equal to 4 MPa, greater than or equal to 5 MPa, greater than or equal to 6 MPa, greater than or equal to 7 MPa, greater than or equal to 8 MPa, greater than or equal to 9 MPa, or greater than or equal to 10 MPa after 24 hours in a wet environment at 37° C. In preferred embodiments, the polymeric material is characterized by a tensile strength at yield greater than or equal to 5 MPa after 24 hours in a wet environment at 37° C.

In some embodiments, the polymeric material has an ultimate tensile strength from 10 MPa to 100 MPa, from 15 MPa to 80 MPa, from 20 MPa to 60 MPa, from 25 MPa to 50 MPa, from 25 MPa to 45 MPa, from 25 MPa to 40 MPa, from 30 MPa to 45 MPa, or from 30 MPa to 40 MPa after 24 hours in a wet environment at 37° C. In preferred embodiments, the polymeric material has an ultimate tensile strength from 10 MPa to 50 MPa after 24 hours in a wet environment at 37° C.

In some embodiments, the polymeric material has a tensile modulus from 100 MPa to 3000 MPa, from 200 MPa to 3000 MPa, from 250 MPa to 2750 MPa, from 400 MPa to 2500 MPa, from 600 MPa to 2250 MPa, or from 800 MPa to 2000 MPa after 24 hours in a wet environment at 37° C. In some embodiments, the polymeric material has a tensile modulus of greater or equal to 100 MPa, greater or equal to 200 MPa, greater or equal to 300 MPa, greater or equal to 400 MPa, greater or equal to 500 MPa, greater or equal to 600 MPa, greater or equal to 700 MPa, greater or equal to 800 MPa, greater or equal to 900 MPa, greater or equal to 1000 MPa, greater or equal to 1100 MPa, greater or equal to 1200 MPa, greater or equal to 1300 MPa, greater or equal to 1400 MPa, or greater or equal to 1500 MPa after 24 hours in a wet environment at 37° C. In some preferred embodiments, the polymeric material has a tensile modulus of greater than 200 MPa after 24 hours in a wet environment at 37° C. In some preferred embodiments, the polymeric material has a tensile modulus from 1.0 GPa to 1.4 GPa after 24 hours in a wet environment at 37° C. In some preferred embodiments, the polymeric material is characterized by a tensile modulus greater than or equal to 200 MPa after 24 hours in a wet environment at 37° C.

In some embodiments, the polymeric material has a flexural stress relaxation remaining (“flexural stress remaining”) greater than or equal to 5%, greater than or equal to 10%, greater than or equal to 15%, greater than or equal to 20%, greater than or equal to 35%, greater than or equal to 40%, greater than or equal to 45%, greater than or equal to 50%, greater than or equal to 55%, or greater than or equal to 60% after 24 hours in a wet environment at 37° C. In some preferred embodiments the polymeric material has a flexural stress remaining of greater than or equal to 10% after 24 hours in a wet environment at 37° C. In some embodiments, the polymeric material is characterized by a flexural stress remaining from 5% to 45%, from 10% to 45%, from 15% to 45%, from 20% to 45%, from 25% to 45%, or from 30% to 45% of the initial load after 24 hours in a wet environment at 37° C. In some preferred embodiments, the polymeric material is characterized by a flexural stress remaining from 20% to 45% of the initial load after 24 hours in a wet environment at 37° C.

In some embodiments, the polymeric material is characterized by a flexural stress remaining from 0.01 MPa to 15 MPa, from 0.05 MPa to 15 MPa, from 0.1 MPa to 15 MPa, from 0.5 MPa to 15 MPa, from 1 MPa to 15 MPa, from 2 MPa to 15 MPa, from 3 MPa to 15 MPa, from 4 MPa to 15 MPa, from 5 MPa to 15 MPa, or from 10 MPa to 15 MPa after 24 hours in a wet environment at 37° C. In some preferred embodiments, the polymeric material is characterized by a flexural stress remaining from 2 MPa to 15 MPa after 24 hours in a wet environment at 37° C. In some embodiments, the polymeric material is characterized by a flexural stress remaining of greater than or equal to 0.1 MPa, greater than or equal to 0.5 MPa, greater than or equal to 1 MPa, greater than or equal to 1.5 MPa, greater than or equal to 2 MPa, greater than or equal to 2.5 MPa, greater than or equal to 3 MPa, greater than or equal to 4 MPa, greater than or equal to 5 MPa, greater than or equal to 6 MPa, greater than or equal to 7 MPa, greater than or equal to 8 MPa, greater than or equal to 9 MPa, greater than or equal to 10 MPa, or greater than or equal to 15 MPa after 24 hours in a wet environment at 37° C. In some preferred embodiments, the polymeric material is characterized by a flexural stress remaining of greater than or equal to 1.5 MPa after 24 hours in a wet environment at 37° C.

In certain embodiments, it is advantageous that the polymeric materials have a high flexural stress remaining, forming relatively stiff materials. In some applications relating to use of hard materials (e.g., aeronautical engineering, medical implants), a polymeric material formed from the polymerizable resin compositions disclosed herein would be advantageous due to the availability of conventional 3D printers to form these polymeric materials having the desired characteristics. In some embodiments, the polymeric material has a flexural modulus remaining of 50 MPa or more, 60 MPa or more, 70 MPa or more, 80 MPa or more, 90 MPa or more, 100 MPa or more, 125 MPa or more, or 150 MPa or more after 24 hours in a wet environment at 37° C.

In certain other embodiments, it is advantageous that the polymeric materials have a relatively low flexural stress remaining, forming materials that are not overly-stiff. In some embodiments, the polymeric material has a flexural modulus remaining of 80 MPa or less, 70 MPa or less, 60 MPa or less, 55 MPa or less, 50 MPa or less, or 45 MPa or less after 24 hours in a wet environment at 37° C.

In some embodiments, a polymeric material will have a flexural stress remaining after a period of time of use. As a non-limiting example, an orthodontic appliance (e.g., an aligner) can be formed of a polymeric material having a high flexural stress. In some embodiments, following application of the appliance to the teeth of a patient, there can be a significant and fast decrease of flexural stress (e.g., over the course of minutes). Such decreases in flexural stress can follow an exponential curve of decrease leading towards an asymptote during the intended lifetime of the appliance (e.g., over the course of weeks for an orthodontic appliance such as an aligner). Orthodontic appliances may have an initial period of discomfort that, following a period of use, decreases corresponding with a decrease of flexural stress remaining. In some embodiments, the polymeric material has a flexural stress remaining of 90 MPa or less, 85 MPa or less, 80 MPa or less, 75 MPa or less, 70 MPa or less, 65 MPa or less, 60 MPa or less, 55 MPa or less, or 50 MPa or less after a time period of use. In preferred embodiments, the polymeric material has a flexural stress remaining of 80 MPa or less after a time period of use. In some embodiments, the time period of use is 1 minute, 5 minutes, 10 minutes, 30 minutes, 1 hour, or 24 hours. As a non-limiting example, an aligner composed of polymeric material placed onto a patient's teeth that is removed after 10 minutes and has a flexural stress of 70 MPa would have a polymeric material characterized by a flexural stress remaining of 70 MPa after a time period of use, wherein said time period is 10 minutes.

In certain embodiments, the polymeric material is characterized by an elongation at yield of greater than or equal to 1%, greater than or equal to 2%, greater than or equal to 3%, greater than or equal to 4%, greater than or equal to 5%, greater than or equal to 6%, greater than or equal to 7%, greater than or equal to 8%, greater than or equal to 9%, greater than or equal to 10%, greater than or equal to 15%, or greater than or equal to 20% after 24 hours in a wet environment at 37° C. (i.e., following exposure to a wet environment for 24 hours). In some embodiments, the polymeric material is characterized by an elongation at yield of greater than or equal to 1%, greater than or equal to 2%, greater than or equal to 3%, greater than or equal to 4%, greater than or equal to 5%, greater than or equal to 6%, greater than or equal to 7%, greater than or equal to 8%, greater than or equal to 9%, greater than or equal to 10%, greater than or equal to 15%, or greater than or equal to 20% before 24 hours in a wet environment at 37° C. In preferred embodiments, the polymeric material is characterized by an elongation at yield of greater than or equal to 4% before and after 24 hours in a wet environment at 37° C.

In some embodiments, the polymeric material has a maximum force at 5% strain greater than or equal to 3 pound-force per 3.57 cm². As a non-limiting example, the sample is a rectangular slab having a width of 2.1 cm and a distance between support of 1.7 cm. In some embodiments, the polymeric material has a remaining force greater than 0.1 pound-force per 3.57 cm² after being submerged for 24 hours in a wet environment having a temperature of 37° C.

In some embodiments, the polymeric material is characterized by an elongation at yield from 1% to 10%, from 2% to 10%, from 3% to 10%, from 4% to 10%, from 5% to 10%, from 1% to 15%, from 1% to 20%, or from 1% to 25% after 24 hours in a wet environment at 37° C. In some embodiments, the polymeric material is characterized by an elongation at yield from 1% to 10%, from 2% to 10%, from 3% to 10%, from 4% to 10%, from 5% to 10%, from 1% to 15%, from 1% to 20%, or from 1% to 25% before 24 hours in a wet environment at 37° C. In preferred embodiments, the polymeric material is characterized by an elongation at yield from 4% to 10% before and after 24 hours in a wet environment at 37° C.

In some embodiments, the polymeric material is characterized by an elongation at break of greater than 5%, greater than 10%, greater than 15%, greater than 20%, greater than 25%, greater than 30%, greater than 35%, greater than 40%, greater than 45%, or greater than 50% after 24 hours in a wet environment at 37° C. In some embodiments, the polymeric material is characterized by an elongation at break of greater than 5%, greater than 10%, greater than 15%, greater than 20%, greater than 25%, greater than 30%, greater than 35%, greater than 40%, greater than 45%, or greater than 50% before 24 hours in a wet environment at 37° C. In preferred embodiments, the polymeric material is characterized by an elongation at break of greater than 15% before and after 24 hours in a wet environment at 37° C. In some embodiments, the polymeric material is characterized by an elongation at break from 5% to 250%, from 10% to 250%, from 15% to 250%, from 20% to 250%, from 25% to 250%, from 30% to 250%, from 35% to 250%, from 40% to 250%, from 45% to 250%, from 50% to 250%, from 75% to 250%, or from 100% to 250% after 24 hours in a wet environment at 37° C. In some embodiments, the polymeric material is characterized by an elongation at break from 5% to 250%, from 10% to 250%, from 15% to 250%, from 20% to 250%, from 25% to 250%, from 30% to 250%, from 35% to 250%, from 40% to 250%, from 45% to 250%, from 50% to 250%, from 75% to 250%, or from 100% to 250% before 24 hours in a wet environment at 37° C. In preferred embodiments, the polymeric material is characterized by an elongation at break from 40% to 250% before and after 24 hours in a wet environment at 37° C.

In some embodiments, the polymeric material is characterized by a storage modulus from 0.1 MPa to 4000 MPa, from 50 MPa to 2750 MPa, from 100 MPa to 2500 MPa, from 200 MPa to 2250 MPa, from 300 MPa to 3000 MPa, from 500 MPa to 3000 MPa, from 750 MPa to 3000 MPa, or from 1000 MPa to 3000 MPa after 24 hours in a wet environment at 37° C. In preferred embodiments, the polymeric material is characterized by a storage modulus from 750 MPa to 3000 MPa after 24 hours in a wet environment at 37° C.

In some embodiments, the polymeric material has at least one glass transition temperature (T_{g}) from 0° C. to 150° C. In preferred embodiments, the polymeric material has at least one glass transition temperature greater than 60° C. In even more preferred embodiments, the polymeric material has at least one glass transition temperature greater than 75° C. In some embodiments, the at least one glass transition temperature is from 0° C. to 200° C., from 0° C. to 140° C., from 0° C. to 20° C., from 20° C. to 40° C., from 40° C. to 60° C., from 60° C. to 80° C., from 80° C. to 100° C., from 100° C. to 120° C., from 120° C. to 140° C., from 140° C. to 160° C., from 160° C. to 180° C., from 180° C. to 200° C., from 0° C. to 35° C., from 35° C. to 65° C., from 65° C. to 100° C., from 0° C. to 50° C., or from 50° C. to 100° C. In some embodiments, the polymeric material has at least one glass transition temperature from 0° C. to 10° C., from 10° C. to 20° C., from 20° C. to 30° C., from 30° C. to 40° C., from 40° C. to 50° C., from 50° C. to 60° C., from 60° C. to 70° C., from 70° C. to 80° C., or from 80° C. to 90° C. In some embodiments, the polymeric material has at least one glass transition temperature from −100° C. to 40° C., from −80° C. to 10° C., from −70° C. to 0° C., from −70° C. to −10° C., from −70° C. to −20° C., from −70° C. to −30° C., from −70° C. to −40° C., from −70° C. to −50° C., or from −80° C. to −40° C. In some embodiments, the polymeric material has at least two glass transition temperatures. In certain embodiments, the polymeric material has a first glass transition temperature less than or equal to 40° C. and a second glass transition temperature greater than or equal to 60° C. In some embodiments, the polymeric material has a first glass transition temperature less than or equal to 0° C. and a second glass transition temperature greater than or equal to 60° C. In some embodiments, the polymeric material has a first glass transition temperature less than or equal to 0° C. and a second glass transition temperature greater than or equal to 75° C. In some embodiments, the polymeric material has a first glass transition temperature less than −20° C. and a second glass transition temperature greater than 80° C.

Low levels of water absorption are favorable for polymeric materials described herein. Water absorption can occur when a polymeric material is exposed to a wet environment (e.g., a patient's mouth using an orthodontic appliance formed from a polymeric material). Properties of the polymeric material can degrade when water absorption reaches a threshold value, typically greater than 22 wt %. It is preferred herein that the polymeric materials have low levels of water uptake. In some embodiments, the polymeric material formed from the polymerizable resin composition comprises a water uptake of less than 25 wt %, less than 20 wt %, less than 15 wt %, less than 10 wt %, less than 5 wt %, less than 4 wt %, less than 3 wt %, less than 2 wt %, less than 1 wt %, less than 0.5 wt %, less than 0.25 wt %, or less than 0.1 wt %. In preferred embodiments, the polymeric material formed from the polymerizable resin composition comprises a water uptake of less than 2 wt %. In more preferred embodiments, the polymeric material formed from the polymerizable resin composition comprises a water uptake of less than 1 wt %. In even more preferred embodiments, the polymeric material formed from the polymerizable resin composition comprises a water uptake of less than 0.5 wt %. In embodiments described herein, the water uptake is measured after 24 hours in a wet environment at 37° C. In some embodiments, a polymer formed from the oligomer of the resin is hydrophobic. In preferred embodiments, the polymeric material formed from the polymerizable resin composition is hydrophobic.

In some embodiments, the polymeric material is characterized by having a low water uptake. In some embodiments, the polymeric material comprises less than 40 wt %, less than 35 wt %, less than 30 wt %, less than 25 wt %, less than 20 wt %, less than 15 wt %, less than 10 wt %, less than 5 wt %, less than 4 wt %, less than 3 wt %, less than 2 wt %, or less than 1 wt % water after 24 hours in a wet environment at 37° C. In preferred embodiments, the polymeric material comprises less than 2 wt % water after 24 hours in a wet environment at 37° C. In more preferred embodiments, the polymeric material comprises less than 1 wt % water after 24 hours in a wet environment at 37° C. In even more preferred embodiments, the polymeric material comprises less than 0.5 wt % water after 24 hours in a wet environment at 37° C.

The polymeric materials formed from the polymerizable resin compositions can have high conversion rates or high extent of reactions. In some embodiments, the polymeric material comprises 20-100 wt % of the polymer formed from the oligomer(s) and/or monomer(s) of the polymerizable resin composition. In some embodiments, the polymeric material comprises greater than 20 wt %, greater than 30 wt %, greater than 40 wt %, greater than 50 wt %, greater than 60 wt %, greater than 70 wt %, greater than 80 wt %, greater than 85 wt %, greater than 90 wt %, greater than 95 wt %, greater than 98 wt %, or greater than 99 wt % of the polymer formed from the oligomer(s) and/or monomer(s) of the polymerizable resin composition. In certain embodiments, it is preferable to have a high conversion percentage of oligomer(s) and/or monomer(s) into polymer when forming the polymeric material. In some embodiments, the formed polymer is hydrophobic.

In some embodiments, the polymeric materials formed from the polymerizable resin compositions have high conversion rates of reactive group double bonds (e.g., acrylates or methacrylates) to single bonds, indicating incorporation into the polymeric material. In some embodiments, the conversion of reactive double bonds in the resin to single bonds in the polymeric material can be measured by FTIR (e.g., by measuring relative amounts before and after curing). In some embodiments, the polymeric material formed from the polymerizable resin composition has greater than 60%, greater than 70%, greater than 80%, greater than 90%, or greater than 95% conversion of double bonds to single bonds.

In some embodiments, the polymeric materials formed from the polymerizable resin compositions have low levels of extractable materials (e.g., unreacted monomers from said polymerizable resin composition). The amount of extractable materials can be determined by weight loss of the polymeric material after soaking in water for 1 week, after soaking in ethanol for 48 hours, or after soaking in hexane for 48 hours. A general experiment for determining the amount of extractable material includes the steps of (i) weighing a dried sample of the polymeric material; (ii) soaking the sample in a solvent at a given temperature (e.g., 25° C.) for a period of time; (iii) refreshing the solvent until extraction is completed; (iv) drying the sample in an oven; (v) weighing the extracted sample; and (vi) calculating the weight loss. In some embodiments, the polymeric materials formed from the polymerizable resin composition have less than 5 wt %, less than 4 wt %, less than 3 wt %, less than 2 wt %, less than 1 wt %, less than 0.75 wt %, less than 0.5 wt %, or less than 0.25 wt % extractable materials.

In some embodiments, the polymeric material has less than 20 wt %, less than 15 wt %, less than 10 wt %, less than 9 wt %, less than 8 wt %, less than 7 wt %, less than 6 wt %, less than 5 wt %, less than 4 wt %, less than 3 wt %, less than 2 wt %, or less than 1 wt % hydrogen bonding units, as calculated or measured by weight percentage of hydrogen bonding groups, further described herein. In preferred embodiments, the polymeric material has less than or equal to 10 wt % hydrogen bonding units.

In some cases, the polymeric material comprises a color defined by an L* value between 70 and 95, an a* value of between −11 and 1, and a b* value of between 2 and 22. In some cases, the polymeric material comprises a color defined by an L* value between 78 and 87, an a* value of between −7 and −3, and a b* value of between 8 and 16.

In some embodiments, the polymeric material is clear, substantially clear, mostly clear, or opaque. In certain embodiments, the polymeric material is clear. In certain embodiments, the polymeric material is substantially clear. In certain embodiments, the polymeric material is mostly clear. In some embodiments, greater than 70% of visible light passes through the polymeric material. In certain embodiments, greater than 80% of visible light passes through the polymeric material. In certain embodiments, greater than 90% of visible light passes through the polymeric material. In certain embodiments, greater than 95% of visible light passes through the polymeric material. In certain embodiments, greater than 99% of visible light passes through the polymeric material. Transparency can be measured using a UV-Vis spectrophotometer. In some embodiments, the transparency is measured by measuring the passage of a wavelength of transparency. In some embodiments, greater than 70%, greater than 80%, greater than 90%, greater than 95%, or greater than 99% of the wavelength of transparency can pass through the polymeric material. In some embodiments, the wavelength of transparency is in the visible light range (i.e., from 400 nm to 800 nm), is in the infrared light range, or is in the ultraviolet light range. In some embodiments, the polymeric material does not have color. In other embodiments, the polymeric material appears white, off-white, or mostly transparent with white coloring, as detected by the human eye.

In some embodiments, greater than 20%, greater than 30%, greater than 40%, greater than 50%, greater than 60%, greater than 70%, greater than 80%, greater than 90%, or greater than 95% of visible light passes through the polymeric material after 24 hours in a wet environment at 37° C. In preferred embodiments, greater than 70% of visible light passes through the polymeric material after 24 hours in a wet environment at 37° C.

In some embodiments, the polymeric material is biocompatible, bioinert, or a combination thereof.

In some embodiments, the polymeric material is formed using 3D printing (i.e., by additive manufacturing) using photopolymerization. In certain embodiments, the polymeric material is formed using conventional 3D printers. In some embodiments, the polymeric material can be used in coatings, molds, injection molding machines, or other manufacturing methods that use or could use light during the curing process. In some embodiments, the polymeric material is well suited for applications that require, e.g., solvent resistance, humidity resistance, water resistance, creep resistance, or heat deflection resistance.

### Methods of Making Polymeric Materials

The present disclosure provides methods for making the polymeric materials described herein, wherein said polymeric materials are formed by polymerizing (e.g., photocuring) the polymerizable resin compositions comprising an antioxidant stabilizer, a reactive diluent and a telechelic compound described herein, and optionally one or more additional compositions selected from initiators, T_{g} modifiers, crosslinking modifiers, solvents, fillers, antioxidants, pigments, colorants, surface modifiers, and mixtures thereof, to obtain an optionally cross-linked polymer. In some embodiments, the method for forming a polymeric material comprises: (i) providing a polymerizable resin composition disclosed herein; and (ii) curing the polymerizable resin composition, forming the polymeric material disclosed herein.

In some embodiments, providing the polymerizable resin composition comprises mixing the components of the polymerizable resin composition.

In some embodiments, curing the polymerizable resin composition comprises exposing the polymerizable resin composition to a light source that initiates and/or facilitate photopolymerization. In some embodiments, a photoinitiator can be used as part of the resin composition to accelerate and/or initiate photopolymerization. In some embodiments, the polymerizable resin composition is exposed to radiation (e.g., UV or visible light) of sufficient power and of a wavelength capable of initiating polymerization. The wavelengths and/or power of radiation useful to initiate polymerization may depend on the photoinitiator used. “Light” as used herein includes any wavelength and power capable of initiating polymerization. Some wavelengths of light include ultraviolet (UV) or visible. UV light sources include UVA (wavelength about 400 nanometers (nm) to about 320 nm), UVB (about 320 nm to about 290 nm) or UVC (about 290 nm to about 100 nm). Any suitable source may be used, including laser sources. The source may be broadband or narrowband, or a combination thereof. The light source may provide continuous or pulsed light during the process. Both the length of time the system is exposed to UV light and the intensity of the UV light can be varied to determine the ideal reaction conditions. In certain embodiments, a polymerizable resin composition is cured using an additive manufacturing device to produce the polymeric material. In some embodiments, the polymerizable resin composition herein may be heated to a predefined elevated process temperature ranging from about 50° C. to about 120° C., such as from about 90° C. to about 120° C., before becoming irradiated with light of a suitable wavelength to be absorbed by the photoinitiator, thereby causing activation of the photoinitiator to induce polymerization of the polymerizable resin to obtain a cured polymeric material, which can optionally be crosslinked.

In some embodiments, the methods disclosed herein for forming a polymeric material arc part of a high temperature lithography-based photopolymerization process, wherein a polymerizable resin composition (e.g., a photopolymerizable resin composition) that can comprise at least one photoinitiator is heated to an elevated process temperature. The heating may lower the viscosity of the polymerizable resin composition before and/or during curing. Non-limiting examples of high-temperature lithography processes include those processes described in WO 2015/075094, WO 2016/078838 and WO 2018/032022. In some implementations, the high-temperature lithography may involve applying heat to material to temperatures from about 50° C. to about 120° C., such as from about 90° C. to about 120° C., from about 100° C. to about 120° C., from about 105° C. to about 115° C., from about 108° C. to about 110° C., etc. The material may be heated to temperatures greater than about 120° C. It is noted other temperature ranges may be used without departing from the scope and substance of the inventive concepts described herein. Thus, a method for forming a polymeric material according to the present disclosure can offer the possibility of quickly and facilely producing devices, such as orthodontic appliances, by additive manufacturing such as 3D printing using polymerizable resin composition as disclosed herein.

In some embodiments, the methods disclosed herein further comprise heating the polymeric material to an elevated temperature. In certain embodiments, the elevated temperature is from 40° C. to 150° C. In some embodiments, heating the polymeric material to the elevated temperature occurs after curing the polymerizable resin composition. In certain embodiments, a thermal cure occurs by heating the polymeric material comprising a thermal initiator to an elevated temperature following the photo-curing step. In certain embodiments, the polymerizable resin composition is cured using an additive manufacturing device to produce the polymeric material. In some embodiments, the additive manufacturing device is a 3-D printer. In some embodiments, the method further comprises the step of cleaning the polymeric material. In certain embodiments, the cleaning of the polymeric material includes washing and/or rinsing the polymeric material with a solvent, which can remove monomers and undesired impurities from the polymeric material.

As described herein, a polymeric material produced by the methods provided herein can be characterized by one or more of: (i) a storage modulus greater than or equal to 200 MPa; (ii) a flexural stress of greater than or equal to 1.5 MPa remaining after 24 hours in a wet environment at 37° C.; (iii) an elongation at break greater than or equal to 5% before and after 24 hours in a wet environment at 37° C.; (iv) a water uptake of less than 25 wt % when measured after 24 hours in a wet environment at 37° C.; and (v) transmission of at least 30% of visible light through the polymeric material after 24 hours in a wet environment at 37° C. In various cases, such polymeric material can be characterized by at least 2, 3, 4, or all of these properties.

### Fabrication and Use of Orthodontic Appliances

The present disclosure provides devices comprising the polymeric materials generated from the polymerizable resin compositions as described further herein. In some embodiments, the polymeric material is used to create orthodontic appliances intended to be placed in the intraoral cavity of a human. Such orthodontic appliances can be, for example, aligners that help to move teeth to new positions. In some embodiments, the orthodontic appliances can be retainers that help to keep teeth from moving to a new position. In some embodiments, the orthodontic appliances can be expanders used to expand the palate, move the location of the jaw, or prevent snoring of a human.

In some embodiments, the present disclosure provides methods for producing the devices described herein, said devices comprising a polymeric material generated from the polymerizable resin compositions described herein. In some embodiments, the method comprises a step of shaping a polymerizable resin composition into a desirable shape prior to a step of curing the polymerizable resin composition, thereby generating the polymeric material having said desirable shape. In some embodiments, the method comprises a step of shaping a polymerizable resin composition into a desirable shape during a step of curing the polymerizable resin composition, thereby generating the polymeric material having said desirable shape. In some embodiments, the method comprises a step of curing the polymerizable resin composition, thereby forming the polymeric material, then shaping the polymeric material into a desirable shape. In some embodiments, the desirable shape is an orthodontic appliance. In some embodiments, the desirable shape is a device and/or object as disclosed herein. In some embodiments, the shaping step comprises extrusion, production of a sheet, production of a film, melt spinning, coating, injection molding, compression and transfer molding, blow molding, rotational blow molding, thermoforming, casting, or a combination thereof.

In certain embodiments, the present disclosure provides an orthodontic appliance comprising a polymeric material as further described herein. The orthodontic appliance may be an aligner, expander, or retainer. In some embodiments, the orthodontic appliance comprises a plurality of tooth receiving cavities configured to reposition teeth from a first configuration toward a second configuration. In some embodiments, the orthodontic appliance is one of a plurality of orthodontic appliances configured to reposition the teeth from an initial configuration toward a target configuration, optionally according to a treatment plan. As used herein a “plurality of teeth” encompasses two or more teeth.

In many embodiments, one or more posterior teeth comprise one or more of a molar, a premolar, or a canine, and one or more anterior teeth comprising one or more of a central incisor, a lateral incisor, a cuspid, a first bicuspid, or a second bicuspid.

The polymerizable resin compositions and cured polymeric materials according to the present disclosure exhibit favorable thermomechanical properties for use as orthodontic appliances, for example, for moving one or more teeth. The addition of the antioxidant stabilizer does not affect the mechanical properties of the orthodontic appliances.

The embodiments disclosed herein can be used to couple groups of one or more teeth to each other. The groups of one or more teeth may comprise a first group of one or more anterior teeth and a second group of one or more posterior teeth. The first group of teeth can be coupled to the second group of teeth with the polymeric shell appliances as disclosed herein.

The embodiments disclosed herein are well suited for moving one or more teeth of the first group of one or more teeth or moving one or more of the second group of one or more teeth, and combinations thereof.

The embodiments disclosed herein are well suited for combination with one or known commercially available tooth moving components such as attachments and polymeric shell appliances. In many embodiments, the appliance and one or more attachments are configured to move one or more teeth along a tooth movement vector comprising six degrees of freedom, in which three degrees of freedom are rotational and three degrees of freedom are translation.

The present disclosure provides orthodontic systems and related methods for designing and providing improved or more effective tooth moving systems for eliciting a desired tooth movement and/or repositioning teeth into a desired arrangement.

Although reference is made to an appliance comprising a polymeric shell appliance, the embodiments disclosed herein are well suited for use with many appliances that receive teeth, for example appliances without one or more of polymers or shells. The appliance can be fabricated with one or more of many materials such as metal, glass, reinforced fibers, carbon fiber, composites, reinforced composites, aluminum, biological materials, and combinations thereof for example. In some cases, the reinforced composites can comprise a polymer matrix reinforced with ceramic or metallic particles, for example. The appliance can be shaped in many ways, such as with thermoforming or direct fabrication as described herein, for example. Alternatively or in combination, the appliance can be fabricated with machining such as an appliance fabricated from a block of material with computer numeric control machining. Preferably, the appliance is fabricated using a polymerizable resin according to the present disclosure.

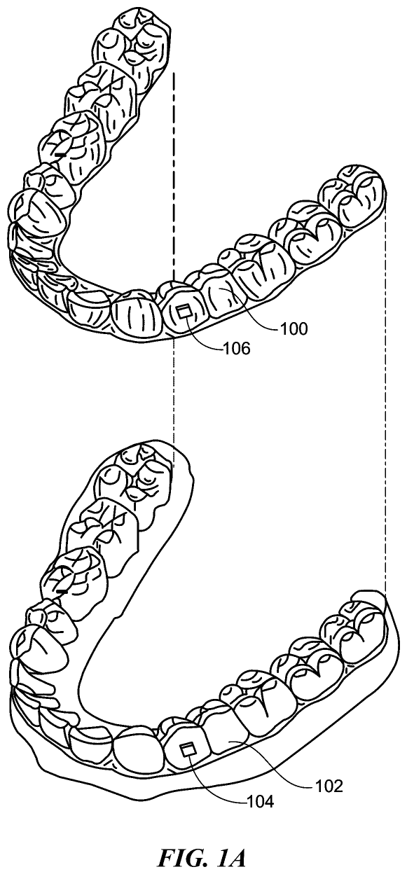

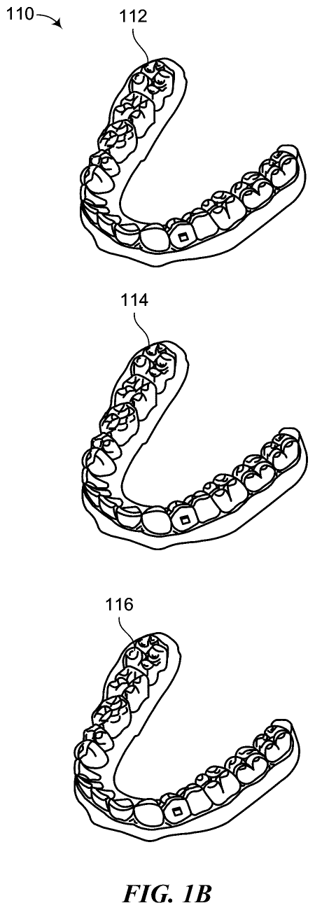

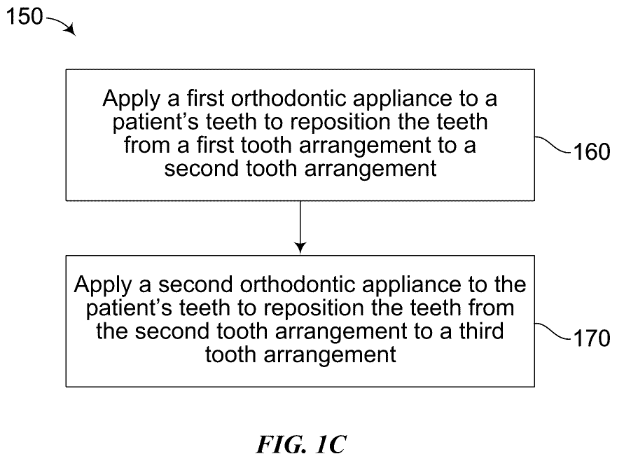

Turning now to the drawings, in which like numbers designate like elements in the various figures, FIG. 1A illustrates an exemplary tooth repositioning appliance or aligner 100 that can be worn by a patient in order to achieve an incremental repositioning of individual teeth 102 in the jaw, and comprises the cured polymeric material disclosed herein. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using rapid prototyping fabrication techniques, from a digital model of an appliance. An appliance can fit over all teeth present in an upper or lower jaw, or less than all of the teeth. The appliance can be designed specifically to accommodate the teeth of the patient (e.g., the topography of the tooth-receiving cavities matches the topography of the patient's teeth) and may be fabricated based on positive or negative models of the patient's teeth generated by impression, scanning, and the like. Alternatively, the appliance can be a generic appliance configured to receive the teeth, but not necessarily shaped to match the topography of the patient's teeth. In some cases, only certain teeth received by an appliance will be repositioned by the appliance while other teeth can provide a base or anchor region for holding the appliance in place as it applies force against the tooth or teeth targeted for repositioning. In some cases, some, most, or even all of the teeth will be repositioned at some point during treatment. Teeth that are moved can also serve as a base or anchor for holding the appliance as it is worn by the patient. Typically, no wires or other means will be provided for holding an appliance in place over the teeth. In some cases, however, it may be desirable or necessary to provide individual attachments or other anchoring elements 104 on teeth 102 with corresponding receptacles or apertures 106 in the appliance 100 so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 1B illustrates a tooth repositioning system 110 including a plurality of appliances 112, 114, 116. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 110 can include a first appliance 112 corresponding to an initial tooth arrangement, one or more intermediate appliances 114 corresponding to one or more intermediate arrangements, and a final appliance 116 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 1C illustrates a method 150 of orthodontic treatment using a plurality of appliances, in accordance with embodiments. The method 150 can be practiced using any of the appliances or appliance sets described herein. In step 160, a first orthodontic appliance is applied to a patient's teeth in order to reposition the teeth from a first tooth arrangement to a second tooth arrangement. In step 170, a second orthodontic appliance is applied to the patient's teeth in order to reposition the teeth from the second tooth arrangement to a third tooth arrangement. The method 150 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

The various embodiments of the orthodontic appliances presented herein can be fabricated in a wide variety of ways. In some embodiments, the orthodontic appliances herein (or portions thereof) can be produced using direct fabrication, such as additive manufacturing techniques (also referred to herein as “3D printing”) or subtractive manufacturing techniques (e.g., milling). In some embodiments, direct fabrication involves forming an object (e.g., an orthodontic appliance or a portion thereof) without using a physical template (e.g., mold, mask etc.) to define the object geometry. Additive manufacturing techniques can be categorized as follows: (1) vat photopolymerization (e.g., stereolithography), in which an object is constructed layer by layer from a vat of liquid photopolymer resin; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) fused deposition modeling (FDM), in which material is drawn though a nozzle, heated, and deposited layer by layer; (5) powder bed fusion, including but not limited to direct metal laser sintering (DMLS), electron beam melting (EBM), selective heat sintering (SHS), selective laser melting (SLM), and selective laser sintering (SLS); (6) sheet lamination, including but not limited to laminated object manufacturing (LOM) and ultrasonic additive manufacturing (UAM); and (7) directed energy deposition, including but not limited to laser engineering net shaping, directed light fabrication, direct metal deposition, and 3D laser cladding. For example, stereolithography can be used to directly fabricate one or more of the appliances herein. In some embodiments, stereolithography involves selective polymerization of a photosensitive resin (e.g., a photopolymer) according to a desired cross-sectional shape using light (e.g., ultraviolet light). The object geometry can be built up in a layer-by-layer fashion by sequentially polymerizing a plurality of object cross-sections. As another example, the appliances herein can be directly fabricated using selective laser sintering. In some embodiments, selective laser sintering involves using a laser beam to selectively melt and fuse a layer of powdered material according to a desired cross-sectional shape in order to build up the object geometry. As yet another example, the appliances herein can be directly fabricated by fused deposition modeling. In some embodiments, fused deposition modeling involves melting and selectively depositing a thin filament of thermoplastic polymer in a layer-by-layer manner in order to form an object. In yet another example, material jetting can be used to directly fabricate the appliances herein. In some embodiments, material jetting involves jetting or extruding one or more materials onto a build surface in order to form successive layers of the object geometry.

Alternatively or in combination, some embodiments of the appliances herein (or portions thereof) can be produced using indirect fabrication techniques, such as by thermoforming over a positive or negative mold. Indirect fabrication of an orthodontic appliance can involve producing a positive or negative mold of the patient's dentition in a target arrangement (e.g., by rapid prototyping, milling, etc.) and thermoforming one or more sheets of material over the mold in order to generate an appliance shell.

In some embodiments, the direct fabrication methods provided herein build up the object geometry in a layer-by-layer fashion, with successive layers being formed in discrete build steps. Alternatively, or in combination, direct fabrication methods that allow for continuous build-up of an object geometry can be used, referred to herein as “continuous direct fabrication.” Various types of continuous direct fabrication methods can be used. As an example, in some embodiments, the appliances herein are fabricated using “continuous liquid interphase printing,” in which an object is continuously built up from a reservoir of polymerizable resin composition by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Continuous liquid interphase printing can achieve fabrication speeds about 25 times to about 100 times faster than other direct fabrication methods, and speeds about 1000 times faster can be achieved with the incorporation of cooling systems. Continuous liquid interphase printing is described in U.S. Patent Publication Nos. 2015/0097315, 2015/0097316, and 2015/0102532, the disclosures of each of which are incorporated herein by reference in their entirety.

As another example, a continuous direct fabrication method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety.

In another example, a continuous direct fabrication method can involve extruding a composite material composed of a polymerizable liquid material surrounding a solid strand. The composite material can be extruded along a continuous three-dimensional path in order to form the object. Such methods are described in U.S. Patent Publication No. 2014/0061974, the disclosure of which is incorporated herein by reference in its entirety.

In yet another example, a continuous direct fabrication method utilizes a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

Machine parameters can include curing parameters. For digital light processing (DLP)-based curing systems, curing parameters can include power, curing time, and/or grayscale of the full image. For laser-based curing systems, curing parameters can include power, speed, beam size, beam shape and/or power distribution of the beam. For printing systems, curing parameters can include material drop size, viscosity, and/or curing power. These machine parameters can be monitored and adjusted on a regular basis (e.g., some parameters at every 1-x layers and some parameters after each build) as part of the process control on the fabrication machine. Process control can be achieved by including a sensor on the machine that measures power and other beam parameters every layer or every few seconds and automatically adjusts them with a feedback loop. For DLP machines, gray scale can be measured and calibrated before, during, and/or at the end of each build, and/or at predetermined time intervals (e.g., every n^{th} build, once per hour, once per day, once per week, etc.), depending on the stability of the system. In addition, material properties and/or photo-characteristics can be provided to the fabrication machine, and a machine process control module can use these parameters to adjust machine parameters (e.g., power, time, gray scale, etc.) to compensate for variability in material properties. By implementing process controls for the fabrication machine, reduced variability in appliance accuracy and residual stress can be achieved.

Optionally, the direct fabrication methods described herein allow for fabrication of an appliance including multiple materials, referred to herein as “multi-material direct fabrication.” In some embodiments, a multi-material direct fabrication method involves concurrently forming an object from multiple materials in a single manufacturing step. For instance, a multi-tip extrusion apparatus can be used to selectively dispense multiple types of materials from distinct material supply sources in order to fabricate an object from a plurality of different materials. Such methods are described in U.S. Pat. No. 6,749,414, the disclosure of which is incorporated herein by reference in its entirety. Alternatively, or in combination, a multi-material direct fabrication method can involve forming an object from multiple materials in a plurality of sequential manufacturing steps. For instance, a first portion of the object can be formed from a first material in accordance with any of the direct fabrication methods herein, then a second portion of the object can be formed from a second material in accordance with methods herein, and so on, until the entirety of the object has been formed.

Direct fabrication can provide various advantages compared to other manufacturing approaches. For instance, in contrast to indirect fabrication, direct fabrication permits production of an orthodontic appliance without utilizing any molds or templates for shaping the appliance, thus reducing the number of manufacturing steps involved and improving the resolution and accuracy of the final appliance geometry. Additionally, direct fabrication permits precise control over the three-dimensional geometry of the appliance, such as the appliance thickness. Complex structures and/or auxiliary components can be formed integrally as a single piece with the appliance shell in a single manufacturing step, rather than being added to the shell in a separate manufacturing step. In some embodiments, direct fabrication is used to produce appliance geometries that would be difficult to create using alternative manufacturing techniques, such as appliances with very small or fine features, complex geometric shapes, undercuts, interproximal structures, shells with variable thicknesses, and/or internal structures (e.g., for improving strength with reduced weight and material usage). For example, in some embodiments, the direct fabrication approaches herein permit fabrication of an orthodontic appliance with feature sizes of less than or equal to about 5 μm, or within a range from about 5 μm to about 50 μm, or within a range from about 20 μm to about 50 μm.

In some embodiments, the direct fabrication techniques described herein can be used to produce appliances with substantially isotropic material properties, e.g., substantially the same or similar strengths along all directions. In some embodiments, the direct fabrication approaches herein permit production of an orthodontic appliance with a strength that varies by no more than about 25%, about 20%, about 15%, about 10%, about 5%, about 1%, or about 0.5% along all directions. In some embodiments, the direct fabrication techniques described herein can be used to produce appliances with substantially anisotropic material properties (e.g., substantially different strengths along all directions). In some embodiments, the direct fabrication techniques described herein produce appliances with a strength that varies by more than about 0.5%, more than about 1%, more than about 5%, more than about 10%, more than about 15%, more than about 20%, or more than about 25% along all directions. Additionally, the direct fabrication approaches herein can be used to produce orthodontic appliances at a faster speed compared to other manufacturing techniques. In some embodiments, the direct fabrication approaches herein allow for production of an orthodontic appliance in a time interval less than or equal to about 1 hour, about 30 minutes, about 25 minutes, about 20 minutes, about 15 minutes, about 10 minutes, about 5 minutes, about 4 minutes, about 3 minutes, about 2 minutes, about 1 minutes, or about 30 seconds. Such manufacturing speeds allow for rapid “chair-side” production of customized appliances, e.g., during a routine appointment or checkup.

In some embodiments, the direct fabrication methods described herein implement process controls for various machine parameters of a direct fabrication system or device in order to ensure that the resultant appliances are fabricated with a high degree of precision. Such precision can be beneficial for ensuring accurate delivery of a desired force system to the teeth in order to effectively elicit tooth movements. Process controls can be implemented to account for process variability arising from multiple sources, such as the material properties, machine parameters, environmental variables, and/or post-processing parameters.

Material properties may vary depending on the properties of raw materials, purity of raw materials, and/or process variables during mixing of the raw materials. In many embodiments, resins or other materials for direct fabrication should be manufactured with tight process control to ensure little variability in photo-characteristics, material properties (e.g., viscosity, surface tension), physical properties (e.g., modulus, strength, elongation) and/or thermal properties (e.g., glass transition temperature, heat deflection temperature). Process control for a material manufacturing process can be achieved with screening of raw materials for physical properties and/or control of temperature, humidity, and/or other process parameters during the mixing process. By implementing process controls for the material manufacturing procedure, reduced variability of process parameters and more uniform material properties for each batch of material can be achieved. Residual variability in material properties can be compensated with process control on the machine, as discussed further herein.

In many embodiments, environmental variables (e.g., temperature, humidity, Sunlight or exposure to other energy/curing source) are maintained in a tight range to reduce variable in appliance thickness and/or other properties. Optionally, machine parameters can be adjusted to compensate for environmental variables.

In many embodiments, post-processing of appliances includes cleaning, post-curing, and/or support removal processes. Relevant post-processing parameters can include purity of cleaning agent, cleaning pressure and/or temperature, cleaning time, post-curing energy and/or time, and/or consistency of support removal process. These parameters can be measured and adjusted as part of a process control scheme. In addition, appliance physical properties can be varied by modifying the post-processing parameters. Adjusting post-processing machine parameters can provide another way to compensate for variability in material properties and/or machine properties.

The configuration of the orthodontic appliances herein can be determined according to a treatment plan for a patient, e.g., a treatment plan involving successive administration of a plurality of appliances for incrementally repositioning teeth. Computer-based treatment planning and/or appliance manufacturing methods can be used in order to facilitate the design and fabrication of appliances. For instance, one or more of the appliance components described herein can be digitally designed and fabricated with the aid of computer-controlled manufacturing devices (e.g., computer numerical control (CNC) milling, computer-controlled rapid prototyping such as 3D printing, etc.). The computer-based methods presented herein can improve the accuracy, flexibility, and convenience of appliance fabrication.

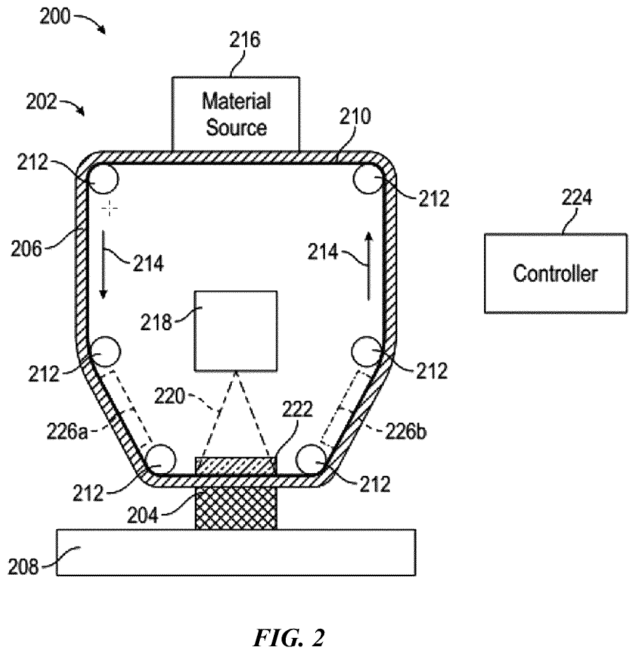

FIG. 2 illustrates a representative example of a system 200 for additive manufacturing configured in accordance with embodiments of the present disclosure. The system 200 can be used to fabricate any embodiment of the objects described herein. For example, the system 200 can be used to produce an object using an additive manufacturing process (e.g., 3D printing).

The system 200 includes a printer assembly 202 configured to fabricate an additively manufactured object 204 (“object 204”) using any of the additive manufacturing processes described herein. The printer assembly 202 is configured to deposit a curable material 206 (e.g., a polymeric resin, polymerizable composition, or other solidifiable precursor material) on a build platform 208 (e.g., a tray, plate, film, sheet, or other planar substrate) to form the object 204. In the illustrated embodiment, the printer assembly 202 includes a carrier film 210 configured to deliver the curable material 206 to the build platform 208. The carrier film 210 can be a flexible loop of material having an outer surface and an inner surface. The outer surface of the carrier film 210 can adhere to and carry a thin layer of the curable material 206. The inner surface of the carrier film 210 can contact one or more rollers 212 that rotate to move the carrier film 210 in a continuous loop trajectory, e.g., along the direction indicated by arrow 214. The printer assembly 202 can also include a material source 216 (shown schematically) configured to apply the curable material 206 to the carrier film 210. In the illustrated embodiment, the material source 216 is located at the upper portion of the printer assembly 202. In other embodiments, however, the material source 216 can be at a different location in the printer assembly 202. The material source 216 can include nozzles, ports, reservoirs, etc., that deposit the curable material 206 onto the outer surface of the carrier film 210. The material source 216 can also include one or more blades (e.g., doctor blades, recoater blades) that smooth the deposited curable material 206 into a relatively thin, uniform layer. For example, the curable material 206 can be formed into a layer having a thickness within a range from 200 microns to 300 microns, or any other desired thickness.

The curable material 206 can be conveyed by the carrier film 210 toward the build platform 208. In the illustrated embodiment, the build platform 208 is located below the printer assembly 202. In other embodiments, however, the build platform 208 can be positioned at a different location in the printer assembly 202. The distance between the carrier film 210 and build platform 208 can be adjustable so that the curable material 206 at can be brought into direct contact with the surface of the build platform 208 (when printing the initial layer of the object 204) or with the surface of the object 204 (when printing subsequent layers of the object 204). For example, the build platform 208 can include or be coupled to a motor (not shown) that raises and/or lowers the build platform 208 to the desired height during the manufacturing process.

The printer assembly 202 includes an energy source 218 (e.g., a projector or light engine) that outputs energy 220 (e.g., light, such as UV light) having a wavelength configured to partially or fully cure the curable material 206. The carrier film 210 can be partially or completely transparent to the wavelength of the energy 220 to allow the energy 220 to pass through the carrier film 210 and onto the portion of the curable material 206 above the build platform 208. Optionally, a transparent plate 222 can be disposed between the energy source 218 and the carrier film 210 to guide the carrier film 210 into a specific position (e.g., height) relative to the build platform 208. During operation, the energy 220 can be patterned or scanned in a suitable pattern onto the curable material 206, thus forming a layer of cured material onto the build platform 208 and/or on a previously formed portion of the object 204. The geometry of the cured material can correspond to the desired cross-sectional geometry for the object 204. The parameters for operating the energy source 218 (e.g., energy intensity, energy dosage, exposure time, exposure pattern, exposure wavelength, energy density, power density) can be set based on instructions from a controller 224, as described in further detail below.

Once the object cross-section has been formed, the build platform 208 can be lowered by a predetermined amount to separate the cured material from the carrier film 210. The remaining curable material 206 can be carried by the carrier film 210 away from the build platform 208 and back toward the material source 216. The material source 216 can deposit additional curable material 206 onto the carrier film 210 and/or smooth the curable material 206 to re-form a uniform layer of curable material 206 on the carrier film 210. The curable material 206 can then be recirculated back to the build platform 208 to fabricate an additional layer of the object 204. This process can be repeated to iteratively build up individual object layers on the build platform 208 until the object 204 is complete. The object 204 and build platform 208 can then be removed from the system 200 for post-processing.

In some embodiments, the system 200 is used in a high temperature lithography process utilizing a highly viscous curable material 206 (e.g., a highly viscous resin). Accordingly, the printer assembly 202 can include one or more heat sources (heating plates, infrared lamps, etc.) for heating the curable material 206 to lower the viscosity to a range suitable for additive manufacturing. For example, the printer assembly 202 can include a first heat source 226a positioned against the segment of the carrier film 210 before the build platform 208, and a second heat source 226b positioned against the segment of the carrier film 210 after the build platform 208. Alternatively, or in combination, the printer assembly 202 can include heat sources at other locations.

The system 200 also includes a controller 224 (shown schematically) that is operably coupled to the printer assembly 202 and build platform 208 to control the operation thereof. The controller 224 can be or include a computing device including one or more processors and memory storing instructions for performing the additive manufacturing operations described herein. For example, the controller 224 can receive a digital data set (e.g., a three-dimensional model) representing the object 204 to be fabricated, determine a plurality of object cross-sections to build up the object 204 from the curable material 206, and can transmit instructions to the energy source 218 to output energy 220 to form the object cross-sections. As described above and in greater detail below, the controller 224 can control the energy application parameters of the energy source 218, such as the energy intensity, energy dosage, exposure time, exposure pattern, energy wavelength, and/or energy type of the energy 220 applied to the curable material 206. Optionally, the controller 224 can also determine and control other operational parameters, such as the positioning of the build platform 208 (e.g., height) relative to the carrier film 210, the movement speed and direction of the carrier film 210, the amount of curable material 206 deposited by the material source 216, the thickness of the material layer on the carrier film 210, and/or the amount of heating applied to the curable material 206.

Although FIG. 2 illustrates a representative example of a system 200 for additive manufacturing, this is not intended to be limiting, and the methods described herein can be implemented using other types of additive manufacturing systems, such as material jetting systems, binder jetting systems, material extrusion systems, powder bed fusion systems, sheet lamination systems, or directed energy deposition systems.

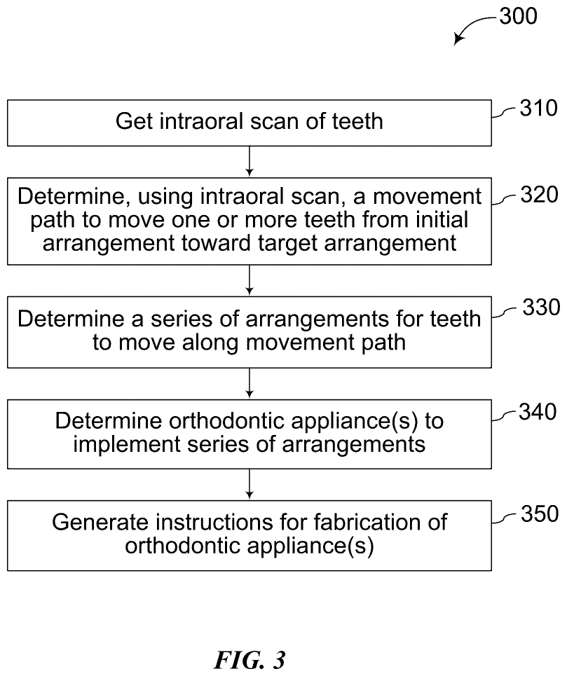

FIG. 3 illustrates a method 300 for designing an orthodontic appliance to be produced by direct fabrication, in accordance with embodiments. The method 300 can be applied to any embodiment of the orthodontic appliances described herein. Some or all of the steps of the method 300 can be performed by any suitable data processing system or device, e.g., one or more processors configured with suitable instructions.

In step 310, an intraoral scan is performed.

In step 320, using the intraoral scan, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions.

In step 330, a series of arrangements to move the one or more teeth along the movement path is determined. The movement path can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In step 340, a determination of orthodontic appliance(s) configured to implement the series of arrangement is performed. Determination of the appliance design, appliance geometry, material composition, and/or properties can be performed using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more appliance designs can be selected for testing or force modeling. As noted above, a desired tooth movement, as well as a series of arrangements required or desired for the tooth movement, can be identified. Using the simulation environment, a candidate appliance design can be analyzed or modeled for determination of an actual moving arrangement resulting from use of the candidate appliance. One or more modifications can optionally be made to a candidate appliance, and arrangements can be further analyzed as described, e.g., in order to iteratively determine an appliance design that produces the desired moving arrangements.

In step 350, instructions for fabrication of the orthodontic appliance incorporating the appliance design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Method 300 may comprise additional steps: 1) The upper arch and palate of the patient is scanned intraorally to generate three-dimensional data of the palate and upper arch; 2) The three-dimensional shape profile of the appliance is determined to provide a gap and teeth engagement structures as described herein.

Although the above steps show a method 300 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 300 may be performed with any suitable fabrication system or device, such as the embodiments described herein. Some of the steps may be optional, and the order of the steps can be varied as desired.

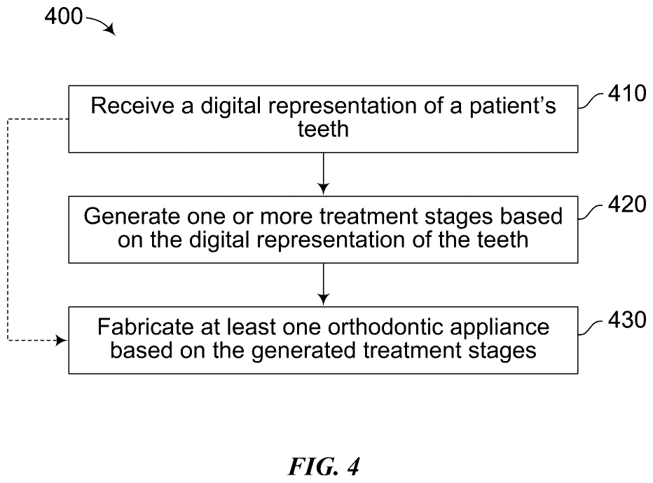

FIG. 4 illustrates a method 400 for digitally planning an orthodontic treatment and/or design or fabrication of an appliance, in accordance with embodiments. The method 400 can be applied to any of the treatment procedures described herein and can be performed by any suitable data processing system.

In step 410, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In step 420, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In step 430, at least one orthodontic appliance is fabricated based on the generated treatment stages. For example, a set of appliances can be fabricated, each shaped according a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 4, design and/or fabrication of an orthodontic appliance, and perhaps a particular orthodontic treatment, may include use of a representation of the patient's teeth (e.g., receive a digital representation of the patient's teeth), followed by design and/or fabrication of an orthodontic appliance based on a representation of the patient's teeth in the arrangement represented by the received representation.

### On-Track Treatment

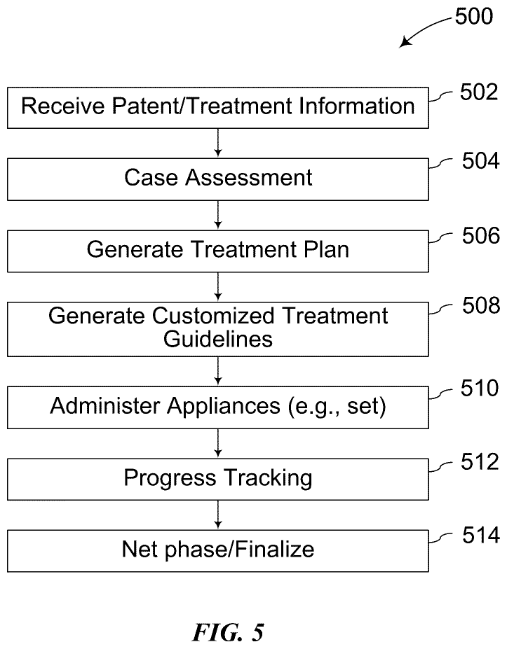

Referring to FIG. 5, a process 500 according to the present invention is illustrated. Individual aspects of the process are discussed in further detail below. The process includes receiving information regarding the orthodontic condition of the patient and/or treatment information (502), generating an assessment of the case (504), and generating a treatment plan for repositioning a patient's teeth (506). Briefly, a patient/treatment information will include obtaining data comprising an initial arrangement of the patient's teeth, which typically includes obtaining an impression or scan of the patient's teeth prior to the onset of treatment and can further include identification of one or more treatment goals selected by the practitioner and/or patient. A case assessment can be generated (504) so as to assess the complexity or difficulty of moving the particular patient's teeth in general or specifically corresponding to identified treatment goals and may further include practitioner experience and/or comfort level in administering the desired orthodontic treatment. In some cases, however, the assessment can include simply identifying particular treatment options (e.g., appointment planning, progress tracking, etc.) that are of interest to the patient and/or practitioner. The information and/or corresponding treatment plan will include identifying a final or target arrangement of the patient's teeth that is desired, as well as a plurality of planned successive or intermediary tooth arrangements for moving the teeth along a treatment path from the initial arrangement toward the selected final or target arrangement.

The process further includes generating customized treatment guidelines (508). The treatment plan typically includes multiple phases of treatment, with a customized set of treatment guidelines generated that correspond to a phase of the treatment plan. The guidelines will include detailed information on timing and/or content (e.g., specific tasks) to be completed during a given phase of treatment and will be of sufficient detail to guide a practitioner, including a less experienced practitioner or practitioner relatively new to the particular orthodontic treatment process, through the phase of treatment. Since the guidelines are designed to specifically correspond to the treatment plan and provide guidelines on activities specifically identified in the treatment information and/or generated treatment plan, the guidelines are said to be customized. The customized treatment guidelines are then provided to the practitioner so as to help instruct the practitioner as how to deliver a given phase of treatment. As set forth above, appliances can be generated based on the planned arrangements and will be provided to the practitioner and ultimately administered to the patient (510). The appliances are typically provided and/or administered in sets or batches of appliances, such as 2, 3, 4, 5, 6, 7, 8, 9, or more appliances, but are not limited to any particular administrative scheme. Appliances can be provided to the practitioner concurrently with a given set of guidelines, or appliances and guidelines can be provided separately.

After the treatment according to the plan begins and following administration of appliances to the patient, treatment progress tracking, e.g., by teeth matching, is done to assess a current and actual arrangement of the patient's teeth compared to a planned arrangement (512). If the patient's teeth are determined to be “on-track” and progressing according to the treatment plan, then treatment progresses as planned and treatment progresses to the next stage of treatment (514). If the patient's teeth have substantially reached the initially planned final arrangement, then treatment progresses to the final stages of treatment (514). Where the patient's teeth are determined to be tracking according to the treatment plan, but have not yet reached the final arrangement, the next set of appliances can be administered to the patient.

The threshold difference values of a planned position of teeth to actual positions selected as indicating that a patient's teeth have progressed on-track are provided below in Table 1. If a patient's teeth have progressed at or within the threshold values, the progress is considered to be on-track. If a patient's teeth have progressed beyond the threshold values, the progress is considered to be off-track.

TABLE 1

| Type Movement | Difference Actual/Planned | |
|---|---|---|
| Rotations | | |
| Upper Central Incisors | 9 | degrees |
| Upper Lateral Incisors | 11 | degrees |
| Lower Incisors | 11 | degrees |
| Upper Cuspids | 11 | degrees |
| Lower Cuspids | 9.25 | degrees |
| Upper Bicuspids | 7.25 | degrees |
| Lower First Bicuspid | 7.25 | degrees |
| Lower Second Bicuspid | 7.25 | degrees |
| Molars | 6 | degrees |
| Extrusion | | |
| Anterior | 0.75 | mm |
| Posterior | 0.75 | mm |
| Intrusion | | |
| Anterior | 0.75 | mm |
| Posterior | 0.75 | mm |
| Angulation | | |
| Anterior | 5.5 | degrees |
| Posterior | 3.7 | degrees |
| Inclination | | |
| Anterior | 5.5 | degrees |
| Posterior | 3.7 | degrees |
| Translation | | |
| BL Anterior | 0.7 | mm |
| BL Posterior Cuspids | 0.9 | mm |
| MD Anterior | 0.45 | mm |
| MD Cuspids | 0.45 | mm |
| MD Posterior | 0.5 | mm |

The patient's teeth are determined to be on track by comparison of the teeth in their current positions with teeth in their expected or planned positions, and by confirming the teeth are within the parameter variance disclosed in Table 1. If the patient's teeth are determined to be on track, then treatment can progress according to the existing or original treatment plan. For example, a patient determined to be progressing on track can be administered one or more subsequent appliances according to the treatment plan, such as the next set of appliances. Treatment can progress to the final stages and/or can reach a point in the treatment plan where bite matching is repeated for a determination of whether a patient's teeth are progressing as planned or if the teeth are off track.

In some embodiments, as further disclosed herein, this disclosure provides methods of treating a patient using a 3D printed orthodontic appliance. In certain embodiments, the method of repositioning a patient's teeth (or, in some embodiments, a singular tooth) comprises:
generating a treatment plan for the patient, the plan comprising tooth arrangements for moving teeth along a treatment path from an initial arrangement toward a final arrangement;
producing a 3D printed orthodontic appliance comprising less than or equal to 20 wt % hydrogen bonding units or less than or equal to 10 wt % hydrogen bonding units; and
moving on-track, with the orthodontic appliance, at least one of the patient's teeth toward an intermediate arrangement or a final tooth arrangement. In preferred embodiments, the method further comprises achieving on-track the movement of the patient's teeth to the intermediate arrangement or final tooth arrangement. In some embodiments, producing the 3D printed orthodontic appliance uses the polymerizable resin compositions disclosed further herein. On-track performance can be determined, e.g., from Table 1, above.

In some embodiments, the method further comprises tracking the progression of the patient's teeth along the treatment path after administration of the orthodontic appliance. In certain embodiments, the tracking comprises comparing a current arrangement of the patient's teeth to a planned arrangement of the teeth. As a non-limiting example, following the initial administration of the orthodontic appliance, a period of time passes (e.g., two weeks), a comparison of the now-current arrangement of the patient's teeth (i.e., at two weeks of treatment) can be compared with the teeth arrangement of the treatment plan. In some embodiments, the progression can also be tracked by comparing the current arrangement of the patient's teeth with the initial configuration of the patient's teeth. The period of time can be, for example, greater than 3 days, greater than 4 days, greater than 5 days, greater than 6 days, greater than 7 days, greater than 8 days, greater than 9 days, greater than 10 days, greater than 11 days, greater than 12 days, greater than 13 days, greater than 2 weeks, greater than 3 weeks, greater than 4 weeks, or greater than 2 months. In some embodiments, the period of time can be from at least 3 days to at most 4 weeks, from at least 3 days to at most 3 weeks, from at least 3 days to at most 2 weeks, from at least 4 days to at most 4 weeks, from at least 4 days to at most 3 weeks, or from at least 4 days to at most 2 weeks. In certain embodiments, the period of time can restart following the administration of a new orthodontic appliance.

In some embodiments, greater than 50%, greater than 55%, greater than 60%, greater than 65%, greater than 70%, greater than 75%, greater than 80%, greater than 85%, greater than 90%, greater than 91%, greater than 92%, greater than 93%, greater than 94%, greater than 95%, greater than 96%, greater than 97%, greater than 98%, or greater than 99% of the patient's teeth are on track with the treatment plan after a period of time of using an orthodontic appliance as disclosed further herein. In some embodiments, the period of time is 3 days, 4 days, 5 days, 6 days, 7 days, 8 days, 9 days, 10 days, 11 days, 12 days, 13 days, 2 weeks, 3 weeks, 4 weeks, or greater than 4 weeks.

### Properties After Use

In some embodiments of the method disclosed above, the 3D printed orthodontic appliance has a retained repositioning force (i.e., the repositioning force after the orthodontic appliance has been applied to or worn by the patient over a period of time), and the retained repositioning force to at least one of the patient's teeth after the period of time is at least 10%, at least 20%, at least 30%, at least 40%, at least 50%, at least 55%, at least 60%, at least 65%, at least 70%, at least 75%, at least 80%, at least 85%, at least 90%, at least 95%, at least 96%, at least 97%, at least 98%, or at least 99% of the repositioning force initially provided to the at least one of the patient's teeth (i.e., with initial application of the orthodontic appliance). In some embodiments, the period of time is 3 days, 4 days, 5 days, 6 days, 7 days, 8 days, 9 days, 10 days, 11 days, 12 days, 13 days, 2 weeks, 3 weeks, 4 weeks, or greater than 4 weeks.

In preferred embodiments, the orthodontic appliances disclosed herein can provide on-track movement of at least one of the patient's teeth. On-track movement has been described further herein, e.g., at Table 1. In some embodiments, the orthodontic appliances disclosed herein can be used to achieve on-track movement of at least one of the patient's teeth to an intermediate tooth arrangement. In some embodiments, the orthodontic appliances disclosed herein can be used to achieve on-track movement of at least one of the patient's teeth to a final tooth arrangement.

In some embodiments, prior to moving on-track, with the orthodontic appliance, at least one of the patient's teeth toward the intermediate arrangement or the final tooth arrangement, the orthodontic appliance comprises a first flexural stress; and after achieving on-track the movement of the at least one of the patient's teeth to the intermediate arrangement or the final tooth arrangement, the orthodontic appliance comprises a second flexural stress.

As provided herein, the methods disclosed can use the orthodontic appliances further disclosed herein. Said orthodontic appliances can be directly fabricated using, e.g., the resins disclosed herein. In certain embodiments, the direct fabrication comprises cross-linking the resin.

The appliances formed from the resins disclosed herein provide improved durability, strength, and flexibility, which in turn improve the rate of on-track progression in treatment plans. In some embodiments, greater than 60%, greater than 70%, greater than 80%, greater than 90%, or greater than 95% of patients treated with the orthodontic appliances disclosed herein (e.g., an aligner) are classified as on-track in a given treatment stage. In certain embodiments, greater than 60%, greater than 70%, greater than 80%, greater than 90%, or greater than 95% of patients treated with the orthodontic appliances disclosed herein (e.g., an aligner) have greater than 50%, greater than 55%, greater than 60%, greater than 65%, greater than 70%, greater than 75%, greater than 80%, greater than 85%, greater than 90%, or greater than 95% of their tooth movements classified as on-track.

As disclosed further herein, the cured polymeric material contains favorable characteristics that, at least in part, stem from the presence of polymeric crystals. These cured polymeric materials can have increased resilience to damage, can be tough, and can have decreased water uptake when compared to similar polymeric materials. The cured polymeric materials can be used for devices within the field of orthodontics, as well as outside the field of orthodontics. For example, the cured polymeric materials disclosed herein can be used to make devices for use in aerospace applications, automobile manufacturing, the manufacture of prototypes, and/or devices for use in durable parts production.

### Experimental Methods

All chemicals were purchased from commercial sources and were used without further purification, unless otherwise stated.

In some embodiments, the stress relaxation of a material or device can be measured by monitoring the time-dependent stress resulting from a steady strain. The extent of stress relaxation can also depend on the temperature, relative humidity and other applicable conditions (e.g., presence of water). In embodiments, the test conditions for stress relaxation are a temperature of 37±2° C. at 100% relative humidity or a temperature of 37±2° C. in water.

The dynamic viscosity of a fluid indicates its resistance to shearing flows. The SI unit for dynamic viscosity is the Poiseuille (Pa·s). Dynamic viscosity is commonly given in units of centipoise, where 1 centipoise (cP) is equivalent to 1 mPa·s. Kinematic viscosity is the ratio of the dynamic viscosity to the density of the fluid; the SI unit is m²/s. Devices for measuring viscosity include viscometers and rheometers. For example, an MCR 301 rheometer from Anton Paar may be used for rheological measurement in rotation mode (PP-25, 50 s-1, 50-115° C., 3° C./min).

Determining the water content when fully saturated at use temperature can comprise exposing the polymeric material to 100% humidity at the use temperature (e.g., 40° C.) for a period of 24 hours, then determining water content by methods known in the art, such as by weight.

In some embodiments, the presence of a crystalline phase and an amorphous phase provide favorable material properties to the polymeric materials. Property values of the cured polymeric materials can be determined, for example, by using the following methods:
stress relaxation properties can be assessed using an RSA-G2 instrument from TA Instruments, with a 3-point bending, according to ASTM D790; for example, stress relaxation can be measured at 30° C. and submerged in water, and reported as the remaining load after 24 hours, as either the percent (%) of initial load, and/or in MPa;
storage modulus can be measured at 37° C. and is reported in MPa;
T_{g} of the cured polymeric material can be assessed using dynamic mechanical analysis (DMA) and is provided herein as the tan 8 peak;
tensile modulus, tensile strength, elongation at yield and elongation at break can be assessed according to ISO 527-2 5B; and tensile strength at yield, elongation at break, tensile strength, and Young's modulus can be assessed according to ASTM D1708.

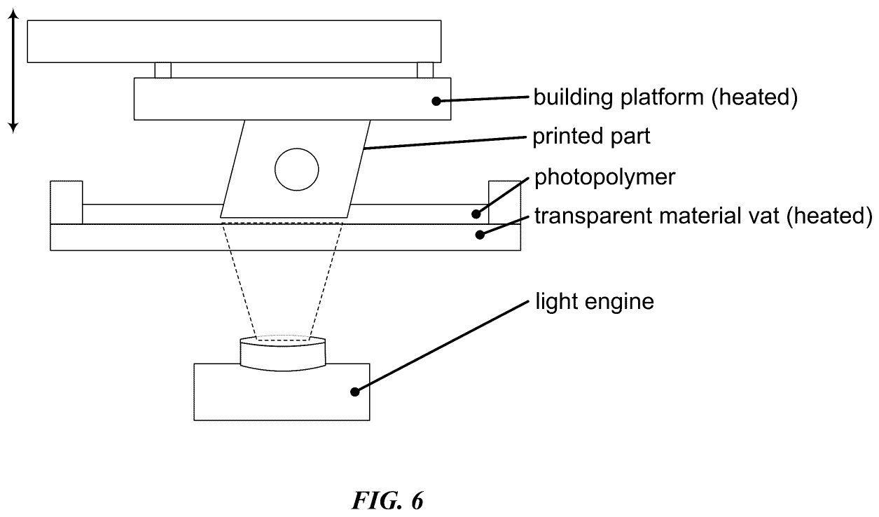

Additive manufacturing or 3D printing processes for generating a device herein (e.g., an orthodontic appliance) can be conducted using a Hot Lithography apparatus prototype from Cubicure (Vienna, Austria), which can substantially be configured as schematically shown in FIG. 6. In such cases, a photopolymerizable composition (e.g., resin) according to the present disclosure can be filled into the transparent material vat of the apparatus shown in FIG. 6, which vat can be heated to 90-110° C. The building platform can be heated to 90-110° C., too, and lowered to establish holohedral contact with the upper surface of the polymerizable composition. By irradiating the composition with 375 nm UV radiation using a diode laser from Soliton, which can have an output power of 70 mW, which can be controlled to trace a predefined prototype design, and alternately raising the building platform, the composition can be cured layer by layer by a photopolymerization process according to the disclosure, resulting in a polymeric material according to present disclosure.

### EXAMPLES

The specific compositions, synthesis, formulations, and descriptions of any of the materials, devices, systems, and components thereof, of the present disclosure can be readily varied depending upon the intended application, as will be apparent to those of skill in the art in view of the disclosure herein. Moreover, it is understood that the examples and aspects described herein are for illustrative purposes only and that various modifications or changes in light thereof can be suggested to persons skilled in the art and are included within the spirit and purview of this application and scope of the appended claims. Numerous different combinations of aspects described herein are possible, and such combinations are considered part of the present disclosure. In addition, all features discussed in connection with any one aspect herein can be readily adapted for use in other aspects herein. The use of different terms or reference numerals for similar features in different aspects does not necessarily imply differences other than those expressly set forth. Accordingly, the present disclosure is intended to be described solely by reference to the appended claims, and not limited to the aspects disclosed herein.

### Example 1

### Synthesis of PolyTHF-Containing Telechelic Compound 1

This example describes the synthesis of polyTHF-containing telechelic compound 1 of the present disclosure.

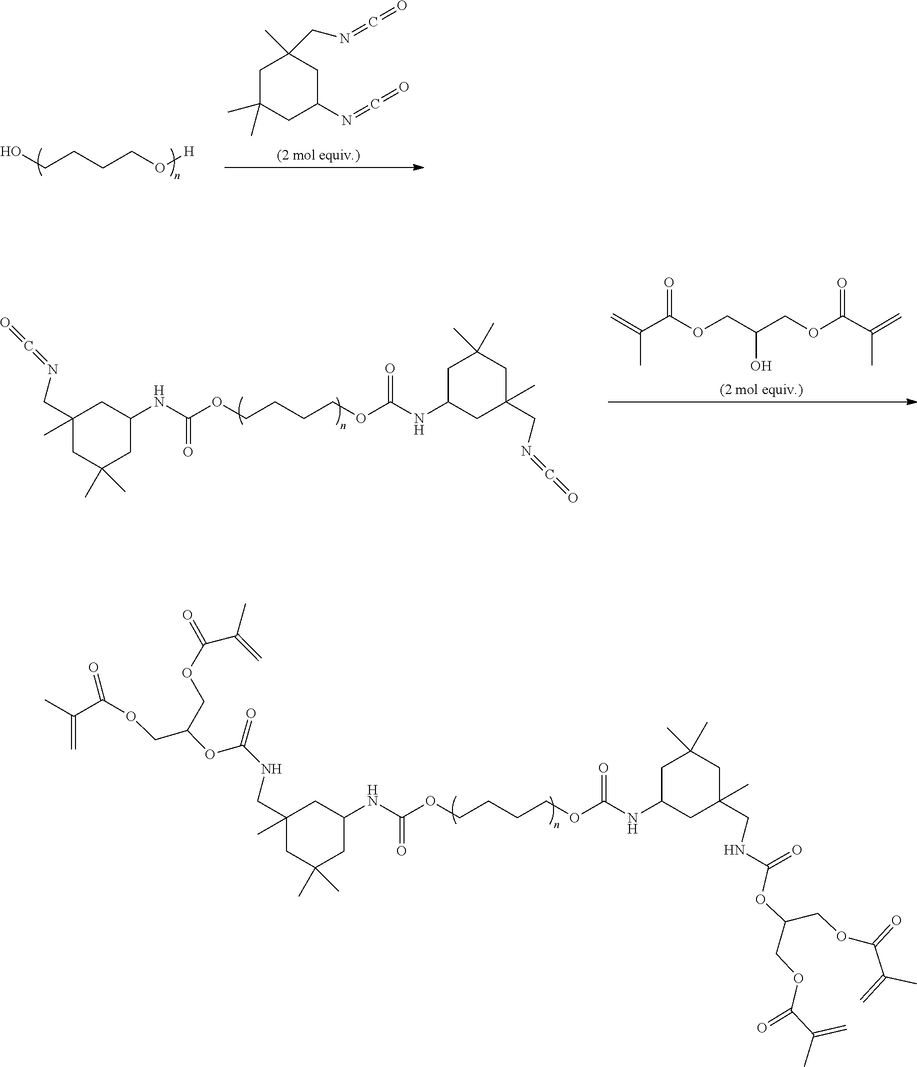

To that end, a reaction vessel was charged with PolyTHF (345.7 g, 3 kDa, 1 eq.). The vessel was purged with dry air for 15-20 minutes. After purging, BHT (0.46 g, 0.1 wt %) was added into the vessel. IPDI (52.33 g, 2 eq.) was then introduced, and dry air was continuously supplied to the vessel until its temperature reached 60° C. At this stage, a catalyst, bismuth neodecanoate (0.207; 0.034 wt %), was added to the mixture. The reaction was allowed to proceed while being monitored by Fourier Transform Infrared (FTIR) spectroscopy, focusing on the isocyanate (NCO) peak. Once the NCO peak became constant (e.g. after 1.5 hours) indicating the reaction completed, glycerol dimethacrylate (GDMA; 61.20 g, 2 eq.) and an additional amount of the bismuth neodecanoate catalyst (0.069; 0.011 wt %) were added to the reaction mixture. The mixture was heated to 90° C. and stirred at 55° C. for 1 hour. After cooling, the polymer was precipitated in methanol (10 times the reaction volume). The solvent was then evaporated under reduced pressure to obtain the polyTHF-containing telechelic compound 1 in 90% yield and high purity (>90%).

### Example 2

### Stability Characterization of Polymerizable Resin Compositions

The impact of vitamin E-based stabilizers on the storage stability of polymerizable resin compositions of the present disclosure was evaluated by performing viscosity, cure depth and color measurements over time as the polymerizable resin compositions were stored at an elevated temperature of 75° C. The compositions of the test samples are provided in Table 2. The polymerizable resin composition B is a control sample comprised of a base resin and 1000 ppm BHT as the stabilizer. The polymerizable resin composition C comprises the base resin and 300 ppm alpha-tocopherol as the stabilizer. The polymerizable resin composition D comprises the base resin and 300 ppm mixed tocopherols as the stabilizer.

TABLE 2
Polymerizable resin compositions

| | | Concentration of |
|---|---|---|
| Composition | Stabilizer | Stabilizer (ppm) |
| B | BHT | 1000 |
| C | α-tocopherol | 300 |
| D | Mixed tocopherols | 300 |

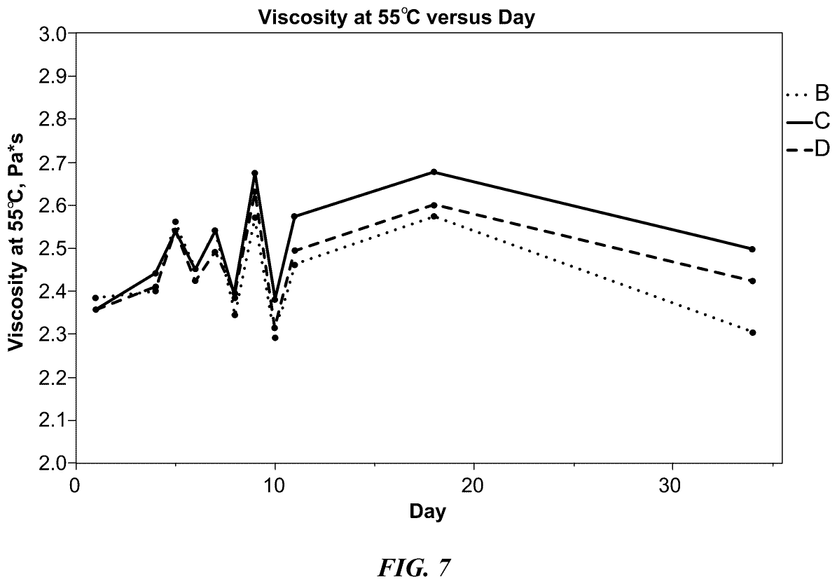

The samples were stored under 75° C. in an oven, and viscosity measurements were performed at 75° C. after specific time intervals over a time period of 3 weeks using a parallel plate viscometer. Each measurement was performed at 55° C. with a 60-second soak time and a shear rate of 100 s⁻¹. The results are summarized in FIG. 7.

As shown in FIG. 7, immediately upon formulation, the polymerizable resin compositions exhibited viscosities around 2.35 Pas (day 0). After 3 weeks, no significant increase in viscosity was observed in any of the compositions, indicating effective inhibition of undesired polymerization.

The viscosity data demonstrate that both BHT and vitamin E can effectively prevent polymerization of the base resin at elevated temperatures. Notably, comparable stability can be achieved with a lower concentration of vitamin E compared to BHT.

The cure depths of polymerizable resin compositions B-D were measured using a Keyence VK X3000 optical microscope. The samples were cured under a light intensity of 45 mW/cm² at 60° C. for various exposure times. The first cure depths (Cure Depth 1) were measured immediately upon formulation, while the second cure depths (Cure Depth 2) were measured after the polymerizable resin compositions B-D were stored in the over at 75° C. for three weeks. The changes in cure depths over the three-week period are summarized in Table 3. As shown in Table, 3, the cure depths remain the same for both compositions C and D, demonstrating that vitamin E stabilizer can provide excellent storage stability to the polymerizable resin compositions.

TABLE 3
Cure depths of polymeric resin compositions before and after
storage at elevated temperature

| | | Cure Depth 1 | | | Cure Depth 2 | | |
|---|---|---|---|---|---|---|---|
| | Exposure Time | (μm) | | | (μm) | | |
| Sample | (s) | B | C | D | B | C | D |
| | 0.4 | 210 | 78 | 91 | 64 | 99 | 114 |
| | 0.9 | 313 | 171 | 226 | 168 | 201 | 214 |
| | 2.4 | 444 | 273 | 349 | 285 | 325 | 344 |

The color stability of polymerizable resin compositions B-D was tested by measuring their b* values in the CIELAB color space, where a higher b* value indicates increased yellowing caused by resin polymerization. The results, summarized in Table 4, show that after three weeks of storage at 75° C., the control polymerizable resin composition B exhibited a significantly higher b* value compared to compositions C and D. This indicates that compositions using vitamin E as the stabilizer are more color-stable than those using BHT as the stabilizer.

TABLE 4
b* values of polymerizable resin compositions
after storage at elevated temperature

| Sample | b* |
|---|---|
| B | 16 |
| C | 9 |
| D | 9 |

### Example 3

Mechanical Properties of Polymeric Material Formed from Polymerizable Resin Composition

Tensile modulus and elongation at break of a polymeric material formed from a polymerizable resin composition of the present disclosure comprising vitamin E as the stabilizer were measured according to ASTM D1708, while stress relaxation was measured according to ASTM 0.195. The results are summarized in Table 5. As a baseline, a polymeric material with a tensile modulus exceeding 200 MPa, an elongation at break greater than 40%, and a stress relaxation above 0.01 MPa is deemed to provide sufficient force of interest. As shown in Table 5, the polymeric material obtained exhibited a Young's modulus of 1104 MPa, an elongation at breaking of 74%, and a stress relaxation of 174 MPs. These results demonstrate that using a vitamin E-based stabilizer can effectively enhance the storage stability of the polymerizable resin composition without compromising the mechanical properties of the resulting polymeric material.

TABLE 5
Mechanical properties of polymeric material

| Mechanical Properties | Standard | Metric |
|---|---|---|
| Young's Modulus | ASTM D1708@ 510 mm/min | 1104 MPa |
| Elongation at Break | ASTM D1708@ 510 mm/min | 74% |
| Stress Relaxation | ASTM 0.195 in × 2 in die 7 hrs | 174 MPa |
| | 5% strain, extrapolated to 24 hrs. | |

### Example 4

### Toxicity Test of Polymerizable Resin Compositions

Polymerizable resin compositions described herein were evaluated for potential cytotoxic effects using an in vitro mammalian cell culture test, conducted in accordance with ISO 10993-5: Biological evaluation of medical devices—Part 5: Tests for in vitro cytotoxicity.

A single preparation of the test article was extracted in single strength Minimum Essential Medium (IX MEM) at 37° C. for 72 hours. The negative control, reagent control, and positive control were similarly prepared. Triplicate monolayers of L-929 mouse fibroblast cells were dosed with each extract and incubated at 37° C. in the presence of 5% CO₂ for 48 hours. After incubation, the monolayers were examined microscopically for abnormal cell morphology and cellular degeneration. No cell lysis was observed in the cytotoxicity tests, indicating using a low concentration of vitamin E as a stabilizer does not pose a risk for toxicity.

### Example 5

### Effect of Vitamin E on Stability of Syringyl Methacrylate (SMA)

The effect of vitamin E on the stability of SMA was studied by monitoring the degree of coloration over time, measured according to ASTMD 5386-93 and expressed as the “APHA value.” In the present implementation, the APHA measurements were taken using a HunterLab Vista Spectrophotometer. The SMA samples containing 200 ppm α-tocopherol were stored at 60° C. in sealed containers, and the results were compared with control samples containing either no stabilizer or 1000 ppm BHT, as summarized in Table 6.

As shown in Table 6, initially, all three samples had the same b* value of 13.54. After one week, the APHA value of SMA increased to 22.80, while the APHA values of the SMA samples containing 200 ppm vitamin E (α-tocopherol) or 1000 ppm BHT showed only slight increases, reaching 14.18 and 13.88, respectively. After four weeks, SMA without a stabilizer turned yellow, with an APHA value of 71.74, which is approximately four times higher than the initial value of 13.54, indicating significant oxidation. In contrast, the APHA values of SMA samples containing 200 ppm vitamin E or 1000 ppm BHT increased by less than 45%, demonstrating enhanced oxidative stability with the addition of stabilizers. Notably, the APHA value of SMA with 200 ppm vitamin E was similar to that of SMA with 1000 ppm BHT, indicating that vitamin E is more effective than BHT in enhancing the oxidative stability of SMA.

TABLE 6
Degree of coloration before and after
storage at elevated temperature

| | | After One | After Two | After Four |
|---|---|---|---|---|
| | Initial | Week | Weeks | Weeks |
| Formulation | APHA | | | |
| SMA | 13.54 | 22.80 | 37.24 | 71.74 |
| SMA + 200 ppm α- | 13.54 | 14.18 | 16.06 | 19.42 |
| Tocopherol | | | | |
| SMA + 1000 ppm BHT | 13.54 | 13.88 | 15.93 | 18.49 |

### Example 6

### Effect of Vitamin E on Enhancing Photoinitiator Stability

The effect of vitamin E on enhancing the photoinitiator stability was studied by monitoring changes in the concentrations of both the photoinitiator, BAPO, and vitamin E in the recovered resin composition as the number of printing cycles increased. The results are summarized in Table 7.

As shown in Table 7, the BAPO concentrations remained constant, while the concentrations of vitamin E decreased in the recovered resin composition with increasing printing cycles. These results indicate that vitamin E can effectively stabilize the photoinitiator in the recovered curable composition during the 3D printing process.

TABLE 7
Concentrations of BAPO and Vitamin E after
single or multiple printing cycles

| Number of Printing | BAPO | Vitamin E |
|---|---|---|
| Cycles | (wt %) | (wt %) |
| 1 | 0.98 | 0.0077 |
| 2 | 1 | 0.0063 |
| 4 | 0.98 | 0.0043 |
| 6 | 0.99 | 0.0026 |

### Example 7

### Effect of Antioxidants on Stability of PolyTHF-Containing Telechelic Compound 1

This example describes viscosity measurements for Samples S1-S10, which include the polyTHF-containing telechelic compound 1 and the antioxidant stabilizers described herein, both upon formulation and after the accelerated thermal aging. The viscosity values of Samples S1-S10 are compared with those of a control composition, S11, which uses conventional BHT as the stabilizer.

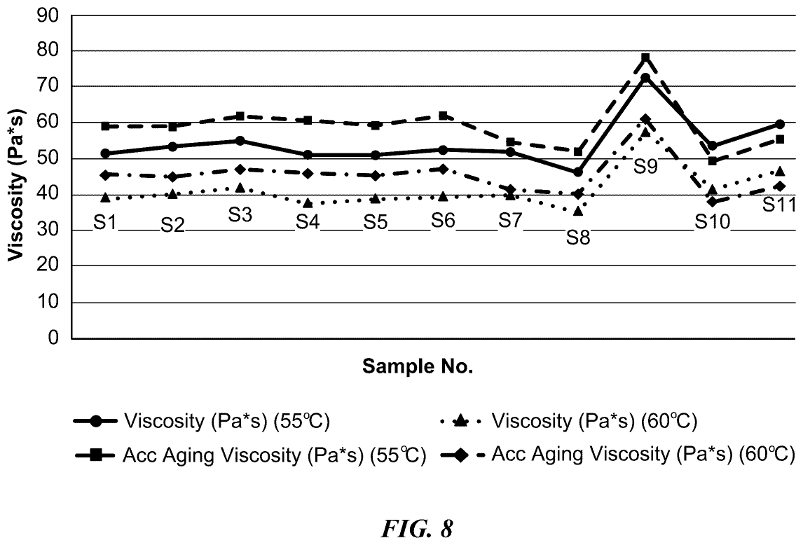

Samples S1-S11 were prepared by blending the telechelic compound 1 with various antioxidants. The compositions of Samples S1-S11 are provided in Table 8. Viscosity measurements for Samples S1-S11 were carried out at 55° C. and 60° C. under air or an inert atmosphere (N₂) upon formulation. Then, after accelerated aging ACC) at 80° C. for one week, the viscosity measurements for Sample S1-S11 were repeated at 55° C. and 60° C. under the same atmospheric conditions. FIG. 8 illustrates the viscosity values for Samples S1-11, including the control (S11), both upon formulation and after accelerated aging. As shown in FIG. 8, the antioxidants described herein exhibit performance comparable to BHT with similar viscosity values observed before and after accelerated aging under identical measurement conditions. This indicates that these antioxidants can serve as effective alternative stabilizers to prevent unwanted polymerization of polyTHF-containing telechelic compound 1. Furthermore, unlike BHT, the antioxidants disclosed herein maintained their polymerization inhibiting properties under an inert atmosphere. When oxygen was absent and the accelerating aging was conducted under nitrogen, BHT's capacity to inhibit radical polymerization decreased, resulting in approximately 50% gel formation in Sample S11. No viscosity data was obtained for BHT in the nitrogen environment. In contrast, the antioxidants disclosed herein showed no signs of gel formation under nitrogen, demonstrating their effectiveness in inhibiting polymerization even under inert conditions.

TABLE 8
Compositions of S1-S11

| | Composition | | | Antioxidant |
|---|---|---|---|---|
| Sample | Telechelic | | Atmospheric | Concentration |
| No. | compound | Antioxidant | Condition | (ppm) |
| S1 | Telechelic | Tris(2,4-di-tert- | Air | 1000 |
| | compound 1 | butylphenyl)phosphite | | |
| S2 | | Tris(2,4-di-tert- | Air | 500/500 |
| | | butylphenyl)phosphite + | | |
| | | Pentaerythritol tetrakis(3,5-di- | | |
| | | tert-butyl-4- | | |
| | | hydroxyhydrocinnamate) | | |
| S3 | | Ethylene bis[3,3-bis(3-tert-butyl- | Air | 1000 |
| | | 4-hydroxyphenyl)butyrate] | | |
| S4 | | Tetrakis(2,4-di-tert-butylphenyl) | Air | 1000 |
| | | [1,1′-biphenyl]-4,4′- | | |
| | | diylbis(phosphonite) | | |
| S5 | | Octadecyl 3-(3,5-di-tert-butyl-4- | Air | 2000 |
| | | hydroxyphenyl)propionate | | |
| S6 | | Tris(2,4-di-tert- | N₂ | 1000 |
| | | butylphenyl)phosphite | | |
| S7 | | Tris(2,4-di-tert- | N₂ | 500/500 |
| | | butylphenyl)phosphite + | | |
| | | Pentaerythritol tetrakis(3,5-di- | | |
| | | tert-butyl-4- | | |
| | | hydroxyhydrocinnamate) | | |
| S8 | | Ethylene bis[3,3-bis(3-tert-butyl- | N₂ | 1000 |
| | | 4-hydroxyphenyl)butyrate] | | |
| S9 | | Tetrakis(2,4-di-tert-butylphenyl) | N₂ | 1000 |
| | | [1,1′-biphenyl]-4,4′- | | |
| | | diylbis(phosphonite) | | |
| S10 | | Octadecyl 3-(3,5-di-tert-butyl-4- | N₂ | 2000 |
| | | hydroxyphenyl)propionate | | |
| S11 | | BHT | Air | 1000 |

### Example 8

### Treatment Using an Orthodontic Appliance

This example describes the use of a directly 3D printed orthodontic appliance to move a patient's teeth according to a treatment plan. This example also describes the characteristics that the orthodontic appliance can have following its use, in contrast to its characteristics prior to use.

A patient in need of, or desirous of, a therapeutic treatment to rearrange at least one tooth has their teeth arrangement assessed. An orthodontic treatment plan is generated for the patient. The orthodontic treatment plan comprises a plurality of intermediate tooth arrangements for moving teeth along a treatment path, from the initial arrangement (e.g., that which was initially assessed) toward a final arrangement. The treatment plan includes the use of an orthodontic appliance, fabricated using polymerizable resin compositions and methods disclosed further herein, to provide orthodontic appliances having low levels of hydrogen bonding units. In some embodiments, a plurality of orthodontic appliances are used, each of which can be fabricated using the polymerizable resin compositions and methods disclosed further herein.

The orthodontic appliances are provided, and iteratively applied to the patient's teeth to move the teeth through each of the intermediate tooth arrangements toward the final arrangement. The patient's tooth movement is tracked. A comparison is made between the patient's actual teeth arrangement and the planned intermediate arrangement. Where the patient's teeth are determined to be tracking according to the treatment plan, but have not yet reached the final arrangement, the next set of appliances can be administered to the patient. The threshold difference values of a planned position of teeth to actual positions selected as indicating that a patient's teeth have progressed on-track are provided above in Table 1. If a patient's teeth have progressed at or within the threshold values, the progress is considered to be on-track. Favorably, the use of the appliances disclosed herein increases the probability of on-track tooth movement.

The assessment and determination of whether treatment is on-track can be conducted, for example, 1 week (7 days) following the initial application of an orthodontic appliance. Following this period of application, additional parameters relating to assessing the durability of the orthodontic appliance can also be conducted. For example, relative repositioning force (compared to that which was initially provided by the appliance), remaining flexural stress, relative flexural modulus, and relative elongation at break can be determined.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A polymerizable resin composition for forming an orthodontic appliance by additive manufacturing, the polymerizable resin composition comprising:
an antioxidant stabilizer selected from the group consisting of vitamin E, octadecyl 3-(3,5-di-tert-butyl-4-hydroxyphenyl)propionate, pentaerythritol tetrakis(3,5-di-tert-butyl-4-hydroxyhydrocinnamate), pentaerythritol tetrakis(3-(3,5-di-tert-butyl-4-hydroxyphenyl)propionate, 1,3,5-tris(3,5-di-tert-butyl-4-hydroxybenzyl)-isocyanurate, 1,3,5-tris(4-tert-butyl-3-hydroxy-2,6-dimethylbenzyl)-isocyanurate, bis(3,5-di-tert-butyl-4-hydroxyhydrocinnamoyl)-methane, 2,2′-methylenebis(4-methyl-6-tert-butylphenol), bis(2,4-di-tert-butylphenol) pentaerythritol diphosphite, tris(nonylphenyl)phosphite, tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite), ethylene bis(oxyethylene)bis[β-(3-tert-butyl-4-hydroxy-5-methylphenyl)propionate] and tetrakis[methylene-3-(3,5-di-tert-butyl-4-hydroxyphenyl)propionate]methane;
a reactive diluent, wherein the reactive diluent is a polymerizable compound having a molecular weight of 0.1 to 1.0 kDa; and
a telechelic compound comprising:
an oligomeric or a polymeric chain of interconnected monomeric units having a first terminal end and a second terminal end;
at least one first reactive functional group covalently bonded to the first terminal end; and
at least one second reactive functional group covalently bonded to the second terminal.

2. The composition of claim 1, wherein the antioxidant stabilizer comprises vitamin E.

3. The composition of claim 2, wherein the vitamin E comprises alpha-tocopherol.

4. The composition of claim 2, wherein the vitamin E comprises mixed tocopherols selected from alpha-tocopherol, beta-tocopherol, delta-tocopherol and gamma-tocopherol.

5. The composition of claim 4, wherein a total content of the mixed tocopherols in vitamin E is about 95 wt %.

6. The composition of claim 1, wherein the antioxidant stabilizer is tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite), octadecyl 3-(3,5-di-tert-butyl-4-hydroxyphenyl)propionate, or a mixture of tris(2,4-di-tert-butylphenyl)phosphite and pentaerythritol tetrakis(3,5-di-tert-butyl-4-hydroxyhydrocinnamate).

7. The composition of claim 1, wherein
the oligomeric or polymeric chain of interconnected monomeric units is selected from the group consisting of (poly)carbonate-(poly)urethane, (poly)ester-(poly)urethane, (poly)ether-(poly)urethane, (poly)thioether-(poly)urethane, hydrogenated (poly)butadiene, (poly)ester and (poly)urethane, or wherein the oligomeric or polymeric chain of interconnected monomeric units comprises a polyether moiety, a polyester moiety, a polyurethane moiety or a combination thereof.

8. (canceled)

9. The composition of claim 1, wherein the at least one first reactive functional group and the at least one second reactive group are independently selected from the group consisting of an acrylate, a methacrylate, a vinyl acrylate, a vinyl methacrylate, an allyl ether, a silene, an alkyne, an alkene, a vinyl ether, a maleimide, a fumarate, a maleate, an itaconate, an epoxide and a styrenyl.

10.-11. (canceled)

12. The composition of claim 1, wherein the telechelic compound has the following structure: 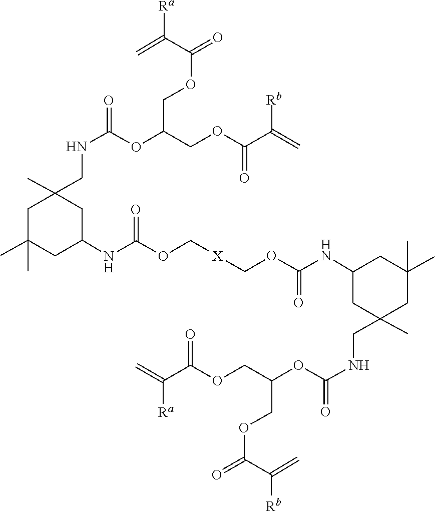
wherein:
X is an oligomeric or polymeric chain of interconnected monomeric units selected from the group consisting of (poly)carbonate-(poly)urethane, (poly)ester-(poly)urethane, (poly)ether-(poly)urethane, (poly)thioether-(poly)urethane, hydrogenated (poly)butadiene, (poly)ester or (poly)urethane; and
R^{a} and R^{b} are independently H, halogen, or substituted or unsubstituted C₁-C₃ alkyl.

13. (canceled)

14. The composition of claim 12, wherein the telechelic compound has one of the following structures: 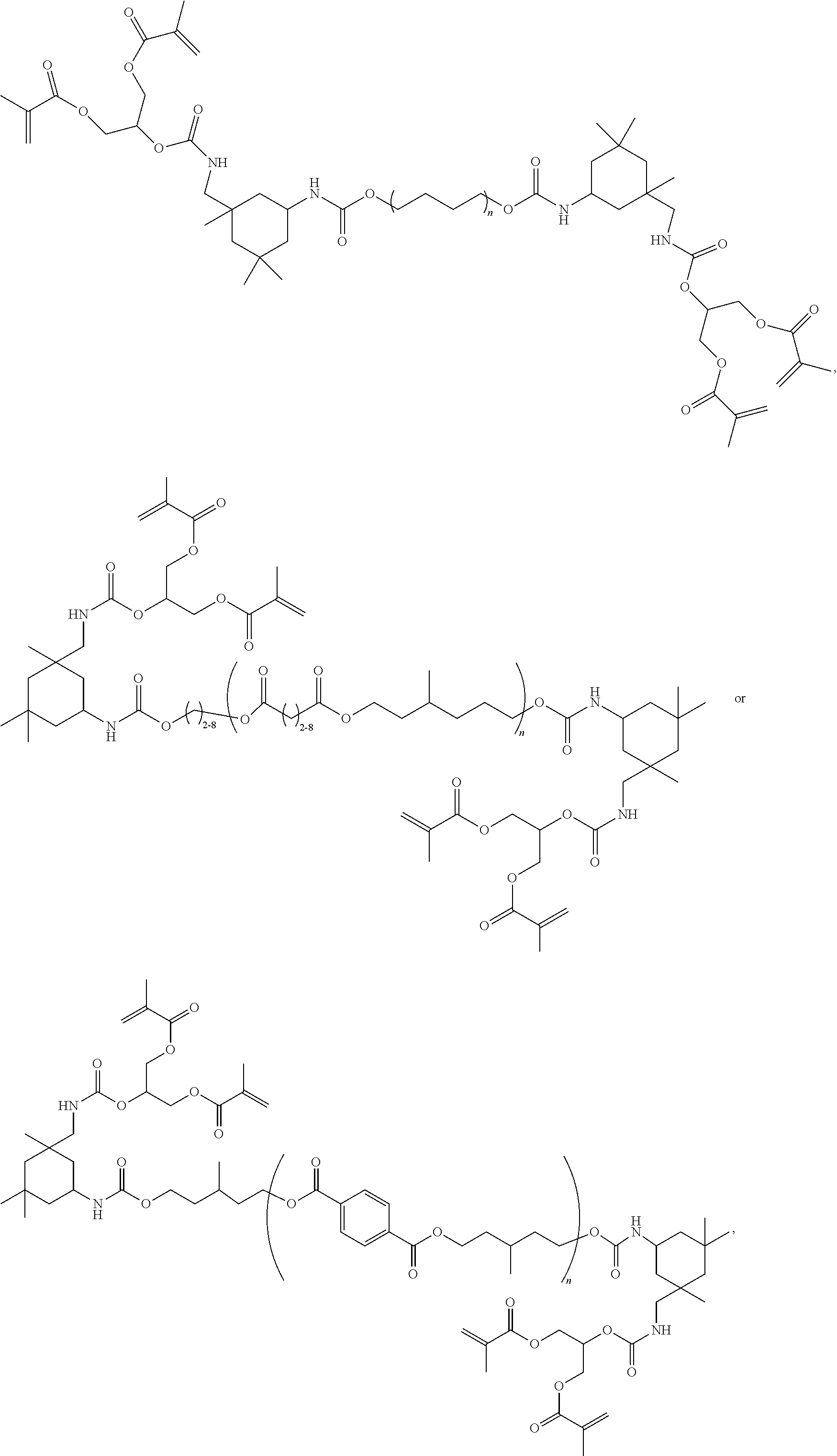
wherein n is an integer from 1 to 100.

15. The composition of claim 7, wherein the telechelic compound is a toughness modifier having a number average molecular weight greater than 5 kDa, wherein the toughness modifier has one of the following structures (ID), (III), (IV) and (V): 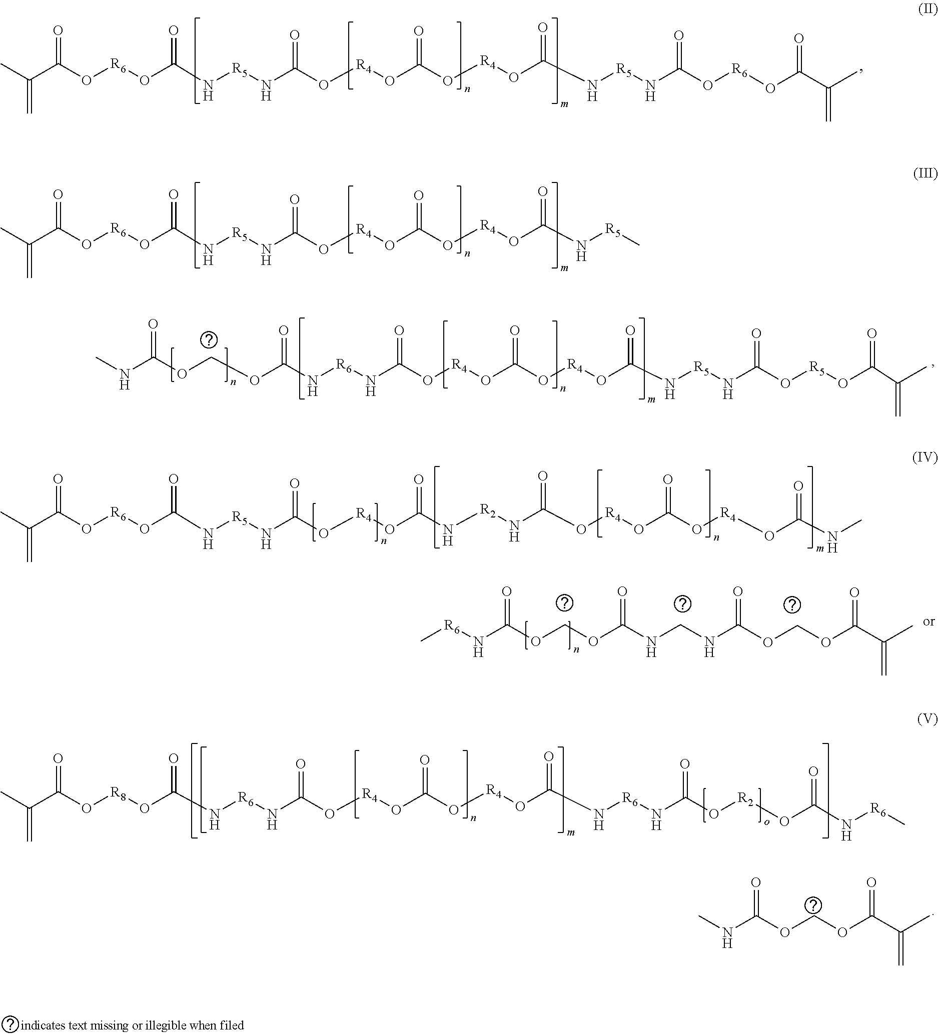
wherein:
each R₄ and each R₅ independently represent a divalent, linear, branched or cyclic C₅-C₁₅ alkyl radical;
each R₆ independently represents a divalent, linear or branched C₂-C₄ alkyl radical;
each R₇ independently represents a divalent, linear, branched C₂-C₆ alkyl radical, or is absent;
each n is independently an integer from 1 to 10;
each m is independently an integer from 1 to 20;
each o is independently an integer from 5 to 50 or is absent; and
p is an integer from 1 to 40 or is absent.

16. (canceled)

17. The composition of claim 1, wherein the polymerizable resin composition further comprises a glass transition temperature modifier having a higher glass transition temperature than the toughness modifier and a number average molecular weight of 0.4 to 5 kDa, wherein the glass transition temperature modifier comprises a compound having the following structure (I): 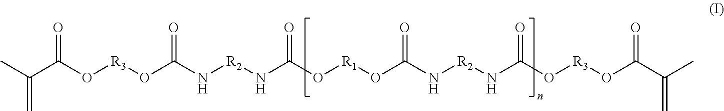
wherein:
each R₁ and each R₂ independently represent a divalent, linear, branched or cyclic C₅-C₁₅ alkyl radical, with the proviso that at least one of R₁ and R₂ is or comprises a C₅-C₆ cycloalkyl structure;
each R₃ independently represents a divalent, linear or branched C₂-C₄ alkyl radical; and
n is an integer from 1 to 5.

18. (canceled)

19. The composition of claim 1, wherein the reactive diluent comprises triethylene glycol dimethacrylate (TEGDMA), decanediol-1,10-dimethacrylate (D3MA), 1,12-dodecanediol dimethacrylate (D4MA), 3,3,5-trimethylcyclohexyl 2-(methacryloxy)benzoate (HSMA), benzyl salicylate methacrylate (BSMA), bisphenol A-glycidyl methacrylate (BisGMA) and urethane dimethacrylate (UDMA), 2-hydroxyethyl methacrylate (HEMA), 2-hydroxybutyl methacrylate (HBMA), isobornyl methacrylate (IBMA), 2-ethylhexyl methacrylate (EHMA), 2-cyanoethyl methacrylate (CEMA), benzyl methacrylate (BMA), 2-phenoxyethyl methacrylate (PEMA), butyl methacrylate (BMA), lauryl methacrylate (LMA), syringyl methacrylate (SMA) or combinations thereof.

20. The composition of claim 1, wherein the polymerizable resin composition comprises no greater than 2000 ppm, based on the total weight of the composition, of the antioxidant stabilizer.

21.-31. (canceled)

32. The composition of claim 341, further comprising a photoinitiator, wherein the photoinitiator comprises phenylbis(2,4,6-trimethylbenzoyl) phosphine oxide (BAPO), diphenyl-(2,4,6-trimethylbenzoyl) phosphine oxide (TPO), ethyl-(2,4,6-trimethylbenzoyl)phenylphosphinate (TPO-L), a polymeric TPO-L, alpha-hydroxyketone, benzil dimethyl ketal (BDK), or a combination thereof.

33. (canceled)

34. The composition of claim 32, further comprising a thermal initiator, wherein the thermal initiator comprises azobisisobutyronitrile, 2,2′-azodi(2-methylbutyronitrile) or a combination thereof.

35.-37. (canceled)

38. The composition of claim 1, wherein the polymerizable composition further comprises a crosslinking modifier, a polymerization catalyst, a light blocker, a plasticizer, a surface energy modifier, a pigment, a dye, a filler, a biologically significant chemical, a solvent, and combinations thereof.

39. The composition of claim 1, wherein the polymerizable resin composition is capable of being 3D printed at a printing temperature greater than 25° C.

40. (canceled)

41. The composition of claim 1, wherein the polymerizable resin composition has a viscosity from 30 cP to 50,000 cP at a printing temperature.

42.-45. (canceled)

46. A polymeric material formed from the polymerizable resin composition of claim 1.

47.-66. (canceled)

67. An orthodontic appliance comprising the polymeric material of claim 46.

68.-71. (canceled)

72. A method of forming an orthodontic appliance, the method comprising:
providing the polymerizable resin composition of claim 1;
curing the polymerizable resin composition to form a polymeric material; and
fabricating the orthodontic appliance with the polymeric material.

73.-94. (canceled)

95. A composition, comprising:
a reactive diluent; and
an antioxidant stabilizer for stabilizing the reactive diluent, wherein the antioxidant stabilizer selected from the group consisting of vitamin E, octadecyl 3-(3,5-di-tert-butyl-4-hydroxyphenyl)propionate, pentaerythritol tetrakis(3-(3,5-di-tert-butyl-4-hydroxyphenyl)propionate, pentaerythritol tetrakis(3,5-di-tert-butyl-4-hydroxyhydrocinnamate), 1,3,5-tris(3,5-di-tert-butyl-4-hydroxybenzyl)-isocyanurate, 1,3,5-tris(4-tert-butyl-3-hydroxy-2,6-dimethylbenzyl)-isocyanurate, bis(3,5-di-tert-butyl-4-hydroxyhydrocinnamoyl)-methane, 2,2′-methylenebis(4-methyl-6-tert-butylphenol), bis(2,4-di-tert-butylphenol) pentaerythritol diphosphite, tris(nonylphenyl)phosphite, tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite), ethylene bis(oxyethylene)bis[β-(3-tert-butyl-4-hydroxy-5-methylphenyl)propionate] and tetrakis[methylene-3-(3,5-di-tert-butyl-4-hydroxyphenyl)propionate]methane.

96.-97. (canceled)

98. A composition, comprising:
a photoinitiator; and
an antioxidant stabilizer for stabilizing the photoinitiator, wherein the antioxidant stabilizer is selected from the group consisting of vitamin E, octadecyl 3-(3,5-di-tert-butyl-4-hydroxyphenyl)propionate, pentaerythritol tetrakis(3-(3,5-di-tert-butyl-4-hydroxyphenyl)propionate, pentaerythritol tetrakis(3,5-di-tert-butyl-4-hydroxyhydrocinnamate), 1,3,5-tris(3,5-di-tert-butyl-4-hydroxybenzyl)-isocyanurate, 1,3,5-tris(4-tert-butyl-3-hydroxy-2,6-dimethylbenzyl)-isocyanurate, bis(3,5-di-tert-butyl-4-hydroxyhydrocinnamoyl)-methane, 2,2′-methylenebis(4-methyl-6-tert-butylphenol), bis(2,4-di-tert-butylphenol) pentaerythritol diphosphite, tris(nonylphenyl)phosphite, tris(2,4-di-tert-butylphenyl)phosphite, ethylene bis[3,3-bis(3-tert-butyl-4-hydroxyphenyl)butyrate], tetrakis(2,4-di-tert-butylphenyl)[1,1′-biphenyl]-4,4′-diylbis(phosphonite), ethylene bis(oxyethylene)bis[β-(3-tert-butyl-4-hydroxy-5-methylphenyl)propionate] and tetrakis[methylene-3-(3,5-di-tert-butyl-4-hydroxyphenyl)propionate]methane.

99.-108. (canceled)
